(19) United States
(12) Patent Application Publication
(10) Pub. No.: US 2014/0165091 A1
(43) Pub. Date: Jun. 12, 2014

(54) TELEVISION AND RADIO STATIONS BROADCASTED BY USERS OF A NEIGHBORHOOD SOCIAL NETWORK USING A RADIAL ALGORITHM

(71) Applicant: Raj Abhyanker, Cupertino, CA (US)

(72) Inventor: Raj Abhyanker, Cupertino, CA (US)

(21) Appl. No.: 14/180,369

(22) Filed: Feb. 14, 2014

Related U.S. Application Data
(63) Continuation-in-part of application No. 11/603,442, filed on Nov. 22, 2006, now abandoned.
Application No. 11/603,442 is a continuation-in-part of application No. 13/236,964, filed on Sep. 20, 2011, now abandoned.
Application No. 13/236,964 is a continuation-in-part of application No. 13/242,303, filed on Sep. 23, 2011.
Application No. 13/242,303 is a continuation-in-part of application No. 13/272,245, filed on Oct. 13, 2011, now Pat. No. 8,660,897.
Application No. 13/272,245 is a continuation-in-part of application No. 14/079,611, filed on Nov. 13, 2013.
Application No. 14/079,611 is a continuation-in-part of application No. 14/089,779, filed on Nov. 26, 2013.
Application No. 14/089,779 is a continuation-in-part of application No. 14/100,034, filed on Dec. 9, 2013.
Application No. 14/100,034 is a continuation-in-part of application No. 14/102,474, filed on Dec. 10, 2013.
(60) Provisional application No. 61/894,443, filed on Oct. 23, 2013.

(51) Int. Cl. H04N 21/45; H04N 21/4627; H04N 21/258; H04H 20/24

(52) U.S. Cl. CPC H04N 21/4524; H04H 20/24; H04N 21/4627; H04N 21/25841
USPC 725/27; 455/3.06

(57) ABSTRACT

Disclosed are a method, a device and a system of television and radio station broadcast data generation in a constrained geospatial vicinity around a broadcast location of a neighborhood social network. In one embodiment, the station broadcast data is radially distributed as a notification data through at least one of an on-page posting, an electronic communication, and a push notification delivered to a set of recipients through an internet protocol (IP) based network associated with users and their user profiles around an epicenter defined at the set of geospatial coordinates associated with the station broadcast data generated through the computing device.

### CLAIMS OF PRIORITY

This patent application is a continuation in part, claims priority from, and hereby incorporates by reference and claims priority from the entirety of the disclosures of the following cases and each of the cases on which they depend and further claim priority or incorporate by reference:
(1) U.S. Provisional patent application No. 60/783,226, titled ‘TRADE IDENTITY LICENSING IN A PROFESSIONAL SERVICES ENVIRONMENT WITH CONFLICT’ filed on Mar. 17, 2006.
(2) U.S. Provisional patent application No. 60/817,470 titled ‘SEGMENTED SERVICES HAVING A GLOBAL STRUCTURE OF NETWORKED INDEPENDENT ENTITIES’, filed Jun. 28, 2006.
(3) U.S. Provisional patent application No. 60/853,499, titled ‘METHOD AND APPARATUS OF NEIGHBORHOOD EXPRESSION AND USER CONTRIBUTION SYSTEM’ filed on Oct. 19, 2006.
(4) U.S. Provisional patent application No. 60/854,230 titled ‘METHOD AND APPARATUS OF NEIGHBORHOOD EXPRESSION AND USER CONTRIBUTION SYSTEM’ filed on Oct. 25, 2006.
(5) U.S. Utility patent application Ser. No. 11/603,442 titled ‘MAP BASED NEIGHBORHOOD SEARCH AND COMMUNITY CONTRIBUTION’ filed on Nov. 22, 2006.
(6) U.S. Provisional patent application No. 61/526,693 titled ‘GEOSPATIAL CONSTRAINT AROUND BIDDABILITY OF A GASTRONOMICAL ITEM’ filed on Aug. 24, 2011.
(7) U.S. Utility patent application Ser. No. 13/236,964 titled ‘NEAR-FIELD COMMUNICATION ENABLED WEARABLE APPAREL GARMENT AND METHOD TO CAPTURE GEOSPATIALLY AND SOCIALLY RELEVANT DATA OF A WEARER OF THE WEARABLE APPAREL GARMENT AND/OR A USER OF A READER DEVICE ASSOCIATED THEREWITH’ filed on Sep. 20, 2011.
(8) U.S. Utility patent application Ser. No. 13/242,303 titled ‘GEOSPATIALLY CONSTRAINED GASTRONOMIC BIDDING’ filed on Sep. 23, 2011.
(9) U.S. Utility patent application Ser. No. 13/272,245 titled ‘NEAR-FIELD COMMUNICATION ENABLED WEARABLE APPAREL GARMENT AND METHOD TO CAPTURE GEOSPATIALLY AND SOCIALLY RELEVANT DATA OF A WEARER OF THE WEARABLE APPAREL GARMENT AND/OR A USER OF A READER DEVICE ASSOCIATED THEREWITH’ filed on Oct. 13, 2011.
(10) U.S. Provisional patent application No. 61/894,443 titled ‘RADIO BROADCAST, COMMERCE PUSHPINS, AND AUTOMATED PAGE UPDATES TO A GEOSPATIALLY CONSTRAINED NEIGHBORHOOD REGION THROUGH AN INTERNET NETWORK AND SEPARATELY A TRACKABLE SOCIAL COMMUNITY FORMED BASED ON TRACKABLE TAG BASED APPAREL THAT CREATES INCENTIVES AND CONNECTIONS BETWEEN USERS WEARING PROMOTIONAL APPAREL AND THOSE OTHER USERS READING THE TRACKABLE TAG ON THE APPAREL’ filed on Oct. 23, 2013.
(11) U.S. Utility patent application Ser. No. 14/079,611 titled ‘JOB BROADCAST DATA PUBLICATION THROUGH A WORK-OPPORTUNITY LISTING SERVER USING A RADIAL ALGORITHM TO AUTOMATICALLY DISTRIBUTE THE JOB BROADCAST DATA IN A THRESHOLD RADIAL DISTANCE FROM A SET OF GEOSPATIAL COORDINATES ASSOCIATED WITH A MOBILE DEVICE’ filed on Nov. 13, 2013.
(12) U.S. Utility patent application Ser. No. 14/089,779 titled ‘EMERGENCY INCLUDING CRIME BROADCAST IN A NEIGHBORHOOD SOCIAL NETWORK’ filed on Nov. 26, 2013.
(13) U.S. Utility patent application Ser. No. 14/100,034 titled ‘SOCIAL CONNECTIONS THROUGH TAGGABLE APPAREL’ filed on Dec. 9, 2013.
(14) U.S. Utility patent application Ser. No. 14/102,474 titled ‘SHORT-TERM RESIDENTIAL SPACES IN A GEO-SPATIAL MAPPING ENVIRONMENT’ filed on Dec. 10, 2013.

### FIELD OF TECHNOLOGY

This disclosure relates generally to data processing devices and, more particularly, to a method, a device and/or a system of television and radio station broadcast data generation in a constrained geospatial vicinity around a broadcast location of a neighborhood social network.

### BACKGROUND

An organization (e.g. a small business, a non-profit organization, municipality, municipal or government agency) and/or an individual (e.g. amateur musician, local politician, amateur or professional journalist, business proprietor) may seek to directly broadcast an audio or video program and/or message to their immediate neighbors, but lack the means to do so. Purchasing radio or television transmission equipment may be prohibitively expensive for organizations and/or individuals with modest budgets. Moreover, television stations and radio stations may need to get permission from a government agency to occupy the broadcast band and/or access distribution networks with cable companies. Likewise, renting airtime on a local radio and/or television station may not be cost-effective for those with limited financial means. Moreover, local cable stations may possess a stigma for unprofessional production.

While inexpensive and/or free alternatives exist for transmitting a message (e.g. youtube.com, vimeo.com), these alternatives may not be focused toward immediate neighbors of the broadcaster. Additionally, broadcasters may have difficulty monetizing live performances through these means because their audience may be widely geographically distributed. Other alternatives (e.g. Facebook®, Twitter®, Vine®, Google+®) may only permit the transmission of live video and audio to a small group of preselected social connections, or may be limited only to those who have sought out the broadcasting organization and/or individual. Individuals wishing to broadcast audio and video programs and/or messages to their immediate neighbors may also resort to old-fashioned ham radios, but their communication range and quality may be hindered by natural features of terrain and atmospheric interference with radio waves. Because of these impediments to individual local broadcasting, creative talents may remain unrecognized by those in a neighborhood, and thus may be wasted. Neighbors who might otherwise be interested in local broadcasting talent may fail to make connections with these broadcasters, and as a result social and commercial opportunities may be lost. Not only may variety in local broadcasting suffer, but so might personal expression of would-be local broadcasters.

### SUMMARY

Disclosed are a method, a device and a system of television and radio station broadcast data generation in a constrained geospatial vicinity around a broadcast location of a neighborhood social network.

In one aspect, a method of a neighborhood broadcast server includes validating that a station broadcast data is associated with a mobile device. The method verifies that a set of geospatial coordinates associated with the station broadcast data are trusted based on a current geospatial location of the mobile device. The station broadcast data is at least one of a radio station and a television station. In addition, the method determines that a time stamp associated with a creation date and a creation time of the station broadcast data is trusted based the current geospatial location of the mobile device. Furthermore, the method automatically publishes the station broadcast data on a set of user profiles having associated verified addresses in a threshold radial distance from the current geospatial location of the mobile device using a radial algorithm.

The method may determine that the station broadcast data is generated by a verified user of the neighborhood broadcast system when validating that the station broadcast data is associated with the mobile device. The method may also determine that an application on the mobile device is communicating the station broadcast data to the neighborhood broadcast server when the station broadcast data is processed. Furthermore, the method may associate the verified user with a verified user profile in the neighborhood broadcast server through the application on the mobile device. The station broadcast data may be radially distributed through an on-page posting, an electronic communication, and/or a push notification delivered to desktop and/or mobile devices associated with users and/or their user profiles around an epicenter defined at the current geospatial location of the mobile device to all subscribed user profiles in a circular geo-fenced area defined by the threshold distance from the current geospatial location of the mobile device through the radial algorithm of the neighborhood broadcast server that measures a distance away of each address associated with each user profile from the current geospatial location at the epicenter.

The method may extract the geospatial coordinates from a metadata associated with the station broadcast data when verifying that the set of geospatial coordinates associated with the station broadcast data are trusted based on the current geospatial location of the mobile device. The method may determine a relative match between a persistent clock associated with the neighborhood broadcast server and/or a digital clock of the mobile device to determine that the time stamp associated with the creation date and/or time of the station broadcast data may be accurate and/or therefore trusted.

A set of residential addresses each associated with a resident name in a neighborhood surrounding the mobile device may be geocoded. The method may also prepopulate the set of residential addresses each associated with the resident name as the set of user profiles in the threshold radial distance from the current geospatial location of the mobile device in a neighborhood curation system communicatively coupled with the neighborhood broadcast server.

Additionally, the method may permit the verified user to modify content in each of the set of user profiles. The method may track the modified content through the neighborhood curation system. A reversible history journal associated with each of the set of user profiles such that a modification of the verified user can be undone on a modified user profile page may be generated. The method may determine an editing credibility of the verified user based on an edit history of the verified user and/or a community contribution validation of the verified user by other users of the neighborhood curation system.

Additionally, the method may automatically publish the station broadcast data to a set of user profiles having associated verified addresses in the threshold radial distance from the current geospatial location of the mobile device. A claim request of the verified user generating the station broadcast data through the mobile device to be associated with an address of the neighborhood curation system may be processed. The method may determine if a claimable neighborhood in the neighborhood curation system is associated with a private neighborhood community in the claimable neighborhood of the neighborhood curation system.

Moreover, the method may associate the verified user with the private neighborhood community in the claimable neighborhood of the neighborhood curation system if the private neighborhood community has been activated by the verified user and/or a different verified user. The method may permit the verified user to draw a set of boundary lines in a form of a geospatial polygon such that the claimable neighborhood in a geospatial region surrounding the claim request creates the private neighborhood community in the neighborhood curation system if the private neighborhood community may be inactive.

Additionally, the method may verify the claim request of the verified user generating the station broadcast data through the mobile device to be associated with a neighborhood address of the neighborhood curation system when the address may be determined to be associated with a work address and/or a residential address of the verified user.

The method may also simultaneously publish the station broadcast data on the private neighborhood community associated with the verified user generating the station broadcast data through the mobile device in the threshold radial distance from the address associated with the claim request of the verified user of the neighborhood curation system when automatically publishing the station broadcast data on a set of user profiles having associated verified addresses in the threshold radial distance from the current geospatial location of the mobile device based on a set of preferences of the verified user using the radial algorithm.

A summary data may be provided to the verified user generating the station broadcast data through the mobile device of how many user profile pages were updated with an alert of the station broadcast data when publishing the station broadcast data in the private neighborhood community and/or the set of user profiles having associated verified addresses in the threshold radial distance from the current geospatial location of the mobile device based on the set of preferences of the verified user.

The method may also live broadcast the station broadcast data to the different verified user and/or other verified users in the private neighborhood community and/or currently within the threshold radial distance from the current geospatial location through a multicast algorithm of the neighborhood broadcast server (such that the live broadcast may multicast to a plurality of mobile devices associated with each of the different user and/or the other verified users simultaneously when the mobile device of the verified user generating the station broadcast data may enable broadcasting of the station broadcast data to a geospatial vicinity around the mobile device of the verified user generating the station broadcast data and/or in any private neighborhood community in which the verified user has a non-transitory connection using the radial algorithm).

Moreover, the method may permit the different verified user and/or other verified users in the private neighborhood community to bi-directionally communicate with the verified user generating the station broadcast data through the neighborhood broadcast server using the radial algorithm, wherein any private neighborhood community in which the verified user has a non-transitory connection may be a residential address of the verified user and/or a work address of the verified user that has been confirmed by the neighborhood broadcast server as being associated with the verified user. The threshold radial distance may be between 0.2 and 0.4 miles from the set of geospatial coordinates associated with the station broadcast data to optimize a relevancy of the station broadcast data. The neighborhood broadcast server may include a crowdsourced-moderation algorithm in which multiple neighbors to a geospatial area determine what content contributed to the neighborhood broadcast server persists and/or which may be deleted. The neighborhood broadcast server may permit users to mute messages of specific verified users to prevent misuse of the neighborhood broadcast server.

In another aspect, the method includes determining that a time stamp associated with a creation date and a creation time of a station broadcast data is trusted based on a current geospatial location of a computing device. Additionally, the method automatically publishes the station broadcast data on a set of user profiles having associated verified addresses in a threshold radial distance from the current geospatial location of the computing device using a radial algorithm. Furthermore, the method radially distributes the station broadcast data as a notification data through an on-page posting, an electronic communication, and a push notification delivered to a set of recipients through an internet protocol (IP) based network associated with users and their user profiles around an epicenter defined at the set of geospatial coordinates associated with the station broadcast data generated through the computing device.

In yet another aspect, a system includes a neighborhood broadcast server to automatically publish a neighborhood broadcast data on a set of user profiles having associated verified addresses in a threshold radial distance from the set of geospatial coordinates associated with the station broadcast data of a verified user of the neighborhood broadcast server using a radial algorithm. The system also includes a mobile device communicatively coupled with the neighborhood broadcast server through the network to generate the station broadcast data using a camera, a microphone, and a sensory capability of the mobile device to generate a captured data that is appended with a present geospatial location and a time stamp associated with a creation date and a creation time of the captured data in generating the station broadcast data.

A validation module may validate that a station broadcast data may be associated with a mobile device. Additionally, the validation module may verify a set of geospatial coordinates associated with the station broadcast data are trusted based on a current geospatial location of the mobile device. A time stamp module may determine that a time stamp associated with a creation date and/or a creation time of the station broadcast data is trusted based the current geospatial location of the mobile device.

The station broadcast data on a set of user profiles having associated verified addresses in the threshold radial distance from the current geospatial location of the mobile device using a radial algorithm may be automatically published by a publishing module. A verification module may also determine that the station broadcast data is generated by a verified user of the neighborhood broadcast system when validating that the station broadcast data is associated with the mobile device. A communication determining module may determine that an application on the mobile device may be communicating the station broadcast data to the neighborhood broadcast server when the station broadcast data may be processed. Additionally, an application module may associate the verified user with a verified user profile in the neighborhood broadcast server through the application on the mobile device.

A radial distribution module may radially distribute the station broadcast data through an on-page posting, an electronic communication, and/or a push notification delivered to desktop and/or mobile devices associated with users and/or their user profiles around an epicenter defined at the current geospatial location of the mobile device to all subscribed user profiles in a circular geo-fenced area defined by the threshold distance from the current geospatial location of the mobile device through the radial algorithm of the neighborhood broadcast server that measures a distance away of each address associated with each user profile from the current geospatial location at the epicenter.

An extraction module may extract the geospatial coordinates from a metadata associated with the station broadcast data when verifying that the set of geospatial coordinates associated with the station broadcast data are trusted based on the current geospatial location of the mobile device. A matching module may determine a relative match between a persistent clock associated with the neighborhood broadcast server and/or a digital clock of the mobile device to determine that the time stamp associated with the creation date and/or time of the station broadcast data is accurate and therefore trusted.

A plotting module may geocode a set of residential addresses each associated with a resident name in a neighborhood surrounding the mobile device. A data-seeding module may prepopulate the set of residential addresses each associated with the resident name as the set of user profiles in the threshold radial distance from the current geospatial location of the mobile device in a neighborhood curation system communicatively coupled with the neighborhood broadcast server.

A modification module may permit the verified user to modify content in each of the set of user profiles. A discovery module may track the modified content through the neighborhood curation system. An undo module may generate a reversible history journal associated with each of the set of user profiles such that a modification of the verified user can be undone on a modified user profile page. Additionally, a reputation module may determine an editing credibility of the verified user based on an edit history of the verified user and/or a community contribution validation of the verified user by other users of the neighborhood curation system.

A claiming module may process a claim request of the verified user generating the station broadcast data through the mobile device to be associated with an address of the neighborhood curation system. A private-neighborhood module may determine if the claimable neighborhood in the neighborhood curation system is associated with a private neighborhood community in the claimable neighborhood of the neighborhood curation system.

An association module may associate the verified user with the private neighborhood community in the claimable neighborhood of the neighborhood curation system if the private neighborhood community has been activated by the verified user and/or a different verified user. A boundary module may permit the verified user to draw a set of boundary lines in a form of a geospatial polygon such that the claimable neighborhood in a geospatial region surrounding the claim request creates the private neighborhood community in the neighborhood curation system if the private neighborhood community is inactive.

An address type module may verify the claim request of the verified user generating the station broadcast data through the mobile device to be associated with a neighborhood address of the neighborhood curation system when the address is determined to be associated with a work address and/or a residential address of the verified user. A concurrency module may simultaneously publish the station broadcast data on the private neighborhood community associated with the verified user generating the station broadcast data through the mobile device in the threshold radial distance from the address associated with the claim request of the verified user of the neighborhood curation system when automatically publishing the station broadcast data on a set of user profiles having associated verified addresses in the threshold radial distance from the current geospatial location of the mobile device based on a set of preferences of the verified user using the radial algorithm.

A summary module may provide a summary data to the verified user generating the station broadcast data through the mobile device of how many user profile pages were updated with an alert of the station broadcast data when publishing the station broadcast data in the private neighborhood community and/or the set of user profiles having associated verified addresses in the threshold radial distance from the current geospatial location of the mobile device based on the set of preferences of the verified user.

A live broadcast module may live broadcast the station broadcast data to the different verified user and/or other verified users in the private neighborhood community and/or currently within the threshold radial distance from the current geo spatial location through a multicast algorithm of the neighborhood broadcast server such that the live broadcast multicasts to a plurality of mobile devices associated with each of the different user and/or the other verified users simultaneously when the mobile device of the verified user generating the station broadcast data enables broadcasting of the station broadcast data to a geospatial vicinity around the mobile device of the verified user generating the station broadcast data and/or in any private neighborhood community in which the verified user has a non-transitory connection using the radial algorithm.

A bi-directional communication module may permit the different verified user and/or other verified users in the private neighborhood community to bi-directionally communicate with the verified user generating the station broadcast data through the neighborhood broadcast server using the radial algorithm. Any private neighborhood community in which the verified user may have a non-transitory connection may be a residential address of the verified user and/or a work address of the verified user that has been confirmed by the neighborhood broadcast server as being associated with the verified user.

A threshold module may optimize a relevancy of the station broadcast data wherein the threshold radial distance may be between 0.2 and 0.4 miles from the set of geospatial coordinates associated with the station broadcast data. Additionally, a moderation module may apply a crowdsourced-moderation algorithm in which multiple neighbors to a geospatial area may determine what content contributed to the neighborhood broadcast server persists and/or which may be deleted. A muting module may permit users to mute messages of specific verified users to prevent misuse of the neighborhood broadcast server.

A television module may generate a set of neighborhood television stations distributed through the internet protocol network such that recipients in a region bounded by the threshold radial distance are permitted to access and tune in each of the set of neighborhood television stations based a claimed neighborhood profile or a current geospatial location of the recipient. Similarly, a radio module may generate a set of neighborhood radio stations distributed through the internet protocol network such that recipients in a region bounded by the threshold radial distance are permitted to access and tune in to each of the set of neighborhood radio stations based on the claimed neighborhood profile or the current geospatial location of the recipient.

The neighborhood broadcast server may permit the station broadcast data to be disseminated to adjacent neighborhoods that have been claimed by different users in a manner such that the station broadcast data is optionally disseminated to the surrounding claimed neighborhoods based on a preference of the verified user. A claimed neighborhood of the verified user may be activated based on a minimum number of other verified users in the threshold radial distance that have been verified through a primary residential address associated with each of the other verified users through at least one of a post card verification, a utility bill verification, a privately-published access code, and a neighbor vouching method. Access to the station broadcast data may be restricted to the claimed neighborhood of the verified user. Access to the station broadcast data may be denied to users having verified addresses outside the claimed neighborhood of the verified user.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this embodiments are illustrated by way of example and not limitation in the figures of the accompanying drawings, in which like references indicate similar elements and in which:

FIG. 1 is a neighborhood broadcast network view of a neighborhood broadcast server having a radial distribution module communicating with a device that generates a radial broadcast through an internet protocol network using a radial algorithm of the radial distribution module of the neighborhood broadcast server, according to one embodiment.

FIG. 2 is an exploded view of the radial distribution module of FIG. 1 that applies the radial algorithm, according to one embodiment.

FIG. 3 is a broadcast view that demonstrates how the radial distribution module of FIG. 1 is used to communicate a station broadcast data to claimed user profiles, pre-seeded user profiles, and to telephone devices through a heterogeneous network formed through the internet protocol network of FIG. 1 and through a cellular network, according to one embodiment.

FIG. 4 is a radial operation view that illustrates an expansion of a threshold radial distance based on a claimed neighborhood at a radial boundary surrounding an epicenter formed by geo spatial coordinates of the device of FIG. 1, according to one embodiment.

FIG. 5 illustrates a remote association view in which a mobile device of a recipient receives the station broadcast data of FIG. 3 based on a non-transitory claimed address associated with a profile of the recipient even when the recipient's mobile device is outside a threshold radial distance of a broadcast, according to one embodiment.

FIG. 6 is a recipient view that explains how the recipient of FIG. 5 views and communicates with a set of broadcasting verified users based on the station broadcast data, according to one embodiment.

FIG. 7 is a radio and television station broadcast view that explains how a broadcasting user creates a broadcast and manages notifications in neighborhoods that they have claimed, according to one embodiment.

FIG. 8 is a user interface view that explains how a user drags pushspins to a map including a broadcast pushpin, which is different than other pushpins in that a time and a location of the broadcast pushpin is fixed based on a set of geospatial coordinates associated with a mobile device of the broadcasting user of FIG. 7, according to one embodiment.

FIG. 9 is a process flow of radially distributing the station broadcast data of FIG. 3 as a notification data around an epicenter defined at the set of geospatial coordinates of FIG. 8 associated with the station broadcast data, according to one embodiment.

FIG. 10 is a table view illustrating data relationships between users, locations, and with a set of notification types needed to generate a broadcast, according to one embodiment.

FIG. 11 is a critical path view illustrating a flow based on time in which critical operations in establishing a bi-directional session between a verified user and those individuals receiving the station broadcast data of FIG. 3 is established, according to one embodiment.

FIG. 12 is a local event broadcast view illustrating the broadcasting of a neighborhood event in which the threshold radial distance is defined by a school district boundary, according to one embodiment.

FIG. 13 is a social community view of a social community module, according to one embodiment.

FIG. 14 is a profile view of a profile module, according to one embodiment.

FIG. 15 is a contribute view of a neighborhood network module, according to one embodiment.

FIG. 16 is a diagrammatic system view of a data processing system in which any of the embodiments disclosed herein may be performed, according to one embodiment.

FIG. 17A is a user interface view of mapping user profile of the geographical location, according to one embodiment.

FIG. 17B is a user interface view of mapping of the unclaimed profile, according to one embodiment.

FIG. 18A is a user interface view of mapping of the unclaimed profile of the commercial user, according to one embodiment.

FIG. 18B is a user interface view of mapping of customizable business profile of the commercial user, according to one embodiment.

FIG. 19 is a user interface view of a group view associated with particular geographical location, according to one embodiment.

FIG. 20 is a user interface view of claim view, according to one embodiment.

FIG. 21 is a user interface view of a building builder, according to one embodiment.

FIG. 22 is a systematic view of communication of wiki data, according to one embodiment.

FIG. 23 is a systematic view of a network view, according to one embodiment.

FIG. 24 is a block diagram of a database, according to one embodiment.

FIG. 25 is an exemplary graphical user interface view for data collection, according to one embodiment.

FIG. 26 is an exemplary graphical user interface view of image collection, according to one embodiment.

FIG. 27 is an exemplary graphical user interface view of an invitation, according to one embodiment.

FIG. 28 is a flowchart of inviting the invitee(s) by the registered user, notifying the registered user upon the acceptance of the invitation by the invitee(s) and, processing and storing the input data associated with the user in the database, according to one embodiment.

FIG. 29 is a flowchart of adding the neighbor to the queue, according to one embodiment.

FIG. 30 is a flowchart of communicating brief profiles of the registered users, processing a hyperlink selection from the verified registered user and calculating and ensuring the Nmax degree of separation of the registered users away from verified registered users, according to one embodiment.

FIG. 31 is an N degree separation view, according to one embodiment.

FIG. 32 is a user interface view showing a map, according to one embodiment.

FIG. 33A is a process flow of searching a map based community and neighborhood contribution, according to one embodiment.

FIG. 33B is a continuation of process flow of FIG. 33A showing additional processes, according to one embodiment.

FIG. 33C is a continuation of process flow of FIG. 33B showing additional processes, according to one embodiment.

FIG. 33D is a continuation of process flow of FIG. 33C showing additional processes, according to one embodiment.

FIG. 33E is a continuation of process flow of FIG. 33D showing additional processes, according to one embodiment.

Other features of the present embodiments will be apparent from the accompanying drawings and from the detailed description that follows.

### DETAILED DESCRIPTION

Example embodiments, as described below, may be used to provide a method, a system and/or a device for this disclosure relates generally to data processing devices and, more particularly, to a method, a device and/or a system of neighborhood television and radio stations through a neighborhood broadcast server using a radial algorithm to automatically distribute a station broadcast data to a set of user profiles having associated verified addresses in a threshold radial distance from a current geospatial location of a broadcast location.

Although the present embodiments have been described with reference to specific example embodiments, it will be evident that various modifications and changes may be made to these embodiments without departing from the broader spirit and scope of the various embodiments.

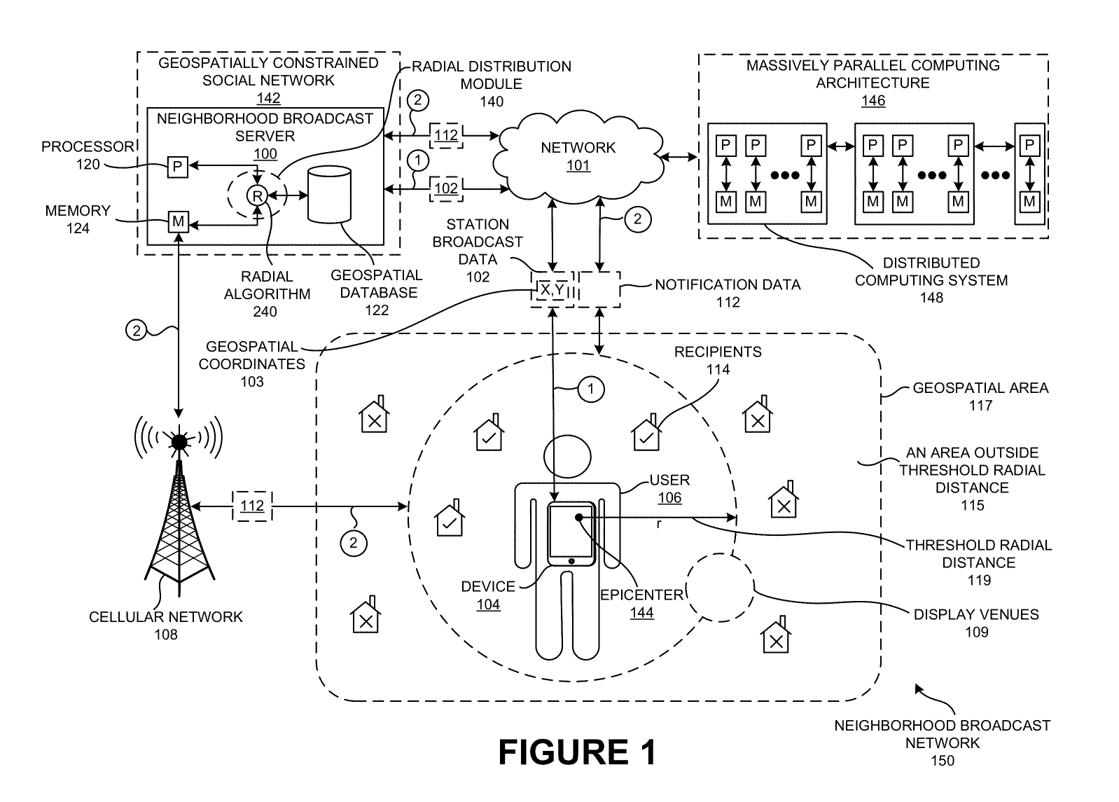

FIG. 1 is a neighborhood broadcast network view of a neighborhood broadcast server 100 having a radial distribution module 140 communicating with a device that generates a radial broadcast through an internet protocol network using a radial algorithm 240 of the radial distribution module 140 of the neighborhood broadcast server 100, according to one embodiment.

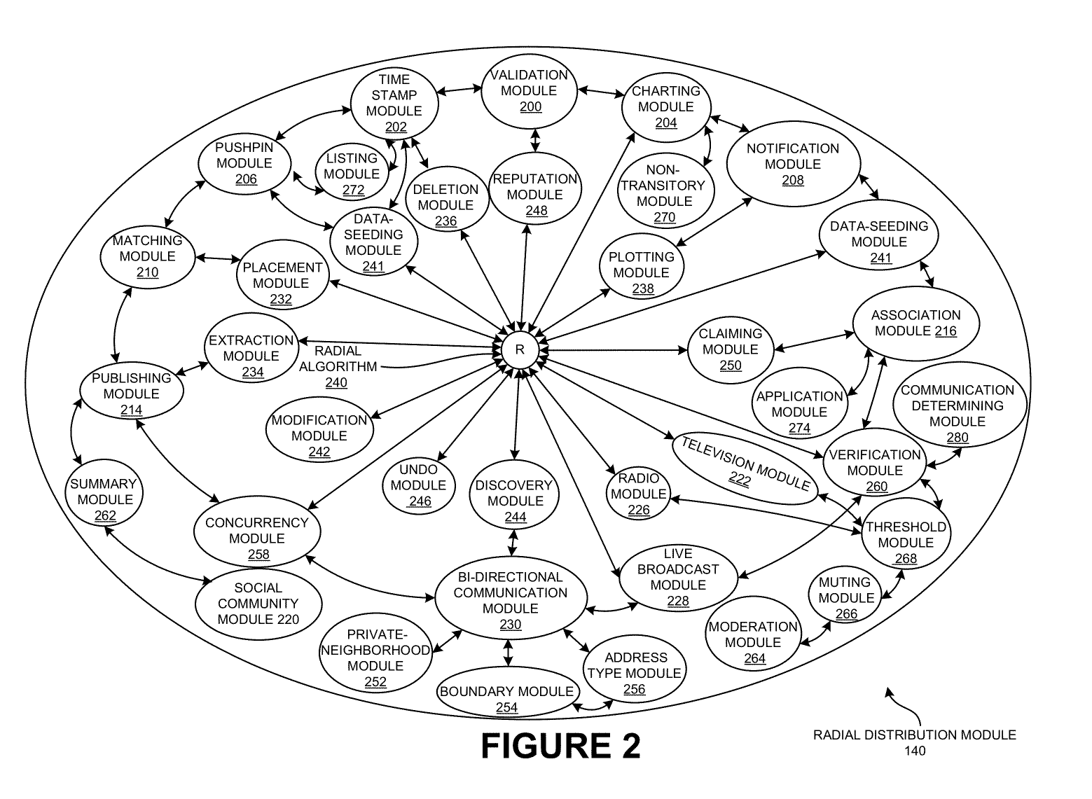

Particularly, FIG. 1 illustrates a neighborhood broadcast network 150, according to one embodiment. The embodiment of FIG. 1 describes a neighborhood broadcast server 100, a network 101, a station broadcast data 102, a set of geospatial coordinates 103, a device 104 (e.g., a mobile device 504), a user 106, a cellular network 108, display venues 109 (including a theater 309A, a school 309B, a cinema 309C, a public exhibition space 309D, and a restaurant 309E), a notification data 112, a set of recipients 114, an area outside the threshold radial distance 115, a geospatial area 117, a threshold radial distance 119, a processor 120, a geospatial database 122, a memory 124, a radial distribution module 140 (e.g., that applies a radial algorithm 240 of FIG. 2 using a series of modules working in concert as described in FIG. 2), a geospatially constrained social network 142, an epicenter 144, a massively parallel computing architecture 146, and a distributed computing system 148.

The neighborhood broadcast server 100 includes a processor 120, a memory 124, and a geospatial database 122, according to the embodiment of FIG. 1. The neighborhood broadcast server 100 may be one or more server side data processing systems (e.g., web servers operating in concert with each other) that operate in a manner that provide a set of instructions to any number of client side devices (e.g., the device 104 (e.g., a mobile device 504)) communicatively coupled with the neighborhood broadcast server 100 through the network 101. For example, the neighborhood broadcast server 100 may be a computing system (e.g., or a group of computing systems) that operates in a larger client-server database framework (e.g., such as in a social networking software such as Nextdoor.com, Fatdoor.com, Facebook.com, etc.).

The device 104 (e.g., a mobile device 504, a smartphone, a tablet, a laptop) may access the neighborhood broadcast server 100 through the network 101 using a browser application (e.g., Google® Chrome) of the mobile device and/or through a client-side application (e.g., a Nextdoor.com mobile application, a Fatdoor.com mobile application) downloaded to the device 104 (e.g., a mobile device 504) operated by the user 106. In an alternate embodiment, a non-mobile computing device, such as a desktop computer (not shown) may access the neighborhood broadcast server 100 through the network 101.

The station broadcast data 102 may be communicated from the device 104 (e.g., a mobile device 504) to the neighborhood broadcast server 100 through the network 101. The station broadcast data 102 may include information (e.g., a radio show, a visual performance) offered by the user 106 to recipients 114 and/or the display venues 109 through the network 101.

The station broadcast data 102 may be generated and distributed through an application of the radial distribution module 140 (e.g., that applies the radial algorithm 240 of FIG. 2 using a series of modules working in concert as described in FIG. 2) of the neighborhood broadcast server 100. The radial distribution module 140 (e.g., that applies the radial algorithm 240 of FIG. 2 using a series of modules working in concert as described in FIG. 2) may be a series of software functions/processes that simulates the experience of transmitting and receiving local broadcasts for the verified user, according to one embodiment.

Using an internet protocol based network (e.g., the network 101), the neighborhood broadcast server 100 may be able to use the radial distribution module 140 (e.g., that applies the radial algorithm 240 of FIG. 2 using a series of modules working in concert as described in FIG. 2) to simulate a radio frequency (RF) based communication network using an IP network topology of the network 101. Therefore, the station broadcast data 102 can be distributed using the neighborhood broadcast server 100 to a geo-constrained area (e.g., the recipients 114 in the geospatial area 117 and/or the display venues 109 in a geo-constrained area around an area in which the device 104 (e.g., a mobile device 504) operates without requiring expensive broadcast towers, transceivers, transmitters, amplifiers, antennas, tuners and/or wave generating and interpreting hardware (e.g., as may be required in local ham radio communication, frequency modulation (FM) audio systems, etc.). The radial distribution module 140 (e.g., that applies the radial algorithm 240 of FIG. 2 using a series of modules working in concert as described in FIG. 2) may recreate an experience of communication between parties in a geospatially restricted area (e.g., for example in the same city, in the surrounding neighborhood, in the same zip code, in the same building, in the same claimed neighborhood) through the use of an Internet protocol network. The neighborhood broadcast server 100 may overcome technical challenges of determining a user's geospatial location, calculating distance to other verified users based on relative geospatial locations, and/or coordinating information with a database of geo-coded information of interest (e.g., using the geospatial database 122) using the radial distribution module 140 (e.g., that applies the radial algorithm 240 of FIG. 2 using a series of modules working in concert as described in FIG. 2).

The radial distribution module 140 (e.g., that applies the radial algorithm 240 of FIG. 2 using a series of modules working in concert as described in FIG. 2), as a function/module of the neighborhood broadcast server, may determine the location of the user 106, the distance between the user 106 and other verified users, and the distance between the user 106 and locations of interest. With that information, the radial distribution module 140 (e.g., that applies the radial algorithm 240 of FIG. 2 using a series of modules working in concert as described in FIG. 2) may further determine which verified users are within a predetermined vicinity of a user 106. This set of verified users within the vicinity of another verified user may then be determined to be receptive to broadcasts transmitted by the user 106 and to be available as transmitters of broadcasts to the user 106.

The radial distribution module 140 (e.g., that applies the radial algorithm 240 of FIG. 2 using a series of modules working in concert as described in FIG. 2) in effect may create a link between verified users of the network 101 that allows the users to communicate with each other, and this link may be based on the physical distance between the users as measured relative to a current geospatial location of the device 104 (e.g., a mobile device 504) with a claimed and verified (e.g., through a verification mechanism such as a postcard verification, a utility bill verification, and/or a vouching of the user with other users) non-transitory location (e.g., a home location, a work location) of the user and/or other users. In an alternate embodiment, the transitory location of the user (e.g., their current location, a current location of their vehicle and/or mobile phone) and/or the other users may also be used by the radial algorithm to determine an appropriate threshold distance for broadcasting a message.

Furthermore, the radial distribution module 140 (e.g., that applies the radial algorithm 240 of FIG. 2 using a series of modules working in concert as described in FIG. 2) may automatically update a set of pages associated with profiles of individuals and/or businesses that have not yet joined the network based on preseeded address information. In effect, the radial distribution module 140 (e.g., that applies the radial algorithm 240 of FIG. 2 using a series of modules working in concert as described in FIG. 2) may update preseeded pages in a geo-constrained radial distance from where a broadcast originates (e.g., using an epicenter 144 calculated from the current location of the device 104 (e.g., a mobile device 504)) with information about the station broadcast data 102. In effect, through this methodology, the radial distribution module 140 (e.g., that applies the radial algorithm 240 of FIG. 2 using a series of modules working in concert as described in FIG. 2) may leave ‘inboxes’ and/or post ‘alerts’ on pages created for users that have not yet signed up based on a confirmed address of the users through a public and/or a private data source (e.g., from Infogroup®, from a white page directory, etc.).

The radial distribution module 140 (e.g., that applies the radial algorithm 240 of FIG. 2 using a series of modules working in concert as described in FIG. 2) of the neighborhood broadcast server 100 may be different from previous implementations because it is the first implementation to simulate the experience of local radio transmission between individuals using the internet and non-radio network technology by basing their network broadcast range on the proximity of verified users to one another, according to one embodiment.

FIG. 1 illustrates a number of operations between the device 104 and the recipients 114 and/or the display venues 109. Particularly, circle ‘1’ of FIG. 1 illustrates that the user of the device 104 communicates the station broadcast data 102 to the neighborhood broadcast server 100 using the network 101. Then, after applying the radial algorithm 240 utilizing the radial distribution module 140, the neighborhood broadcast server 100 generates and communicates an appropriate notification data (e.g., the notification data 112, which may be comprised of any of the information contained in the station broadcast data 102 or may be identical to the station broadcast data 102) associated with the station broadcast data 102 to a geospatially distributed set of recipients 114 in a radial area (radius represented as ‘r’ of FIG. 1) in a geospatial vicinity from an epicenter 144 associated a present geospatial location with the device 104 as illustrated as circle ‘2’ in FIG. 1.

The radial algorithm 240 may operate as follows, according to one embodiment. The radial algorithm may utilize a radial distribution function (e.g., a pair correlation function)

g(r)

in the neighborhood broadcast network 150. The radial distribution function may describe how density varies as a function of distance from a user 106, according to one embodiment.

If a given user 106 is taken to be at the origin O (e.g., the epicenter 144), and if

ρ=N/V

is the average number density of recipients 114 in the neighborhood broadcast network 150, then the local time-averaged density at a distance 1′ from O is

ρg(r)

according to one embodiment. This simplified definition may hold for a homogeneous and isotropic type of recipients 114, according to one embodiment of the radial algorithm 240.

A more anisotropic distribution (e.g., exhibiting properties with different values when measured in different directions) of the recipients 114 will be described below, according to one embodiment of the radial algorithm 240. In simplest terms it may be a measure of the probability of finding a recipient at a distance of r away from a given user 106, relative to that for an ideal distribution scenario, according to one embodiment. The anisotropic algorithm involves determining how many recipients 114 are within a distance of r and r+dr away from the user 106, according to one embodiment. The radial algorithm 240 may be determined by calculating the distance between all user pairs and binning them into a user histogram, according to one embodiment.

The histogram may then be normalized with respect to an ideal user at the origin o, where user histograms are completely uncorrelated, according to one embodiment. For three dimensions (e.g., such as a building representation in the geospatially constrained social network 142 in which there are multiple residents in each floor), this normalization may be the number density of the system multiplied by the volume of the spherical shell, which mathematically can be expressed as

g(r)_{I}=4πr²ρdr.

where ρ may be the user density, according to one embodiment of the radial algorithm 240.

The radial distribution function of the radial algorithm 240 can be computed either via computer simulation methods like the Monte Carlo method, or via the Ornstein-Zernike equation, using approximate closure relations like the Percus-Yevick approximation or the Hypernetted Chain Theory, according to one embodiment

This may be important because by confining the broadcast reach of a verified user in the neighborhood broadcast network 150 to a specified range, the radial distribution module 140 (e.g., that applies the radial algorithm 240 of FIG. 2 using a series of modules working in concert as described in FIG. 2) may replicate the experience of local radio broadcasting and enable verified users to communicate information to their immediate neighbors as well as receive information from their immediate neighbors in areas that they care about, according to one embodiment. Such methodologies can be complemented with hyperlocal advertising targeted to potential users of the neighborhood broadcast server 100 on preseeded profile pages and/or active user pages of the neighborhood broadcast server 100. Advertisement communications thus may become highly specialized and localized resulting in an increase in their value and interest to the local verified users of the network through the neighborhood broadcast server 100.

The radial distribution module 140 (e.g., that applies the radial algorithm 240 of FIG. 2 using a series of modules working in concert as described in FIG. 2) may solve the problem of trying to locate a receptive audience to a verified user's broadcasts, whether that broadcast may be one's personal music, an advertisement for a car for sale, a solicitation for a new employee, and/or a recommendation for a good restaurant in the area. This radial distribution module 140 (e.g., that applies the radial algorithm 240 of FIG. 2 using a series of modules working in concert as described in FIG. 2) may eliminate unnecessarily broadcasting that information to those who are not receptive to it, both as a transmitter and as a recipient of the broadcast. The radial algorithm saves both time and effort of every user involved by transmitting information only to areas that a user cares about, according to one embodiment.

In effect, the radial algorithm of the neighborhood broadcast server enables users to notify people around locations that are cared about (e.g., around where they live, work, and/or where they are physically located). In one embodiment, the user 106 can be provided ‘feedback’ after the station broadcast data 102 may be delivered to the recipients 114 and/or to the display venues 109 using the radial distribution module 140 (e.g., that applies the radial algorithm 240 of FIG. 2 using a series of modules working in concert as described in FIG. 2) of the neighborhood broadcast server 100. For example, after the station broadcast data 102 may be delivered, the device 104 (e.g., a mobile device 504) may display a message saying: “3256 neighbors around a one-mile radius from you have been notified on their profile pages of your music video notification in Menlo Park” and/or “8356 neighbors around a one-mile radius from you have been notified of your instructional home-repair video.”

The various embodiments described herein of the neighborhood broadcast server 100 using the radial distribution module 140 (e.g., that applies the radial algorithm 240 of FIG. 2 using a series of modules working in concert as described in FIG. 2) may solve a central problem of internet radio service providers (e.g., Pandora) by retaining cultural significance related to a person's locations of association. For example, the radial distribution module 140 (e.g., that applies the radial algorithm 240 of FIG. 2 using a series of modules working in concert as described in FIG. 2) may be used to ‘create’ new radio stations, television stations, and/or mini alert broadcasts to a geospatially constrained area on one end, and provide a means for those ‘tuning in’ to consume information posted in a geospatial area that the listener cares about and/or associates themselves with. The information provided can be actionable in that the user 106 may be able to secure new opportunities through face to face human interaction and physical meeting not otherwise possible in internet radio scenarios.

The radial algorithm may be a set of instructions that may enable users (e.g., verified users, non-verified users) of the Nextdoor.com and Fatdoor.com websites and applications to broadcast their activities (e.g., garage sale, t-shirt sale, crime alert) to surrounding neighbors within a claimed neighborhood and to guests of a claimed neighborhood, according to one embodiment. The radial algorithm may be new because current technology does not allow for users of a network (e.g., Nextdoor.com, Fatdoor.com) to locally broadcast their activity to a locally defined geospatial area. With the radial algorithm, users of the network may communicate with one another in a locally defined manner, which may present more relevant information and activities, according to one embodiment. For example, if a verified user of the network broadcasts an item for sale, locally defined neighbors of the verified user may be much more interested in purchasing the product compared to if the item was for sale in a different town or city, according to one embodiment. The radial distribution module 140 may solve the problem of neighbors living in the locally defined geospatial area who don't typically interact, and allows them to connect within a virtual space that did not exist before, according to one embodiment. The radial algorithm 240 operating through the radial distribution module 140, community boards (e.g., job boards, for sale boards) may have been a method of distributing content in a surrounding neighborhood effectively. However, there was no way to easily distribute content related to exigent circumstances and/or with urgency in a broadcast-like manner to those listening around a neighborhood through mobile devices until the various embodiments applying the radial distribution module 140 as described herein.

A radial algorithm 240 may be a method of calculating a sequence of operations, and in this case a sequence of radio operations, according to one embodiment. Starting from an initial state and initial input, the radial algorithm 240 describes a computation that, when executed, proceeds through a finite number of well-defined successive states, eventually producing radial patterned distribution (e.g., simulating a local radio station), according to one embodiment.

The neighborhood broadcast server 100 may solve technical challenges through the radial distribution module 140 (e.g., that applies the radial algorithm 240 of FIG. 2 using a series of modules working in concert as described in FIG. 2) by implementing a vigorous screening process to screen out any lewd or vulgar content in one embodiment. For example, what may be considered lewd content is subjective, and verified users could argue that we are restricting their constitutional right to freedom of speech through a crowd-moderation capability enabled by the radial distribution module 140 (e.g., that applies the radial algorithm 240 of FIG. 2 using a series of modules working in concert as described in FIG. 2), according to one embodiment. In one embodiment, verified users may sign an electronic agreement to screen their content and agree that the neighborhood broadcast network 150 may delete any content that it deems inappropriate for broadcasting, through the radial distribution module 140 (e.g., that applies the radial algorithm 240 of FIG. 2 using a series of modules working in concert as described in FIG. 2) according to one embodiment.

The radial distribution module 140 (e.g., that applies the radial algorithm 240 of FIG. 2 using a series of modules working in concert as described in FIG. 2) may allow verified users to create and broadcast their own radio show, e.g., music, talk show, commercial, instructional contents, etc., and to choose their neighborhood(s) for broadcasting based on a claimed location, according to one embodiment. The radial distribution module 140 (e.g., that applies the radial algorithm 240 of FIG. 2 using a series of modules working in concert as described in FIG. 2) may allow users to choose the neighborhoods that they would want to receive the broadcasts, live and recorded broadcasts, and/or the types and topics of broadcasts that interest them.

The radial distribution module 140 (e.g., that applies the radial algorithm 240 of FIG. 2 using a series of modules working in concert as described in FIG. 2) based approach of the neighborhood broadcast server 100 may be a completely different concept from the currently existing neighborhood (e.g. geospatial) social networking options. The radial distribution module 140 (e.g., that applies the radial algorithm 240 of FIG. 2 using a series of modules working in concert as described in FIG. 2) may also allow the user to create his/her own radio station, television station and/or other content such as the station broadcast data 102 and distribute this content around locations to users and preseeded profiles around them. The radial distribution module 140 (e.g., that applies the radial algorithm 240 of FIG. 2 using a series of modules working in concert as described in FIG. 2) can allow verified users to create their content and broadcast in the selected geospatial area. It also allows verified listeners to listen to only the relevant local broadcasts of their choice.

The radial distribution module 140 (e.g., that applies the radial algorithm 240 of FIG. 2 using a series of modules working in concert as described in FIG. 2) may be important because it may provide any verified user the opportunity to create his/her own radial broadcast message (e.g., can be audio, video, pictorial and/or textual content) and distribute this content to a broad group. Radial distribution module 140 (e.g., that applies the radial algorithm 240 of FIG. 2 using a series of modules working in concert as described in FIG. 2) may also allow verified listeners to listen to any missed live broadcasts through the prerecorded features, according to one embodiment. Through this, the radial distribution module 140 (e.g., that applies the radial algorithm 240 of FIG. 2 using a series of modules working in concert as described in FIG. 2) changes the way social networks (e.g., Nextdoor, Fatdoor, Facebook, Path, etc.) operate by enabling location centric broadcasting to regions that a user cares about, according to one embodiment. Radial distribution module 140 (e.g., that applies the radial algorithm 240 of FIG. 2 using a series of modules working in concert as described in FIG. 2) may solve a technical challenge by defining ranges based on a type of posting, a type of neighborhood, and/or boundary condition of a neighborhood by analyzing whether the station broadcast data 102 may be associated with a particular kind of broadcast, a particular neighborhood, a temporal limitation, and/or through another criteria.

By using the radial distribution module 140 (e.g., that applies the radial algorithm 240 of FIG. 2 using a series of modules working in concert as described in FIG. 2) of the neighborhood broadcast server 100 the verified user 16 may be able to filter irrelevant offers and information provided by broadcasts. In one embodiment, only the broadcasting user (e.g., the user 106) may be a verified user to create accountability for a particular broadcast and/or credibility of the broadcaster. In this embodiment, recipients 114 of the broadcast may not need to be verified users of the neighborhood broadcast network. By directing traffic and organizing the onslaught of broadcasts, the radial distribution module 140 (e.g., that applies the radial algorithm 240 of FIG. 2 using a series of modules working in concert as described in FIG. 2) of the neighborhood broadcast server 100 may able to identify the origins and nature of each group of incoming information and locate recipients 114 that are relevant/interested in the station broadcast data 102, maximizing the effective use of each broadcast.

The radial distribution module 140 (e.g., that applies the radial algorithm 240 of FIG. 2 using a series of modules working in concert as described in FIG. 2) of the neighborhood broadcast server 100 may process the input data from the device 104 (e.g., a mobile device 504) in order to identify which notification(s) to broadcast to which individual(s). This may be separate from a traditional radio broadcast as it not only geographically constrains broadcasters and recipients 114 but also makes use of user preferences in order to allow broadcasters to target an optimal audience and allow recipients 114 to alter and customize what they consume. The user 106 may associate his/herself with a non-transitory address in order to remain constantly connected to their neighborhood and/or neighbors even when they themselves or their neighbors are away. The radial algorithm 240 may be also unique from a neighborhood social network (e.g., the geospatially constrained social network 142) as it permits users to broadcast offers, information, audio, video etc. to other users, allowing users to create their own stations.

In order to implement the radial distribution module 140 (e.g., that applies the radial algorithm 240 of FIG. 2 using a series of modules working in concert as described in FIG. 2), geospatial data may need to be collected and amassed in order to create a foundation on which users may sign up and verify themselves by claiming a specific address, associating themselves with that geospatial location. The radial distribution module 140 (e.g., that applies the radial algorithm 240 of FIG. 2 using a series of modules working in concert as described in FIG. 2) may then be able to utilize the geospatial database 122 to filter out surrounding noise and deliver only relevant data to recipients 114. In order to accomplish this, the radial distribution module 140 (e.g., that applies the radial algorithm 240 of FIG. 2 using a series of modules working in concert as described in FIG. 2) may be able to verify the reliability of geospatial coordinates, time stamps, and user information associated with the device 104 (e.g., a mobile device 504). In addition, threshold geospatial radii, private neighborhood boundaries, and personal preferences may be established in the neighborhood broadcast server 100 and accommodated using the radial distribution module 140 (e.g., that applies the radial algorithm 240 of FIG. 2 using a series of modules working in concert as described in FIG. 2). The geospatial database 122 may work in concert with the radial distribution module 140 (e.g., that applies the radial algorithm 240 of FIG. 2 using a series of modules working in concert as described in FIG. 2) to store, organize, and manage broadcasts, pushpins, user profiles, preseeded user profiles, metadata, and epicenter 144 locations associated with the geospatially constrained social network 142 (e.g., a neighborhood social network such as Fatdoor.com, Nextdoor.com).

The radial algorithm 240 may be used to calculate relative distances between each one of millions of records as associated with each placed geo-spatial coordinate in the geospatially constrained social network 142 (e.g., a neighborhood social network such as Fatdoor.com, Nextdoor.com). Calculations of relative distance between each geospatial coordinate can be a large computational challenge because of the high number of reads, writes, modify, and creates associated with each geospatial coordinate added to the geospatially constrained social network 142 and subsequent recalculations of surrounding geospatial coordinates associated with other users and/or other profile pages based a relative distance away from a newly added set of geospatial coordinates (e.g., associated with the station broadcast data 102 and/or with other pushpin types). To overcome this computational challenge, the radial algorithm may leverage a massively parallel computing architecture 146 through which processing functions are distributed across a large set of processors accessed in a distributed computing system 148 through the network 101.

In order to achieve the utilization of the massively parallel computing architecture 146 in a context of a radial distribution function of a geospatially constrained social network 142, a number of technical challenges have been overcome in at least one embodiment. Particularly, the radial distribution module 140 constructs a series of tables based on an ordered geospatial ranking based on frequency of interaction through a set of ‘n’ number of users simultaneously interacting with the geospatially constrained social network 142, in one preferred embodiment. In this manner, sessions of access between the neighborhood broadcast server 100 and users of the neighborhood broadcast server 100 (e.g., the user 106) may be monitored based on geospatial claimed areas of the user (e.g., a claimed work and/or home location of the user), and/or a present geospatial location of the user. In this manner, tables associated with data related to claimed geospatial areas of the user and/or the present geospatial location of the user may be anticipatorially cached in the memory 124 to ensure that a response time of the geospatially constrained social network 142 may be not constrained by delays caused by extraction, retrieval, and transformation of tables that are not likely to be required for a current and/or anticipated set of sessions between users and the neighborhood broadcast server 100.

In a preferred embodiment, an elastic computing environment may be used by the radial distribution module 140 to provide for increase/decreases of capacity within minutes of a database function requirement. In this manner, the radial distribution module 140 can adapt to workload changes based on number of requests of processing simultaneous and/or concurrent requests associated with station broadcast data 102 by provisioning and deprovisioning resources in an autonomic manner, such that at each point in time the available resources match the current demand as closely as possible.

The radial distribution module 140 (e.g., that applies the radial algorithm 240 of FIG. 2 using a series of modules working in concert as described in FIG. 2) may be a concept whereby a server communicating data to a dispersed group of recipients 114 over a network 101, which may be an internet protocol based wide area network (as opposed to a network communicating by radio frequency communications) communicates that data only to a geospatially-constrained group of recipients 114. The radial distribution module 140 (e.g., that applies the radial algorithm 240 of FIG. 2 using a series of modules working in concert as described in FIG. 2) may apply a geospatial constraint related to a radial distance away from an origin point, or a constraint related to regional, state, territory, county, municipal, neighborhood, building, community, district, locality, and/or other geospatial boundaries.

The radial distribution module 140 (e.g., that applies the radial algorithm 240 of FIG. 2 using a series of modules working in concert as described in FIG. 2) may be new as applied to data traveling over wide area networks using internet protocol topology in a geospatial social networking and commerce context, according to one embodiment. While radio broadcasts, by their nature, are transmitted in a radial pattern surrounding the origin point, there may be no known mechanism for restricting access to the data only to verified users of a service subscribing to the broadcast. As applied to wired computer networks, while techniques for applying geospatial constraints have been applied to search results, and to other limited uses, there has as yet been no application of geospatial constraint as applied to the various embodiments described herein using the radial distribution module 140 (e.g., that applies the radial algorithm 240 of FIG. 2 using a series of modules working in concert as described in FIG. 2).

The radial distribution module 140 (e.g., that applies the radial algorithm 240 of FIG. 2 using a series of modules working in concert as described in FIG. 2) may be roughly analogous to broadcast radio communications such as a) in broadcast radio, b) in wireless computer networking, and c) in mobile telephony. However, all of these systems broadcast their information promiscuously, making the data transmitted available to anyone within range of the transmitter who may be equipped with the appropriate receiving device. In contrast, the radial distribution module 140 (e.g., that applies the radial algorithm 240 of FIG. 2 using a series of modules working in concert as described in FIG. 2) herein describes a system in which networks are used to transmit data in a selective manner in that information may be distributed around a physical location of homes or businesses in areas of interest/relevancy.

The radial distribution module 140 (e.g., that applies the radial algorithm 240 of FIG. 2 using a series of modules working in concert as described in FIG. 2) may solve a problem of restricting data transmitted over networks to specific users who are within a specified distance from the individual who originates the data. In a broad sense, by enabling commerce and communications that are strictly limited within defined neighborhood boundaries, the radial distribution module 140 (e.g., that applies the radial algorithm 240 of FIG. 2 using a series of modules working in concert as described in FIG. 2) may enable the geospatially constrained social network 142 (e.g., a neighborhood social network such as Fatdoor.com, Nextdoor.com) communications, attacking the serious social conditions of anonymity and disengagement in community that afflict the nation and, increasingly, the world.

The radial distribution module 140 (e.g., that applies the radial algorithm 240 of FIG. 2 using a series of modules working in concert as described in FIG. 2) may comprise one or more modules that instruct the neighborhood broadcast server 100 to restrict the broadcasting of the station broadcast data 102 to one or more parts of the geospatial area 117. For example, in the embodiment of FIG. 1, the radial distribution module 140 (e.g., that applies the radial algorithm 240 of FIG. 2 using a series of modules working in concert as described in FIG. 2) may instruct the neighborhood broadcast server 100 to broadcast the station broadcast data 102 to the recipients 114 but not to the area outside the threshold radial distance 119.

In one or more embodiments, the radial distribution module 140 (e.g., that applies the radial algorithm 240 of FIG. 2 using a series of modules working in concert as described in FIG. 2) may allow the neighborhood broadcast server 100 to function in manner that simulates a traditional radio broadcast (e.g., using a radio tower to transmit a radio frequency signal) in that both the neighborhood broadcast server 100 and the radio broadcast are restricted in the geospatial scope of the broadcast transmission. In one or more embodiments, the radial distribution module 140 (e.g., that applies the radial algorithm 240 of FIG. 2 using a series of modules working in concert as described in FIG. 2) may prevent the broadcast of the station broadcast data 102 to any geospatial area to which the user 106 does not wish to transmit the station broadcast data 102, and/or to users that have either muted and/or selectively subscribed to a set of broadcast feeds.

The radial distribution module 140 (e.g., that applies the radial algorithm 240 of FIG. 2 using a series of modules working in concert as described in FIG. 2) may analyze the station broadcast data 102 to determine which recipients 114 may receive notification data 112 within a threshold radial distance 119 (e.g., set by the user 106 and/or auto calculated based on a type of posting). The radial distribution module 140 (e.g., that applies the radial algorithm 240 of FIG. 2 using a series of modules working in concert as described in FIG. 2) may use a variety of parameters, including information associated with the station broadcast data (e.g. location, type, etc.) to determine the threshold radial distance 119.

The radial distribution module 140 (e.g., that applies the radial algorithm 240 of FIG. 2 using a series of modules working in concert as described in FIG. 2) may also determine which verified addresses associated with recipients 114 having verified user profiles are located within the threshold radial distance 119. The radial distribution module 140 (e.g., that applies the radial algorithm 240 of FIG. 2 using a series of modules working in concert as described in FIG. 2) may then broadcast the notification data 112 to the profiles and/or mobile devices 504 of the verified users having verified addresses within the threshold radial distance 119.

The radial distribution module 140 (e.g., that applies the radial algorithm 240 of FIG. 2 using a series of modules working in concert as described in FIG. 2) may therefore simulate traditional radio broadcasting (e.g. from a radio station transmission tower) over the IP network. Thus, the radial distribution module 140 (e.g., that applies the radial algorithm 240 of FIG. 2 using a series of modules working in concert as described in FIG. 2) may allow the broadcast to include information and data that traditional radio broadcasts may not be able to convey, for example geospatial coordinates and/or real-time bi-directional communications. Additionally, the radial distribution module 140 (e.g., that applies the radial algorithm 240 of FIG. 2 using a series of modules working in concert as described in FIG. 2) may allow individual users low-entry broadcast capability without resort to expensive equipment and/or licensing by the Federal Communications Commission (FCC).

Another advantage of this broadcast via the radial distribution module 140 (e.g., that applies the radial algorithm 240 of FIG. 2 using a series of modules working in concert as described in FIG. 2) may be that it may bypass obstructions that traditionally disrupt radio waves such as mountains and/or atmospheric disturbances. Yet another advantage of the radial distribution module 140 (e.g., that applies the radial algorithm 240 of FIG. 2 using a series of modules working in concert as described in FIG. 2) may be that it may expand the physical distance of broadcast capability without resort to the expense ordinarily associated with generating powerful carrier signals. In yet another advantage, the radial distribution module 140 (e.g., that applies the radial algorithm 240 of FIG. 2 using a series of modules working in concert as described in FIG. 2) may allow for almost unlimited channels and/or stations as compared to traditional radio where only a narrow band of electromagnetic radiation has been appropriated for use among a small number of entities by government regulators (e.g. the FCC).

The user 106 may be an individual who operates the device 104 (e.g., a mobile device 504) to generate the station broadcast data 102. It will be understood by those skilled in the art that the verified nature of the user may be an optional characteristic in an alternate embodiment. This means that in an alternate embodiment, any user (whether verified or not) may generate the station broadcast data 102 through the device 104 (e.g., a mobile device 504). In another alternative embodiment, the user 106 may be an electronic sensor, such as a detection sensor device (e.g., a sensory detection sensor device such as a motion detector, a chemical detection device, etc.), and/or an appliance (e.g., such as a refrigerator, a home security network, and/or a motion detector). It should also be noted that the ‘mobile’ nature of the device 104 may be optional in yet another alternative embodiment. In such an alternate embodiment, any computing device, whether mobile/portable or fixed in location may generate the station broadcast data 102.

The cellular network 108 may be associated with a telephone carrier (e.g., such as AT&T, Sprint, etc.) that provides an infrastructure through which communications are generated between the neighborhood broadcast server 100 and the display venues 109 using the radial algorithm 240. For example, the cellular network 108 may provide a communication infrastructure through which the station broadcast data 102 may be communicated as voice and/or text messages through telephones (e.g., standard telephones and/or smart phones) operated by at least some of the display venues 109 of FIG. 1. It should be understood that in one embodiment, the display venues 109 are paid subscribers/customers of the geospatially constrained social network 142 in a manner such that each of the display venues 109 may pay a fee per received station broadcast data 102, and/or each hired engagement to the geospatially constrained social network 142. The display venues 109 may pay extra to be permitted access to receive the station broadcast data 102 even when they do not have a transitory and/or non-transitory connection to a neighborhood if they service that neighborhood area though operating their business outside of it. For this reason, FIG. 1 visually illustrates that the display venues 109 may be located (e.g., principal business address) outside the threshold radial distance 119.

The cellular network 108 (e.g., a mobile network) may be a wireless network distributed over land areas called cells, each served by at least one fixed-location transceiver, known as a cell site or base station through which the station broadcast data 102 is distributed from the neighborhood broadcast server 100 to telephones of the display venues 109 using the radial distribution module 140 (e.g., that applies the radial algorithm 240 of FIG. 2 using a series of modules working in concert as described in FIG. 2), according to one embodiment. The cellular network 108 may use a set of frequencies from neighboring cells, to avoid interference and provide guaranteed bandwidth within each cell, in one embodiment.

When joined together these cells of the cellular network 108 may provide radio coverage over a wide geographic area through the cellular network 108 in a manner that ensures that the station broadcast data 102 may be simultaneously communicated via both IP networks (e.g., to the recipients 114) and/or to the display venues 109 through the cellular network 108. It will be appreciated that the radial distribution module 140 (e.g., that applies the radial algorithm 240 of FIG. 2 using a series of modules working in concert as described in FIG. 2) in effect permits simultaneous updates to claimed user pages, unclaimed (preseeded) user pages in a geospatially constrained social network 142 (e.g., neighborhood social network) based on a geospatial location of the device 104 (e.g., a mobile device 504) in a manner that simulates a radio (RF) based network separately from the concepts described in conjunction with the cellular network 108. However, it will be understood that the radial distribution module 140 (e.g., that applies the radial algorithm 240 of FIG. 2 using a series of modules working in concert as described in FIG. 2) may be not restricted to such topology and can multimodally communicate through different networks, such as through the cellular network 108 described in FIG. 1.

The display venues 109 may be locations, devices, and/or mobile phones associated with people or locations that present content to small or large groups of people. The display venues 109 may be notified when a broadcast in an area that they care about including a non-transitory location (e.g., around where they live and/or work, regardless of where they currently are) and a transitory location (e.g., where they currently are) is posted using the device 104 (e.g., a mobile device 504) as the station broadcast data 102.

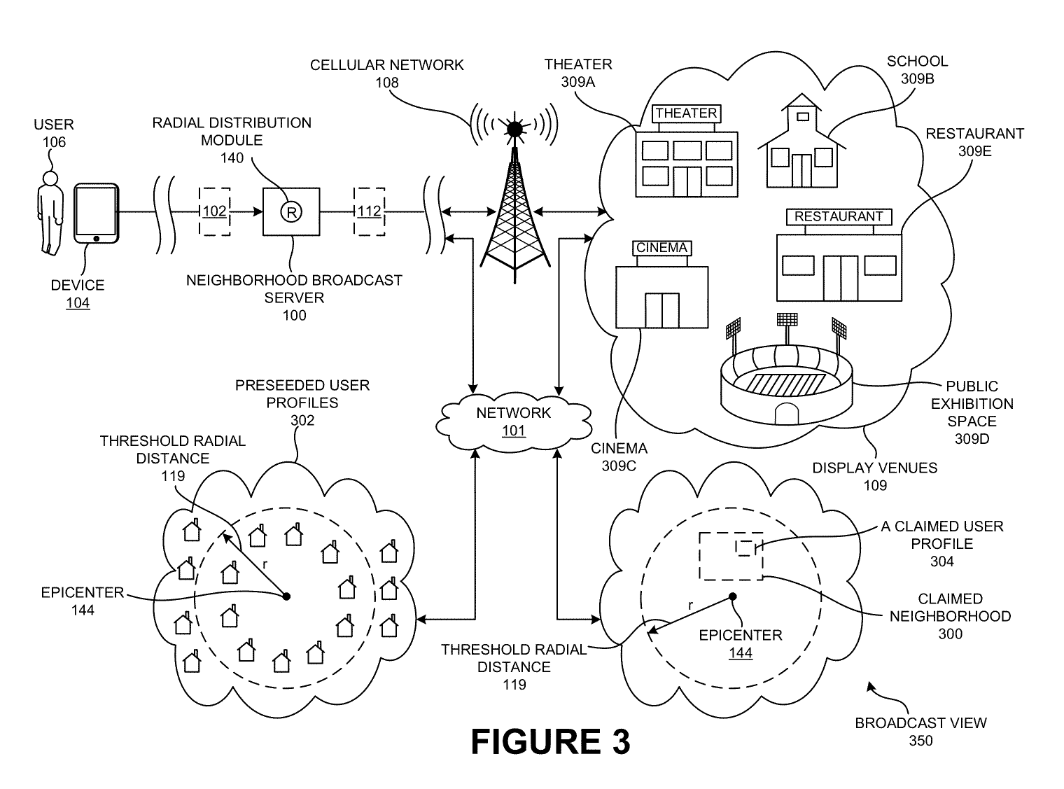

The display venues 109 are illustrated in FIG. 3 as including a theater 309A, a school 309B, a cinema 309C, and a public exhibition space 309D. In this manner, mobile devices 504 and/or desktop computers operated by the display venues 109 may be alerted whenever the station broadcast data 102 is posted in and/or around their neighborhood through a push notification (e.g., an alert popping up on their phone), through an email, a telephone call, and/or a voice message delivered to the particular mobile device 504 operated by each of the display venues 109 using the radial distribution module 140 (e.g., that applies the radial algorithm 240 of FIG. 2 using a series of modules working in concert as described in FIG. 2).

The station broadcast data 102 may be delivered as notification data 112 (which may include a number of attributes as later will be described with reference to FIG. 2) from the neighborhood broadcast server 100 to the recipients 114 and/or to the display venues 109 using the radial distribution module 140 (e.g., that applies the radial algorithm 240 of FIG. 2 using a series of modules working in concert as described in FIG. 2) of the neighborhood broadcast server 100.

The recipients 114 may be individuals that have claimed a profile (e.g., verified their profile through a postcard, a telephone lookup, a utility bill) associated with a particular non-transitory address (e.g., a home address, a work address) through a geospatial social network (e.g., a geospatially constrained social network 142 (e.g., a neighborhood social network such as Fatdoor.com, Nextdoor.com)) through which the neighborhood broadcast server 100 operates. The recipients 114 may be in a geo-fenced area, in that an epicenter 144 of a broadcast message from the device 104 (e.g., a mobile device 504) may be a center through which a radial distance is calculated based on a characteristic of the station broadcast data 102. For example, a short term job (e.g., moving furniture) may be delivered only to an immediate 0.1 mile radius, and a permanent job opening may be automatically delivered to a broader 0.6 mile radius either automatically and/or through a user defined preference (e.g., set by the user 106).

It should be appreciated that individuals in an area outside the threshold radial distance 115 may not receive the station broadcast data 102 because their geospatial address may be outside a radial boundary surrounding an epicenter 144 in which the station broadcast data 102 originates. Additionally, the threshold radial distance 119 may be confined on its edges by a geospatial polygon at a juncture between area defined by recipients 114 and the area outside the threshold radial distance 119, according to one embodiment.

FIG. 2 is an exploded view of the radial distribution module 140 of FIG. 1 that applies the radial algorithm 240, according to one embodiment.

Particularly, FIG. 2 illustrates an exploded view of the radial distribution module 140, according to one embodiment. A variety of software instruction sets and/or hardware components form the radial distribution module 140, according to one embodiment. Select ones of these software instruction sets and/or hardware components utilize the radial algorithm 240 to perform functions related to radially distributing information to pre-seeded user profiles, user profiles, and telephone devices (e.g., land based phones, circuit switched phones).

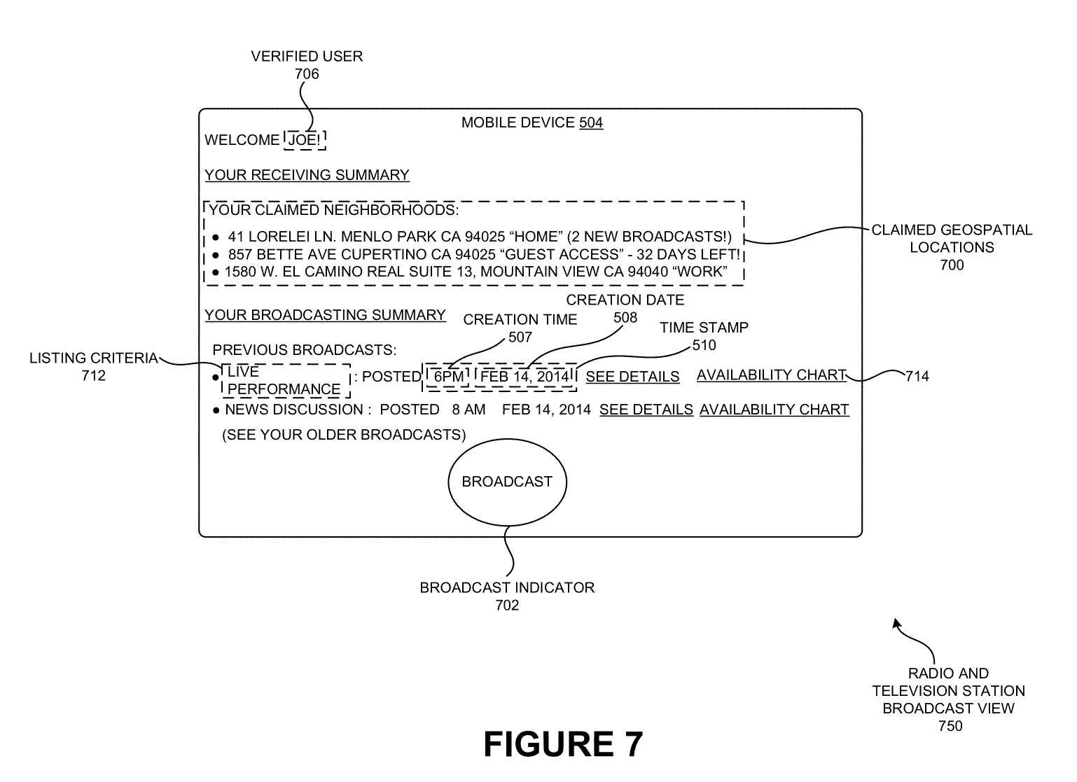

A validation module 200 may determine that a station broadcast data 102 generated through a mobile device 504 may be associated with a verified user (e.g., the user 106 of FIG. 1 as described as the verified user 706 in FIG. 7) of the neighborhood broadcast server 100) using a processor 120 and/or a memory 124. In addition, the validation module 200 may determine that the station broadcast data (e.g., the station broadcast data 102) is generated by the validated user (e.g., the user 106 of FIG. 1 as described as the verified user 706 in FIG. 7) of the neighborhood broadcast system (e.g., of the geospatially constrained social network 142) when analyzing that the station broadcast data (e.g., the station broadcast data 102) is associated with the mobile device 504. The validation module 200 may apply the radial algorithm 240 to determine if the verified user 706 may be in a validated geospatial location based on previous history of the verified user 706, according to one embodiment.

In addition, the validation module 200 may ensure that a set of geospatial coordinates 103 associated with the station broadcast data 102 generated through the mobile device 504 are trusted based on a claimed geospatial location (e.g., any of the claimed geospatial locations 700 as described in FIG. 7) of the verified user (e.g., the user 106 of FIG. 1 as described as the verified user 706 in FIG. 7) of the neighborhood broadcast server 100.

A time stamp module 202 may determine that a time stamp 510 associated with a creation date 508 and/or a creation time 507 of the station broadcast data 102 generated through the mobile device 504 may be trusted based on the claimed geospatial location (e.g., any of the claimed geospatial locations 700 as described in FIG. 7 of the verified user (e.g., the user 106 of FIG. 1 as described as the verified user 706 in FIG. 7) of the neighborhood broadcast server 100). A listing module 272 may determine a listing criteria 712 associated with the station broadcast data 102 including a description, a photograph, a video, a category, a functional status of a station broadcast offered through the station broadcast data 102. A charting module 204 may populate an availability chart 714 when the station broadcast associated with the listing criteria 712 may be posted, wherein the availability chart 714 includes a target area radius, a start timing, and/or a duration amount. A verification module 260 may also determine that the station broadcast data 102 is generated by a verified user 706 of the neighborhood broadcast system when validating that the station broadcast data 102 is associated with the device 104. A communication determining module 280 may determine that an application on the device 104 may be communicating the station broadcast data 102 to the neighborhood broadcast server 100 when the station broadcast data 102 may be processed. An application module 274 may communicate the station broadcast data (e.g., the station broadcast data 102) to the neighborhood broadcasting system when the station broadcast data (e.g., the station broadcast data 102) may be processed, and/or to associate the verified user (e.g., the user 106 of FIG. 1 as described as the verified user 706 in FIG. 7) with a verified user (e.g., the user 106 of FIG. 1 as described as the verified user 706 in FIG. 7) profile in the neighborhood broadcasting system through the application on the device 104.

A pushpin module 206 may present the station broadcast data 102 generated through the device 104 as a station broadcast alert pushpin of the station broadcast in a geospatial map surrounding pre-populated residential and/or business listings in a surrounding vicinity, such that the station broadcast alert pushpin of the station broadcast may be automatically presented on the geospatial map in addition to being presented on the set of user profiles (e.g., preseeded user profiles 302 and/or claimed user profiles 304 as described in FIG. 3 having associated verified addresses in the threshold radial distance 119 from the set of geospatial coordinates 103 associated with the station broadcast data 102 generated through the device 104 of the verified user (e.g., the user 106 of FIG. 1 as described as the verified user 706 in FIG. 7) of the neighborhood broadcast server 100).

A radial distribution module 140 may radially distribute the station broadcast data 102 generated through the device 104 through an on-page posting, an electronic communication, and/or a push notification delivered to desktop and/or mobile devices 504 associated with users and/or their user profiles (e.g., preseeded user profiles 302 and/or claimed user profiles 304 as described in FIG. 3) around an epicenter 144 defined at the set of geospatial coordinates 103 associated with the station broadcast data 102 generated through the device 104 to all subscribed user profiles (e.g., preseeded user profiles 302 and/or claimed user profiles 304 as described in FIG. 3) in a circular geo-fenced area defined by the threshold distance from the set of geospatial coordinates 103 associated with the station broadcast data 102 generated through the device 104 through the radial algorithm 240 of a neighborhood broadcasting system that measures a distance away of each address associated with each user profile from the current geospatial location at the epicenter 144.

A placement module 232 may enable the verified user (e.g., the user 106 of FIG. 1 as described as the verified user 706 in FIG. 7) to drag and/or drop the station broadcast alert pushpin on any location on the geospatial map, and/or automatically determining a latitude and/or a longitude associated a placed location.

A notification module 208 may automatically notify a theater 309A, a school 309B, a cinema 309C, a public exhibition space 309D, and/or a restaurant 309E in a surrounding geospatial area to the set of geospatial coordinates 103 associated with the station broadcast data 102 generated through the device 104. An extraction module 234 may separate the geospatial coordinates 103 from a metadata associated with the station broadcast data 102 generated through the device 104 when verifying that the set of geospatial coordinates 103 associated with the station broadcast data 102 generated through the device 104 are trusted based on the claimed geospatial location (e.g., any of the claimed geospatial locations 700 as described in FIG. 7 of the verified user (e.g., the user 106 of FIG. 1 as described as the verified user 706 in FIG. 7) of the neighborhood broadcast server 100).

A matching module 210 may determine a relative match between a persistent clock associated with the neighborhood broadcast server 100 and/or a digital clock of the device 104 to determine that the time stamp 510 associated with the creation date 508 and/or time of the station broadcast data 102 generated through the device 104 may be accurate and/or therefore trusted. A deletion module 236 may automatically remove a publishing of the station broadcast data 102 generated through the device 104 on a set of user profiles (e.g., preseeded user profiles 302 and/or claimed user profiles 304 as described in FIG. 3 having associated verified addresses in the threshold radial distance 119 from the set of geospatial coordinates 103 associated with the station broadcast data 102 generated through the device 104 of the verified user (e.g., the user 106 of FIG. 1 as described as the verified user 706 in FIG. 7) of the neighborhood broadcast server 100) based on a station broadcast alert expiration time. A plotting module 238 may geocode a set of residential addresses each associated with a resident name in a neighborhood surrounding the device 104.

A data-seeding module 241 may prepopulate the set of residential addresses each associated with the resident name as the set of user profiles (e.g., preseeded user profiles 302 and/or claimed user profiles 304 as described in FIG. 3 in the threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the neighborhood broadcast server 100) in a neighborhood curation system (e.g., part of the geospatially constrained social network 142) communicatively coupled with the neighborhood broadcast server 100. A modification module 242 may alter content in each of the set of user profiles (e.g., preseeded user profiles 302 and/or claimed user profiles 304 as described in FIG. 3). A discovery module 244 may track the modified content through the neighborhood curation system (e.g., part of the geospatially constrained social network 142). An undo module 246 may generate a reversible history journal associated with each of the set of user profiles (e.g., preseeded user profiles 302 and/or claimed user profiles 304 as described in FIG. 3 such that a modification of the verified user (e.g., the user 106 of FIG. 1 as described as the verified user 706 in FIG. 7) can be undone on a modified user profile page. A reputation module 248 may determine an editing credibility of the verified user (e.g., the user 106 of FIG. 1 as described as the verified user 706 in FIG. 7) based on an edit history of the verified user (e.g., the user 106 of FIG. 1 as described as the verified user 706 in FIG. 7) and/or a community contribution validation of the verified user (e.g., the user 106 of FIG. 1 as described as the verified user 706 in FIG. 7) by other users of the neighborhood curation system (e.g., part of the geospatially constrained social network 142).

A publishing module 214 may automatically communicate the station broadcast data 102 generated through the device 104 to a set of user profiles (e.g., preseeded user profiles 302 and/or claimed user profiles 304 as described in FIG. 3 having associated verified addresses in a threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the neighborhood broadcast server 100) using the radial algorithm 240. A claiming module 250 may process a claim request of the verified user (e.g., the user 106 of FIG. 1 as described as the verified user 706 in FIG. 7) generating the station broadcast data 102 generated through the device 104 to be associated with an address of the neighborhood curation system (e.g., part of the geospatially constrained social network 142). A private-neighborhood module 252 may determine if the claimable neighborhood in the neighborhood curation system (e.g., part of the geospatially constrained social network 142) may be associated with a private neighborhood community in the claimable neighborhood of the neighborhood curation system (e.g., part of the geospatially constrained social network 142).

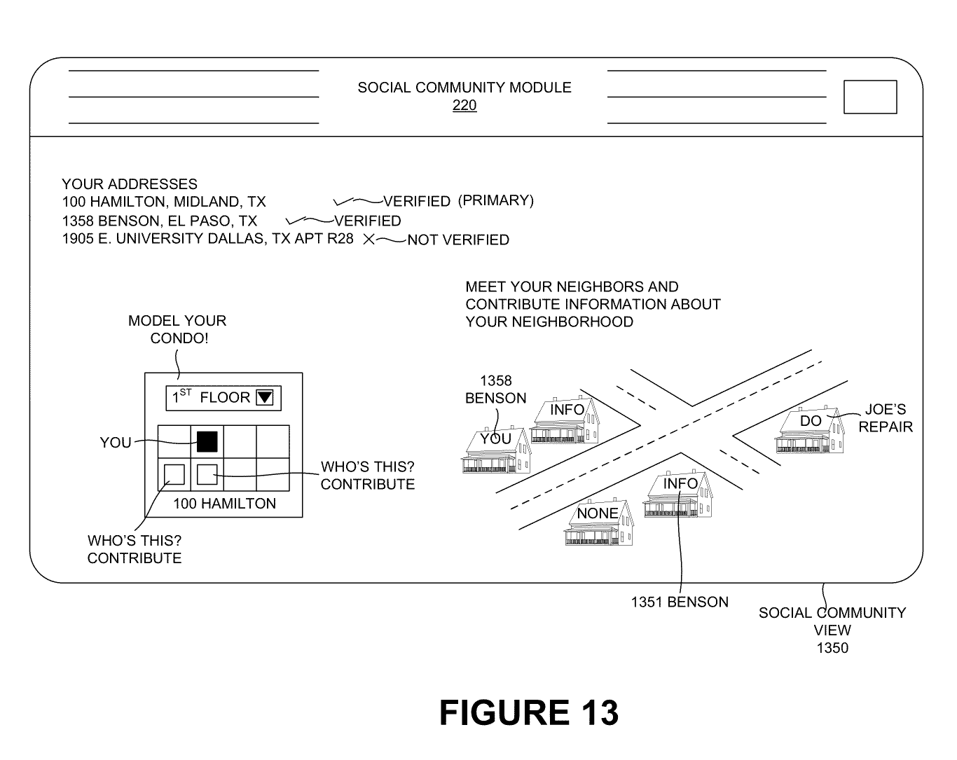

An association module 216 may associate the verified user (e.g., the user 106 of FIG. 1 as described as the verified user 706 in FIG. 7) with the private neighborhood community in the claimable neighborhood of the neighborhood curation system (e.g., part of the geospatially constrained social network 142) if the private neighborhood community has been activated by the verified user (e.g., the user 106 of FIG. 1 as described as the verified user 706 in FIG. 7) and/or a different verified user (e.g., the user 106 of FIG. 1 as described as the verified user 706 in FIG. 7). A boundary module 254 may permit the verified user (e.g., the user 106 of FIG. 1 as described as the verified user 706 in FIG. 7) to draw a set of boundary lines in a form of a geospatial polygon such that the claimable neighborhood in a geospatial region surrounding the claim request creates the private neighborhood community in the neighborhood curation system (e.g., part of the geospatially constrained social network 142) if the private neighborhood community may be inactive. A social community module 220 may enable users 106 to interact with other users and/or contribute information about the neighborhood. The social community module 220 is best described in FIG. 13. An address type module 256 may verify the claim request of the verified user (e.g., the user 106 of FIG. 1 as described as the verified user 706 in FIG. 7) generating the station broadcast data 102 generated through the device 104 to be associated with a neighborhood address of the neighborhood curation system (e.g., part of the geospatially constrained social network 142) when the address may be determined to be associated with a work address and/or a residential address of the verified user (e.g., the user 106 of FIG. 1 as described as the verified user 706 in FIG. 7).

A concurrency module 258 may simultaneously publish the station broadcast data 102 generated through the device 104 on the private neighborhood community associated with the verified user (e.g., the user 106 of FIG. 1 as described as the verified user 706 in FIG. 7) generating the station broadcast data 102 generated through the device 104 in the threshold radial distance 119 from the address associated with the claim request of the verified user (e.g., the user 106 of FIG. 1 as described as the verified user 706 in FIG. 7) of the neighborhood curation system (e.g., part of the geospatially constrained social network 142) when automatically publishing the station broadcast data 102 generated through the device 104 on a set of user profiles (e.g., preseeded user profiles 302 and/or claimed user profiles 304 as described in FIG. 3 having associated verified addresses in a threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the neighborhood broadcast server 100) based on a set of preferences of the verified user (e.g., the user 106 of FIG. 1 as described as the verified user 706 in FIG. 7) using the radial algorithm 240.

A summary module 262 may provide a summary data to the verified user 706 generating the station broadcast data 102 through the device 104 of how many user profile pages were updated with an alert of the station broadcast data 102 when publishing the station broadcast data 102 in the private neighborhood community and/or the set of user profiles having associated verified addresses in the threshold radial distance 119 from the current geospatial location of the mobile device 504 based on the set of preferences of the verified user 706.

A live broadcast module 228 may live broadcast the station broadcast data 102 generated through the device 104 to the different verified user (e.g., the user 106 of FIG. 1 as described as the verified user 706 in FIG. 7) and/or other verified user (e.g., the user 106 of FIG. 1 as described as the verified user 706 in FIG. 7) in the private neighborhood community and/or currently within the threshold radial distance 119 from the current geospatial location through the neighborhood broadcast server 100 through a multicast algorithm such that a live broadcast multicasts to a plurality of data processing systems associated with each of the different user and/or the other verified user (e.g., the user 106 of FIG. 1 as described as the verified user 706 in FIG. 7) simultaneously when the device 104 of the verified user (e.g., the user 106 of FIG. 1 as described as the verified user 706 in FIG. 7) generating the live-broadcast enables broadcasting of the station broadcast data 102 generated through the device 104 to any one of a geospatial vicinity around the device 104 of the verified user (e.g., the user 106 of FIG. 1 as described as the verified user 706 in FIG. 7) generating the broadcast and/or in any private neighborhood community in which the verified user (e.g., the user 106 of FIG. 1 as described as the verified user 706 in FIG. 7) has a non-transitory connection.

A bi-directional communication module 230 may permit the different verified user (e.g., the user 106 of FIG. 1 as described as the verified user 706 in FIG. 7) and/or other verified user (e.g., the user 106 of FIG. 1 as described as the verified user 706 in FIG. 7) in the private neighborhood community to bi-directionally communicate with the verified user (e.g., the user 106 of FIG. 1 as described as the verified user 706 in FIG. 7) generating the broadcast through the neighborhood broadcast server 100. A moderation module 264 may apply a crowdsourced moderation algorithm in which multiple neighbors to a geospatial area determine what content contributed to the neighborhood broadcast server 100 persists and/or which may be deleted. A muting module 266 may permit users to mute messages of specific verified user (e.g., the user 106 of FIG. 1 as described as the verified user 706 in FIG. 7) to prevent misuse of the neighborhood broadcast server 100.

A threshold module 268 may automatically set the threshold distance between 0.2 and/or 0.4 miles from the set of geospatial coordinates 103 associated with the station broadcast data 102 generated through the device 104 to optimize a relevancy of the live-broadcast. A non-transitory module 270 may determine any private neighborhood community in which the verified user (e.g., the user 106 of FIG. 1 as described as the verified user 706 in FIG. 7) has a non-transitory connection may be a residential address of the verified user (e.g., the user 106 of FIG. 1 as described as the verified user 706 in FIG. 7) and/or a work address of the verified user (e.g., the user 106 of FIG. 1 as described as the verified user 706 in FIG. 7) that has been confirmed by the neighborhood broadcast server 100 as being associated with the verified user (e.g., the user 106 of FIG. 1 as described as the verified user 706 in FIG. 7).

A television module 222 may generate a set of neighborhood television stations distributed through the internet protocol network such that recipients in a region bounded by the threshold radial distance are permitted to access and tune in each of the set of neighborhood television stations based a claimed neighborhood profile or a current geospatial location of the recipient. A radio module 226 may generate a set of neighborhood radio stations distributed through the internet protocol network such that recipients in a region bounded by the threshold radial distance are permitted to access and tune in to each of the set of neighborhood radio stations based on the claimed neighborhood profile or the current geospatial location of the recipient.

FIG. 3 is a broadcast view that demonstrates how the radial distribution module of FIG. 1 is used to communicate a station broadcast data 102 to claimed user profiles, pre-seeded user profiles, and to telephone devices through a heterogeneous network formed through the internet protocol network of FIG. 1 and through a cellular network, according to one embodiment.

Particularly, FIG. 3 illustrates a broadcast view 350, according to one embodiment. FIG. 3 introduces a claimed neighborhood 300, a set of preseeded user profiles 302, and a claimed user profile 304, and their relationships with elements previously described in FIG. 1. In addition, FIG. 3 explains the set of display venues 109 of FIG. 1 to include a theater 309A, a school 309B, a cinema 309C, a public exhibition space 309D, and a restaurant 309H.

In FIG. 3, the claimed neighborhood 300 may refer to a region that may be claimed by the user 106 as being associated with a non-transitory location (e.g., a work address, a home address) of the user 106. The preseeded user profiles 302 may refer to address information from people and/or business directories that has been prepopulated in the geospatial social map and/or may be associated with manually placed pushpins on the geospatial map in the geospatially constrained social network 142 of FIG. 1. The claimed user profile 304 may refer to the verified user 706 associated with a verified address in the geospatial social map and/or may be associated with claimed pushpin (e.g., a previously preseeded residential and/or business profile) on the geospatial map in the geospatially constrained social network 142 of FIG. 1.

The theater 309A, the school 309B, the cinema 309C, the public exhibition space 309D, and the restaurant 309E may receive the station broadcast data 102 through their mobile devices 504, desktop devices, and/or through their cellular telephones. The theater 309A, the school 309B, the cinema 309C, the public exhibition space 309D and the restaurant 309E may receive the station broadcast data 102 and may bi-directionally interact with the display venues 109 through either cellular and/or through the network 101 (e.g., an internet protocol network).

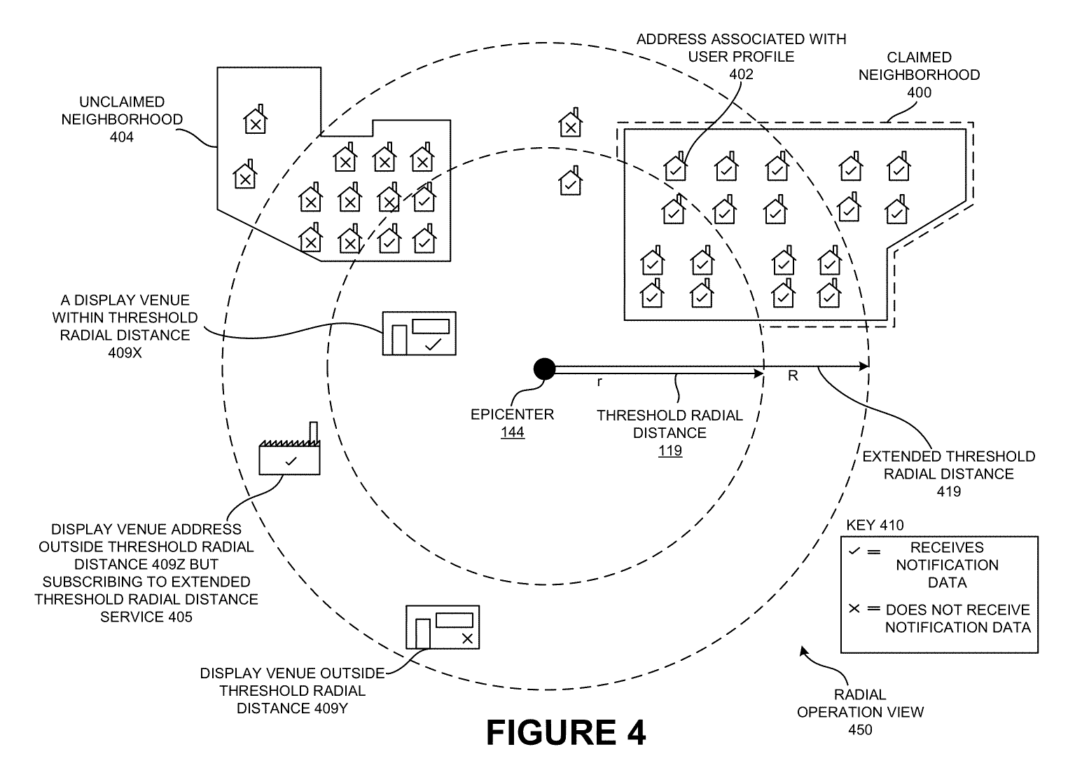

The notification data 112 may be communicated through the network 101 to the preseeded user profiles 302 within a threshold radial distance 119 of the epicenter 144. Alternately, the notification data 112 may be communicated through the network 101 to different ones of the claimed user profile 304 within the claimed neighborhood 300 that are located within the threshold radial distance 119 from the epicenter 144. Additionally, as described in FIG. 4, it will be understood that the claimed neighborhood 300 may be situated partially within the threshold radial distance 119 and partially outside the threshold radial distance 119, yet the notification data 112 received by of the recipients 114 (e.g., having a claimed user profile) may be propagated to other claimed user profiles within the claimed neighborhood 300 even though they are outside the threshold radial distance 119.

The notification data 112 may also be communicated through the cellular network 108 or through the network 101 to the set of display venues 109. Additionally, it should be understood that other types of businesses may receive the notification data 112. FIG. 4 is a radial operation view 450 that illustrates an expansion of a threshold radial distance based on a claimed neighborhood 400 at a radial boundary surrounding the epicenter 144 formed by geospatial coordinates of the device of FIG. 1, according to one embodiment. FIG. 4 illustrates a claimed neighborhood 400, an address associated with a user profile 402, an unclaimed neighborhood 404, a service provider address outside the threshold radial distance as described in operation 409Z but subscribing to extend the threshold radial distance as described in operation 405, a service provider address within the threshold radial distance as described in operation 409X, a service provider within the threshold radial distance as described in operation 409X, a service provider outside the threshold radial distance in operation 409Y, and a key 410. The key 410 describes that a ‘checkmark’ inside a home in either the claimed neighborhood 400 and/or the unclaimed neighborhood 404 indicates that the station broadcast data 102 reaches a user associated with that address at a radial geospatial distance away. In contrast, the key 410 describes that an ‘X mark’ inside a home in either the claimed neighborhood 400 and/or the unclaimed neighborhood 404 indicates that the station broadcast data 102 does not reach a user associated with that address at a radial geospatial distance away.

Particularly, in FIG. 4, an address associated with each user profile 402 is illustrated, according to one embodiment. In FIG. 4, because the claimed neighborhood 400 is partially within the threshold radial distance ‘r’, every verified user in the claimed neighborhood 400 receives the station broadcast data 102, according to one embodiment. Thereby, the radial broadcast distance ‘r’ is extended to a′ as illustrated in FIG. 4 (e.g., the extended threshold radial distance 419 of FIG. 4). It should be understood that in an alternate embodiment, the radial broadcast of the station broadcast data 102 may not extend to the entire group of users of the claimed neighborhood 400. However, to promote neighborhood communication and cooperation, the station broadcast data 102 is illustrated as being extended to the claimed neighborhood 400 in the embodiment of FIG. 4.

It should be also noted that in some embodiments, the “preseeded user profiles” may be users that have previously signed up for the geospatially constrained social network 142, as opposed to users that have been preseeded there in a social network. For example, in one alternate embodiment, each of the claimed neighborhood 400 may serve as an approximate to actual radial distribution, in that broadcast messages are solely sent to claimed neighborhoods (e.g., private claimed neighborhoods) of actual users in a vicinity of a broadcast (rather than to public profiles).

FIG. 4 also illustrates an unclaimed neighborhood 404. The unclaimed neighborhood 404 may be preseeded based on public data, according to one embodiment. The unclaimed neighborhood has within it a series of addresses (e.g., associated with non-transitory homes and/or business locations), according to one embodiment as illustrated in FIG. 4. Those addresses in the unclaimed neighborhood 404 to whom the station broadcast data 102 is delivered have a ‘checkmark’, according to one embodiment. In contrast, those addresses in the unclaimed neighborhood 404 to whom the station broadcast data 102 is not delivered have an ‘X mark’, as illustrated in FIG. 4. Particularly, addresses in the radial boundary ‘r’ have a check mark, whereas addresses that extend from the radial boundary ‘r’ (e.g., and therefore outside the threshold radial distance 119) are marked with the ‘X mark’. In this example embodiment of FIG. 4 showing the unclaimed neighborhood 404, the addresses within the threshold radial distance 119 are the addresses that receive the station broadcast data 102.

Also illustrated in FIG. 4 is the concept of the service provider address within the threshold radial distance as shown in operation 409X, the service provider address outside the threshold radial distance but subscribing to extend threshold radial distance service as shown in operation 405, and the service provider address outside the threshold radial distance as illustrated in operation 409Y. Each of these different operations will be compared and contrasted. The service provider address in operation 409X may receive the station broadcast data 102 because the service provider in this example embodiment of FIG. 4 is within the threshold radial distance 119, according to one embodiment. The service provider address in operation 405 may receive the station broadcast data 102 because they provide a consideration (e.g., pay a monthly subscription, annual fee, and/or pay per access/use fee) to the geospatially constrained social network 142, even though the service provider in operation 405 does not have a physical address within the threshold radial distance 119. The geospatially constrained social network 142 (e.g., or neighborhood broadcast server 100) may verify, confirm, and/or ask for an assurance that the service provider actually provides services to homes/businesses in the threshold radial distance 119. The geospatially constrained social network 142 (and other the neighborhood broadcast server 100) may request feedback, reviews, and comments from homes/businesses in the geospatially constrained social network 142 for the service providers in operation 405 and operation 409X to ensure that they continue to be recommended and/or are permitted to participate in the threshold radial distance 119 around the epicenter 144 (e.g., where the broadcast originates) in the geospatially constrained social network 142. Operation 409Y indicates that a service provider outside the threshold radial distance 119 does not receive the station broadcast data 102, and therefore cannot participate bi-directionally in the geospatially constrained social network 142.

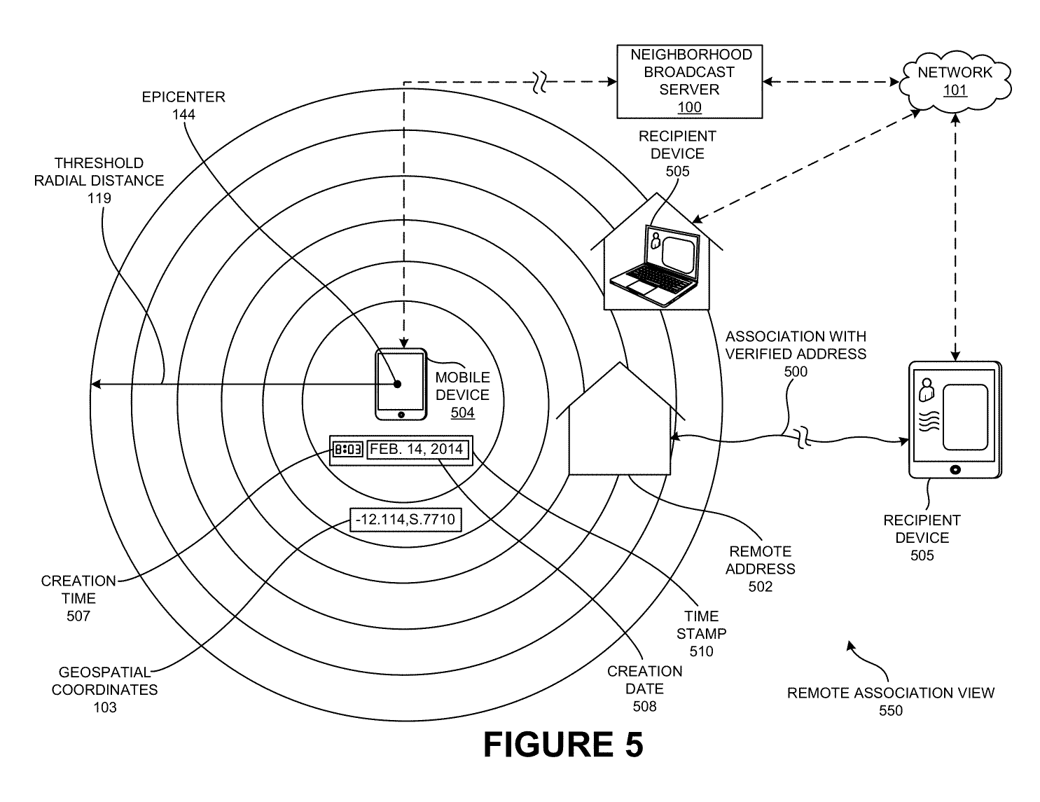

FIG. 5 illustrates a remote association view 550 in which a recipient device 505 receives the station broadcast data of FIG. 3 based on a non-transitory claimed address associated with a profile of the recipient even when the recipient device 505 is outside a threshold radial distance of a broadcast, according to one embodiment.

Particularly, FIG. 5 illustrates an operation 500 which illustrates the recipient device 505 can be associated to a remote address 502, and a time stamp 510 associated with a creation time 507, a creation date 508, and a set of geospatial coordinates 103. The remote address 502 may be a non-transitory location such as a home and/or a work address of the user 106 generating the station broadcast data 102), according to one embodiment. The non-transitory location may be a place of domicile (e.g., a home) and/or a place of situs (e.g., a physical location and/or a principle place of business) of a property (e.g., a work address) and/or business associated with the user 106), according to one embodiment. The concept illustrates that the recipient device 505 may be located at a physical location outside the threshold radial distance 119 and still get the station broadcast data 102 if the recipient device 505 has verified an address at a location that they care about and/or are associated with (e.g., a location in which they live, work, and/or have guest access) that is within the threshold radial distance 119. In other words, the user 106 may receive broadcast (e.g., the station broadcast data 102 which may be live streamed and/or through after the event notifications) related to a radial distance from their home and/or work even when physically at a location outside their claimed non-transitory location.

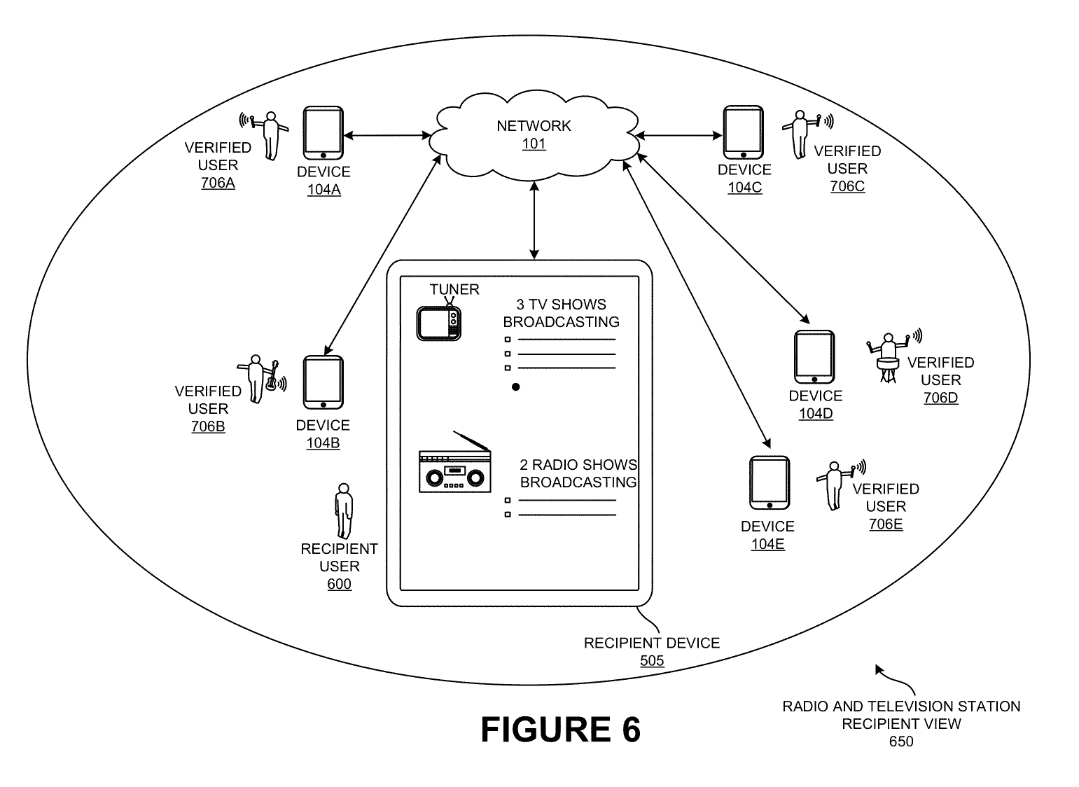

FIG. 6 is a radio and television station recipient view 650 that explains how the recipient user 600 (e.g., the user 106 when receiving broadcasts, the verified user 706 when receiving broadcasts) of FIG. 5 receives and views the station broadcast data 102, according to one embodiment. Particularly, FIG. 6 illustrates a set of verified users 706 (verified user 706A, verified user 706B, etc.) within the threshold radial distance 119, a set of corresponding devices 104 (device 104A, device 104B, etc.) of each verified user 706, a recipient user 600, and a recipient device 505, according to one embodiment.

In FIG. 6, an interface may be provided to the recipient user 600 such that the recipient user 600 can view the available radio and television station transmissions from verified users 706 transmitting the station broadcast data 102 within the threshold radial distance 119.

A summary data may be provided to the recipient user 600 generating the station broadcast data 102 generated through the device 104 of how many user profile pages were updated with an alert of the station broadcast data 102 generated through the device 104 when publishing the station broadcast data 102 generated through the device 104 in the private neighborhood community and/or the set of user profiles (e.g., preseeded user profiles 302 and/or claimed user profiles 304 as described in FIG. 3 having associated verified addresses (in the threshold radial distance 119 from the claimed geospatial location (e.g., any of the claimed geospatial locations 700 as described in FIG. 7 of the verified user 706 (e.g., the user 106 of FIG. 1 as described as the verified user 706 in FIG. 7) of the neighborhood broadcast server 100))) based on the set of preferences of the verified user 706 (e.g., the user 106 of FIG. 1 as described as the verified user 706 in FIG. 7).

FIG. 7 is a radio and television station broadcast view 750 that explains how a broadcasting user creates a station broadcast and manages notifications in neighborhoods that they have claimed, according to one embodiment. Particularly, FIG. 7 describes claimed geospatial locations 700 of a verified user 706 (‘Joe’), and associated information with a station broadcast generated by Joe using a broadcast indicator 702. The associated information comprises a listing criteria 712, the creation time 507, the creation date 508, the time stamp 510, and an availability chart 714. The listing criteria 712 may include information about what type of broadcast (e.g., ‘live performance, ‘news discussion’) Joe is making through the neighborhood broadcast server 100. The creation time 507 and creation date 508 (grouped as the time stamp 510) may indicate when the listing criteria 712 was created. The availability chart 714 may indicate times and locations at which Joe broadcasts (e.g., broadcasts within target area radius, a start timing, and/or a duration amount) or when Joe desires feedback from recipient users 506 bi-directionally communicating with him through their recipient devices 505 based on their received broadcasts.

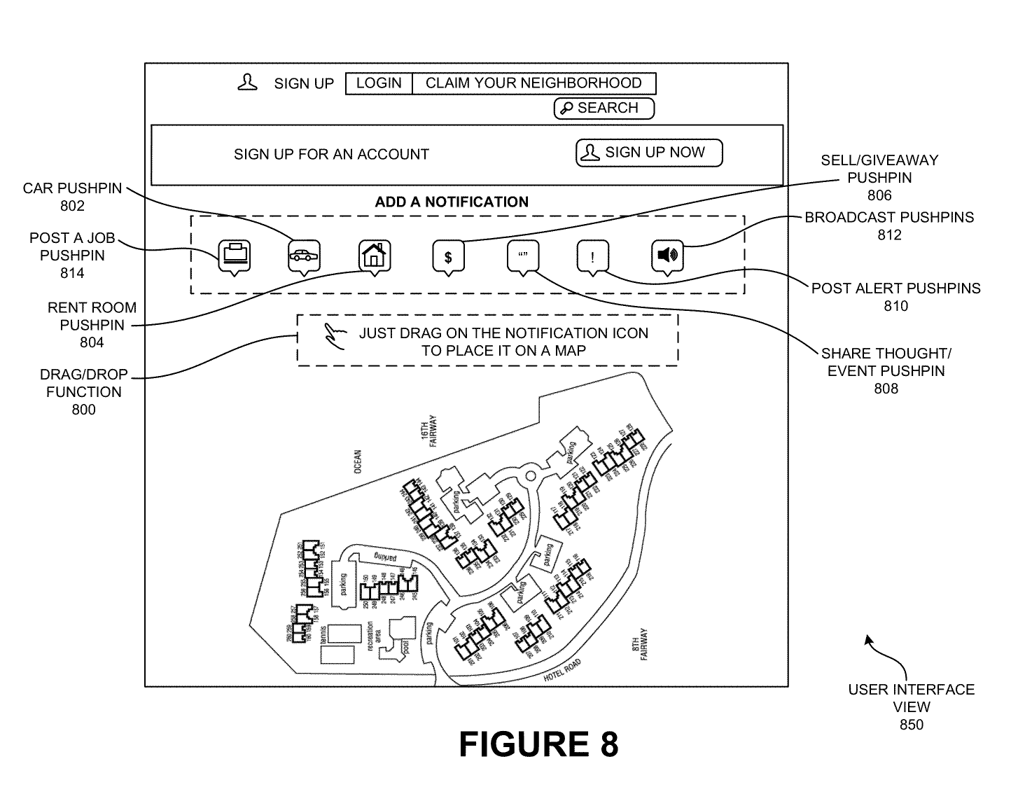

FIG. 8 is a user interface view 850 that explains how a user drags pushpins to a map including a broadcast pushpin, which is different than other pushpins in that a time and a location of the broadcast pushpin is fixed based on a set of geospatial coordinates associated with a device 104 of the broadcasting user of FIG. 7, according to one embodiment. Particularly, FIG. 8 illustrates a drag/drop function 800 associated with a car pushpin 802, a rent room pushpin 804, a sell/giveaway pushpin 806, a share thought/event pushpin 808, a post alert pushpin 810, a broadcast pushpin 812, and a post a job pushpin 814, according to one embodiment.

In FIG. 8, the broadcast pushpin 812 (e.g., that may generate the station broadcast data 102) may be unique in that it can only be placed through a device that has a geo-spatial chip and which can verify a geo-spatial location of a device making the broadcast. In this way, the broadcast pushpin 812 is fixed in time and place, whereas the other pushpins can be manually dragged to the map through the drag/drop function 800.

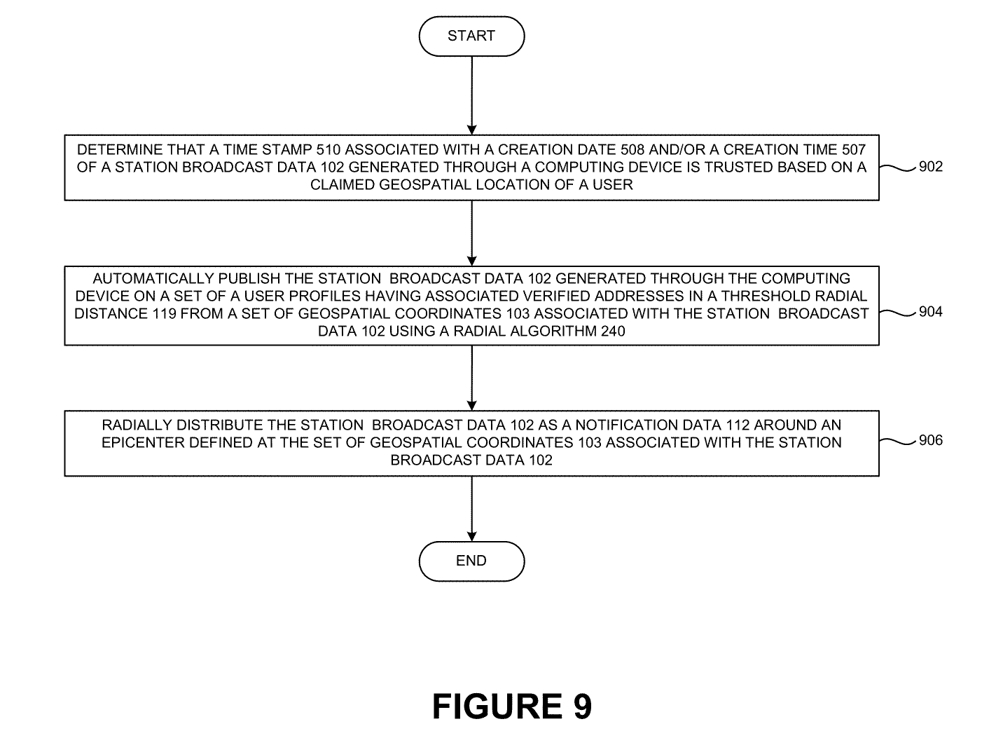

FIG. 9 is a process flow of radially distributing the station broadcast data 102 of FIG. 3 as a notification data 112 around an epicenter 144 defined at the set of geospatial coordinates of FIG. 8 associated with the station broadcast data 102, according to one embodiment. Particularly, in FIG. 9, operation 902 may determine that a time stamp 510 associated with a creation date 508 and/or a creation time 507 of the station broadcast data 102 generated through a computing device (e.g., the device 104) is trusted based on a claimed geospatial location of a user (e.g., the user 106), according to one embodiment. Then, in operation 904, the station broadcast data 102 generated through the computing device may be automatically published on a set of user profiles having associated verified addresses in a threshold radial distance 119 from a set of geospatial coordinates 103 associated with the station broadcast data 102 using a radial algorithm 240. Next, in operation 906, the station broadcast data 102 may be radially distributed as the notification data 112 around an epicenter defined at the set of geospatial coordinates 103 associated with the station broadcast data 102.

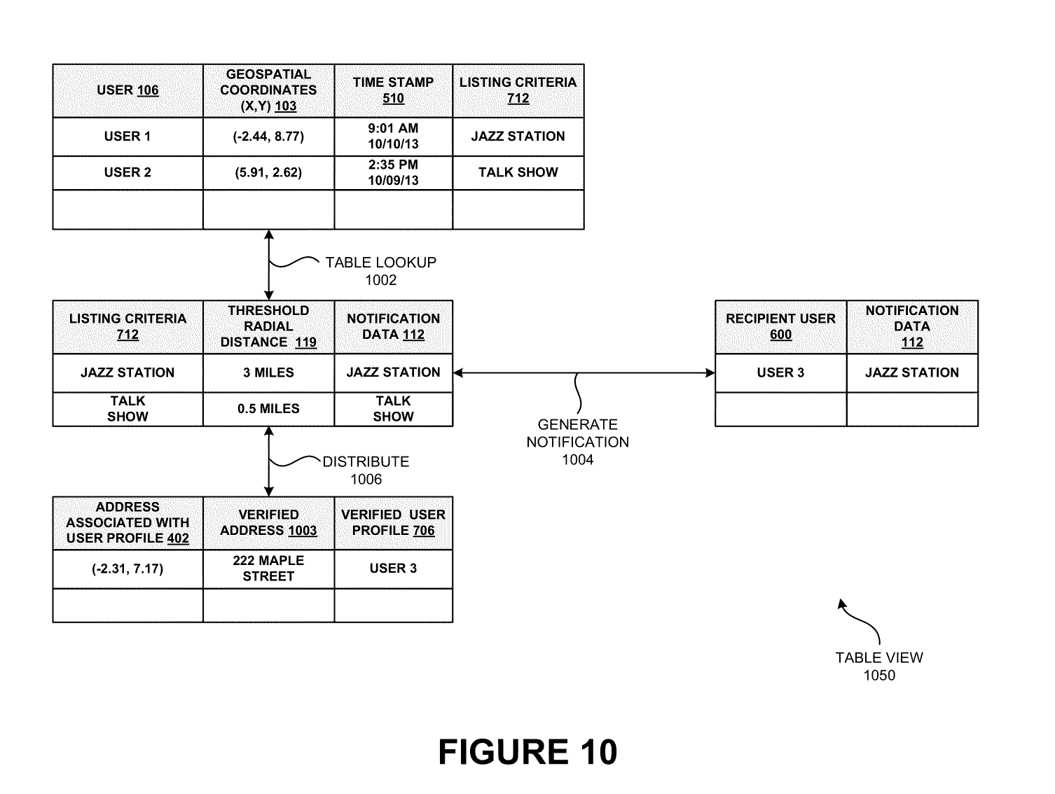

FIG. 10 is a table view 1050 illustrating data relationships between users, locations, and with a set of notification types needed to generate a broadcast, according to one embodiment. In FIG. 10, a table lookup 1002 may be performed in which a listing criteria 712 is matched with a threshold radial distance 119 and a notification data 112. Then, a notification may be generated using the generate notification operation 1004 from the recipient user 600, and distributed to the verified address (e.g., the verified address 1003) in the threshold radial distance 119 using the distribute operation 1006, according to one embodiment.

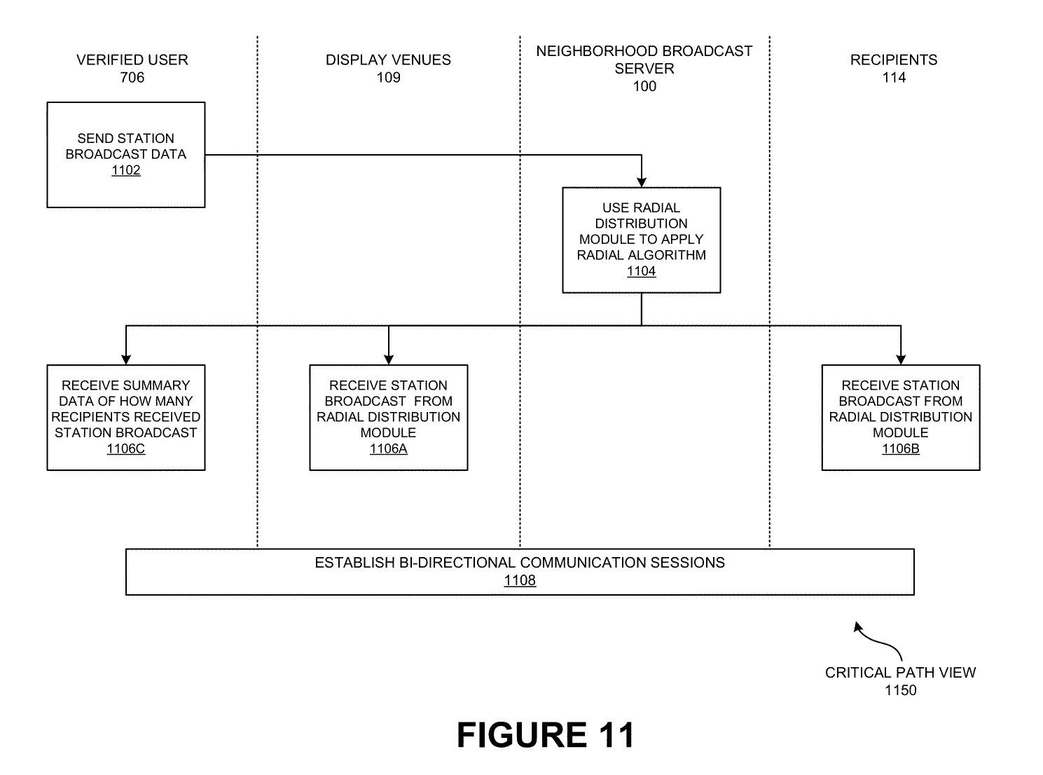

FIG. 11 is a critical path view 1150 illustrating a flow based on time in which critical operations in establishing a bi-directional session between a verified user and those individuals receiving the station broadcast data of FIG. 3 is established, according to one embodiment. In FIG. 11, a verified user 706 sends a station broadcast data 102 to the neighborhood broadcast server 100 in operation 1102. Then, the display venues 109 receive the station broadcast data 102 from the radial distribution module 140 of the neighborhood broadcast server 100 in operation 1106A, according to one embodiment. Similarly, the recipients 114 receive the station broadcast data 102 from the radial distribution module 140 of the neighborhood broadcast server 100 in operation 1106B, according to one embodiment. Based on operation 1106A and 1106B, the verified user 706 may automatically receive a summary of how many recipients received the station broadcast data 102 in operation 1106C. Next, bidirectional communication sessions are established between the verified user 706 and the service provider and/or the recipients 114 in operation 1108.

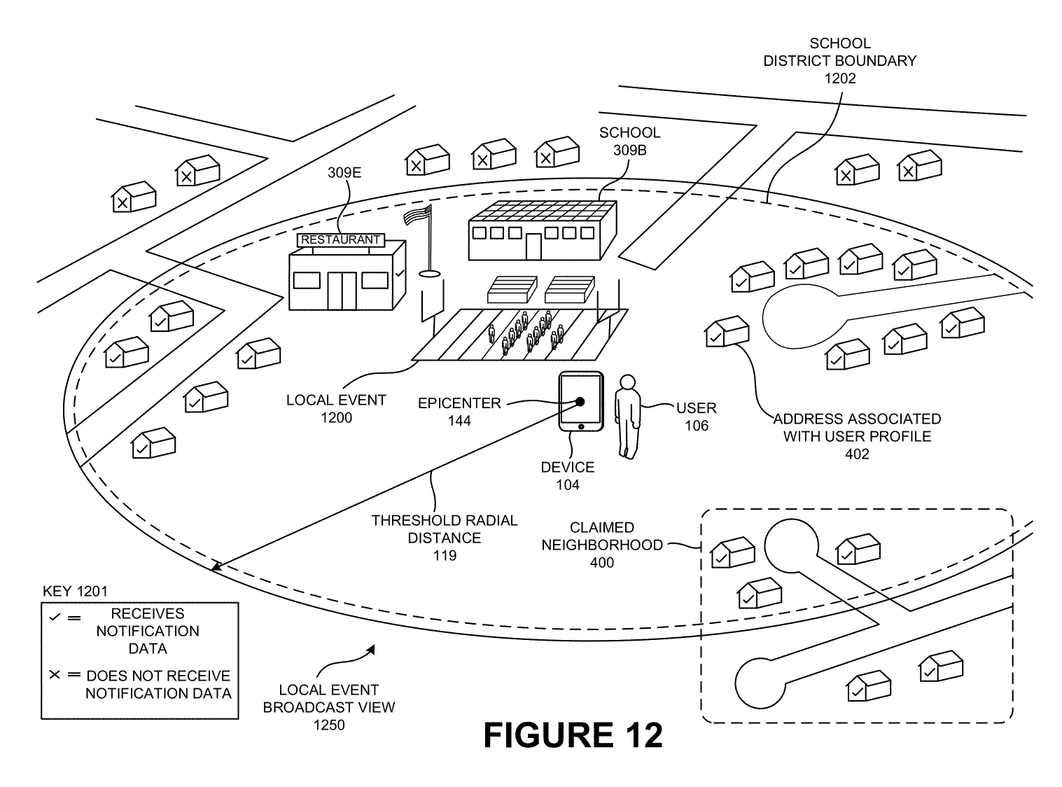

FIG. 12 is a local event broadcast view 1250 illustrating the broadcasting of a neighborhood event in which the threshold radial distance is defined by a school district boundary, according to one embodiment.

Particularly, FIG. 12 further illustrates a local event 1200, a key 1201, and a school district boundary 1202. The key 1201 describes that a ‘checkmark’ inside a home of an address associated with a user profile 402 or a display venue 109 that the station broadcast data 102 reaches a user associated with that address at a radial geospatial distance away. In contrast, the key 1201 describes that an ‘X mark’ inside a home or venue that the station broadcast data 102 does not reach a user associated with that address at a radial geospatial distance away.

In the embodiment of FIG. 12, the user 106 may be present at the local event 1200 (e.g., a football game, a concert, a rally, a protest) with his or her device 104. The station broadcast data 102 generated through the device 104 may be broadcast by way of the notification data 114 to recipients (e.g., the addresses associated with user profiles 402 and/or display venues 109) within the threshold radial distance 119. The threshold radial distance 119 may be defined such that the user 106's broadcast reaches as far as the school district boundary 1202. Additionally, the broadcast may be extended to all addresses associated with a user profile 402 within a claimed neighborhood 400 if at least one of the addresses associated with a user profile 402 is within the threshold radial distance 119 defined by the school district boundary 1202. Other recipients 114 may include the display venues 109, and, specifically as illustrated in the embodiment of FIG. 12, the school 309B and the restaurant 309E.

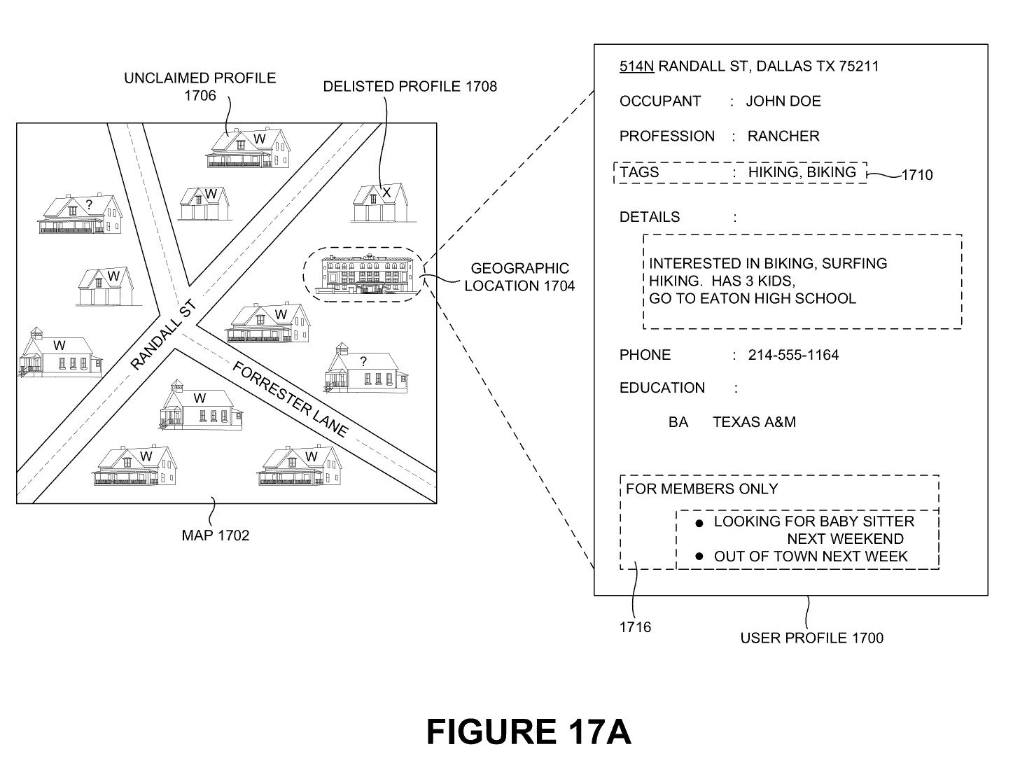

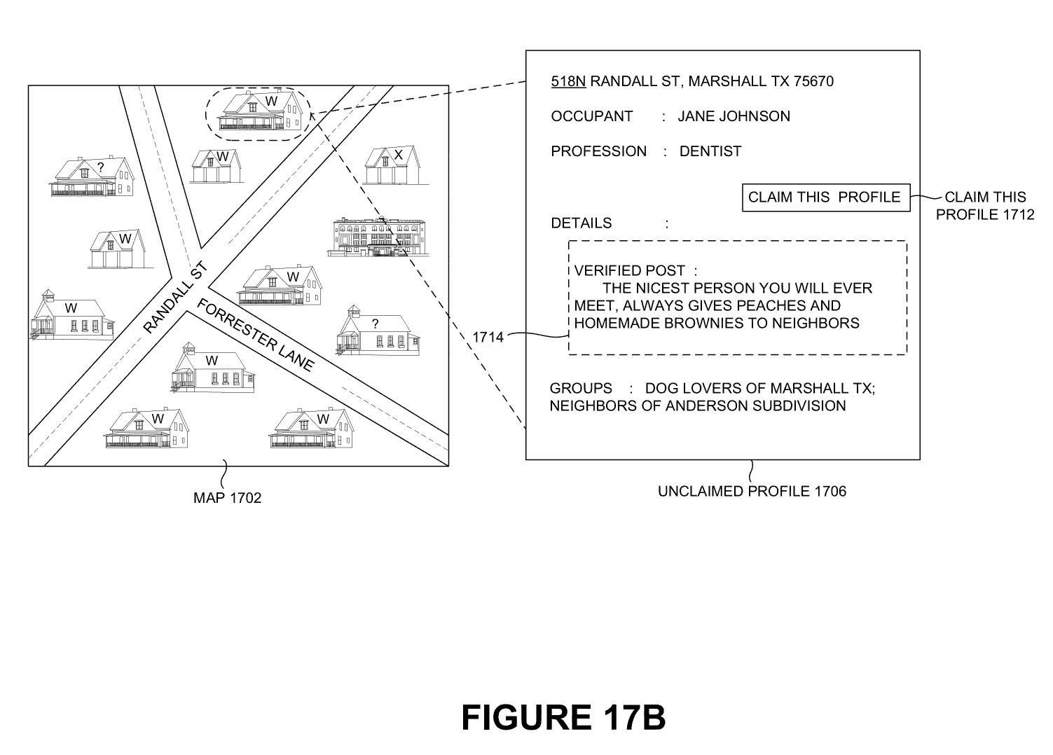

FIG. 13 is a user interface view of the social community module 2906, according to one embodiment. The social community module view 1350 may display the information associated with the social community module 220. The user interface 1350 may display map of the specific geographic location associated with the user profile of the social community module 220. The social community module view 1350 may display the map based geographic location associated with the user profile (e.g., the user profile 1700 of FIG. 17A) only after verifying the address of the registered user of the global neighborhood environment 2300.

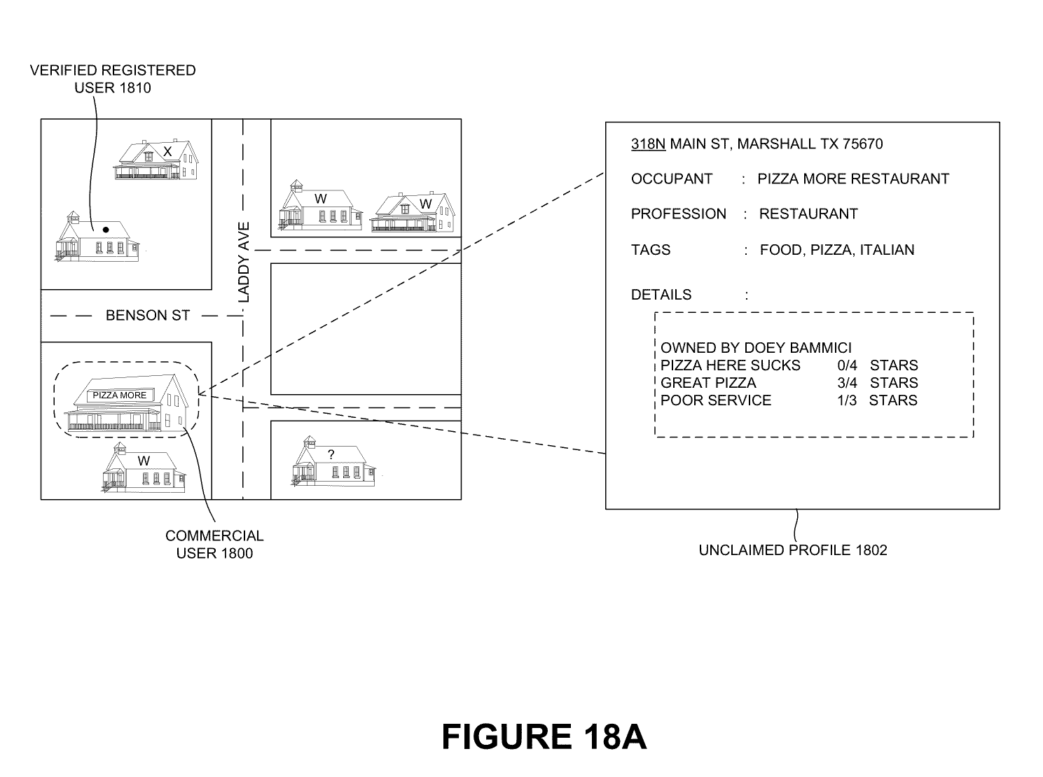

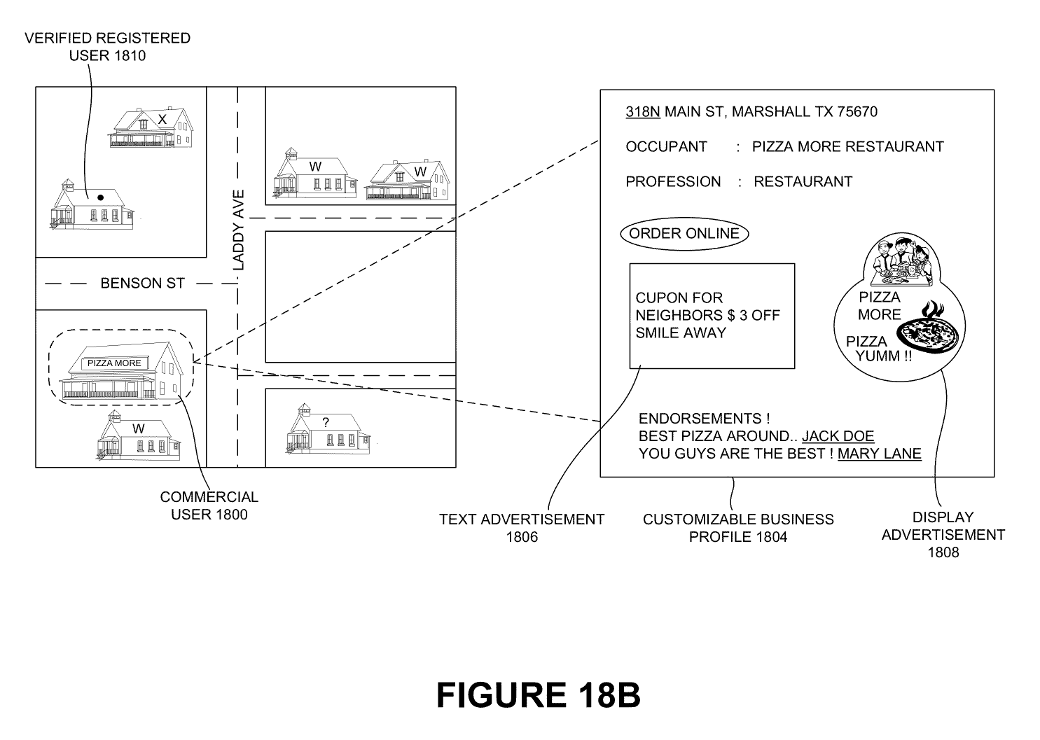

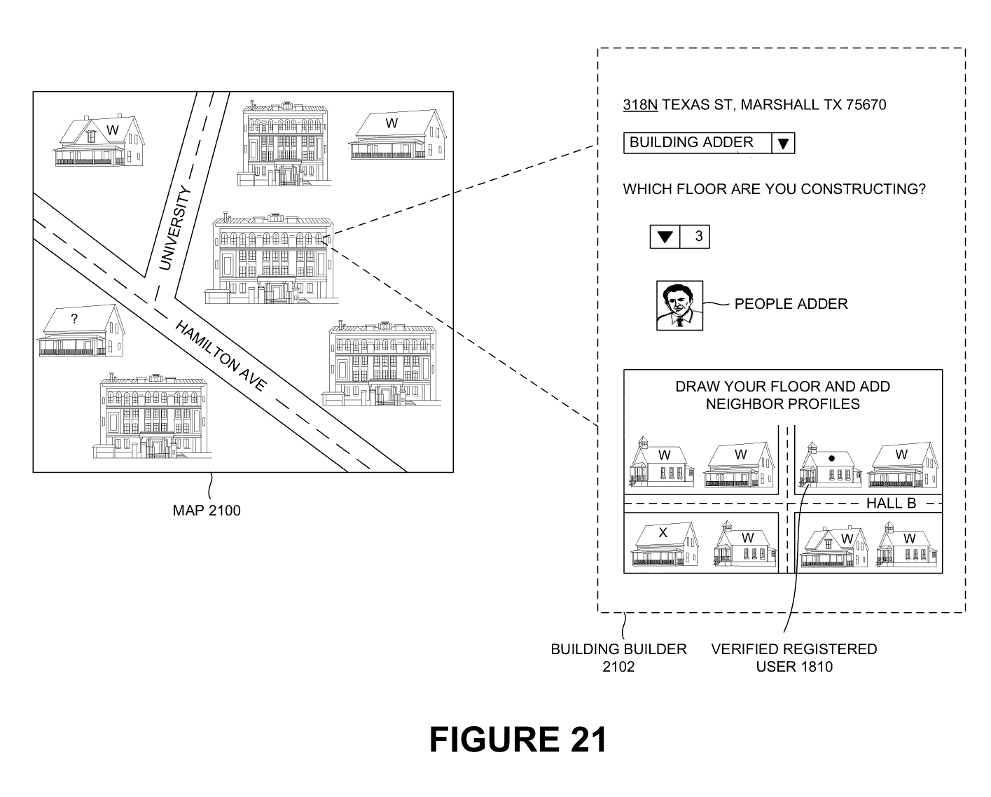

In addition, the user interface 1350 may provide a building creator (e.g., the building builder 2102 of FIG. 21), in which the registered users of the global neighborhood environment 2300 may create and/or modify empty unclaimed profiles (e.g., a unclaimed profile 1706 of FIG. 17A-18B, a unclaimed profile 1802 of FIG. 18A), building layouts, social network pages, etc. The social community module view 1350 of the social community module 2906 may enable access to the user (e.g., the user 106 of FIG. 1) to model a condo on any floor (e.g., basement, ground floor, first floor, etc.) selected through the drop down box by the registered user of the global neighborhood environment 2300. The user interface 1350 of the social community module 220 may enable the registered user of the global neighborhood environment 2300 to contribute information about their neighbors.

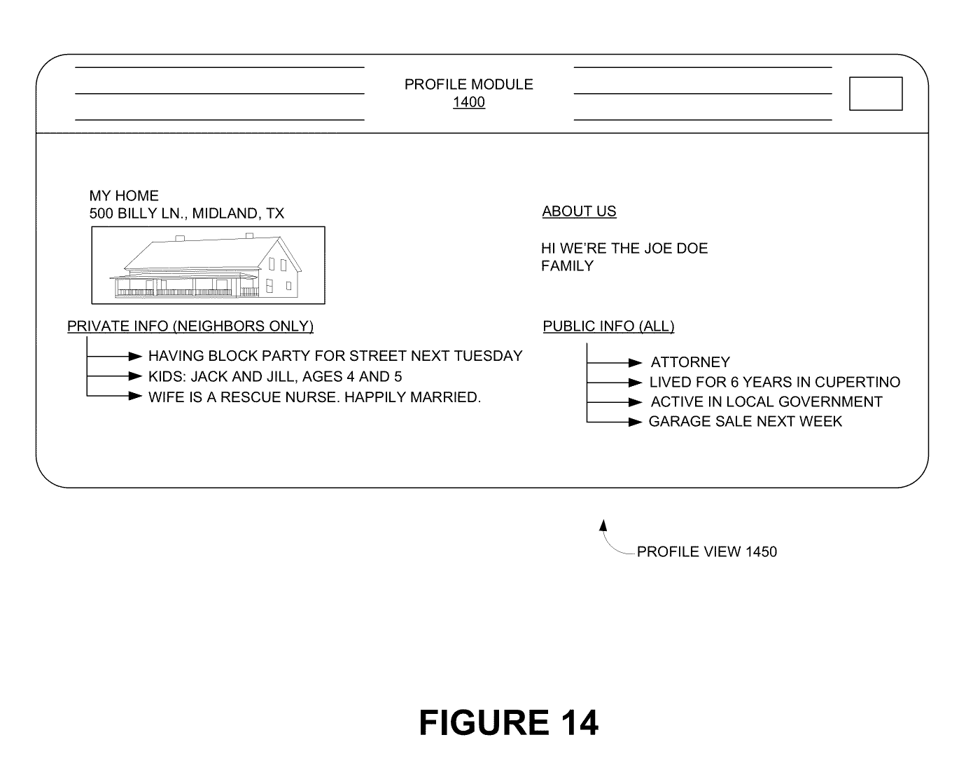

FIG. 14 is a profile view 1450 of a profile module 1400, according to one embodiment. The profile view 1450 of profile module 1400 may offer the registered user to access the profile about the neighbors. The profile view 1450 of profile module 1400 may indicate the information associated with the profile of the registered user of the global neighborhood environment 2300. The profile view 1450 may display the address of the registered user. The profile view 1450 may also display events organized by the neighbors, history of the neighbors, and/or may also offer the information (e.g., public, private, etc.) associated with the family of the neighbors located in the locality of the user (e.g., the user(s) 106 of FIG. 1) of the global neighborhood environment 2300.

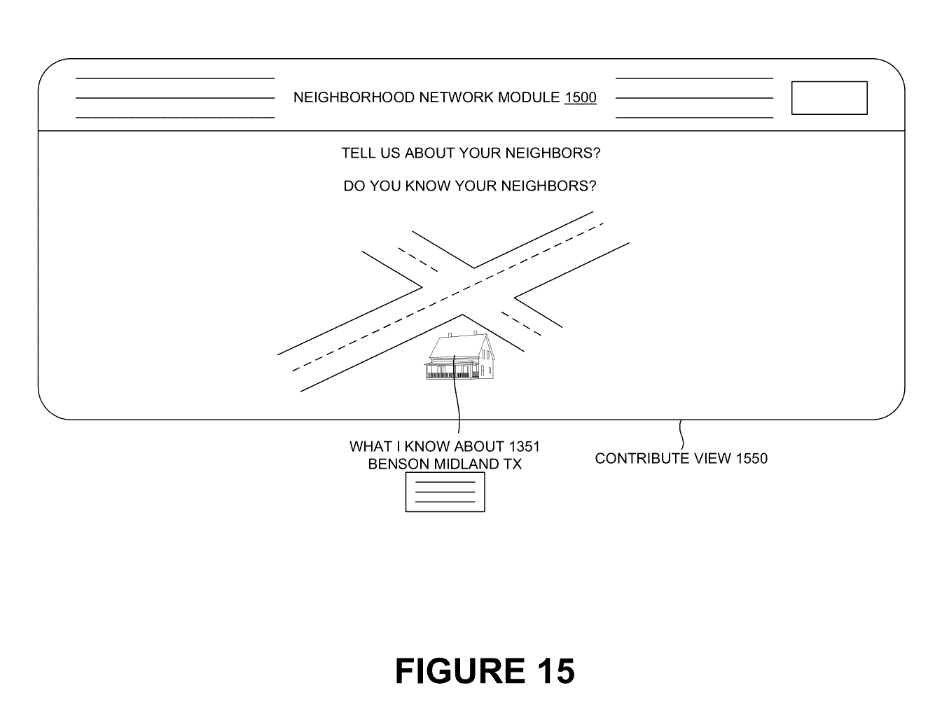

FIG. 15 is a contribute view 1550 of a neighborhood network module 1500, according to one embodiment. The contribute view 1550 of the neighborhood network module 1500 may enable the registered user of the global neighborhood environment 2300 to add information about their neighbors in the neighborhood network. The contribute view 1550 of the neighborhood network module 1500 may offer registered user of the global neighborhood environment 2300 to add valuable notes associated with the family, events, private information, etc.

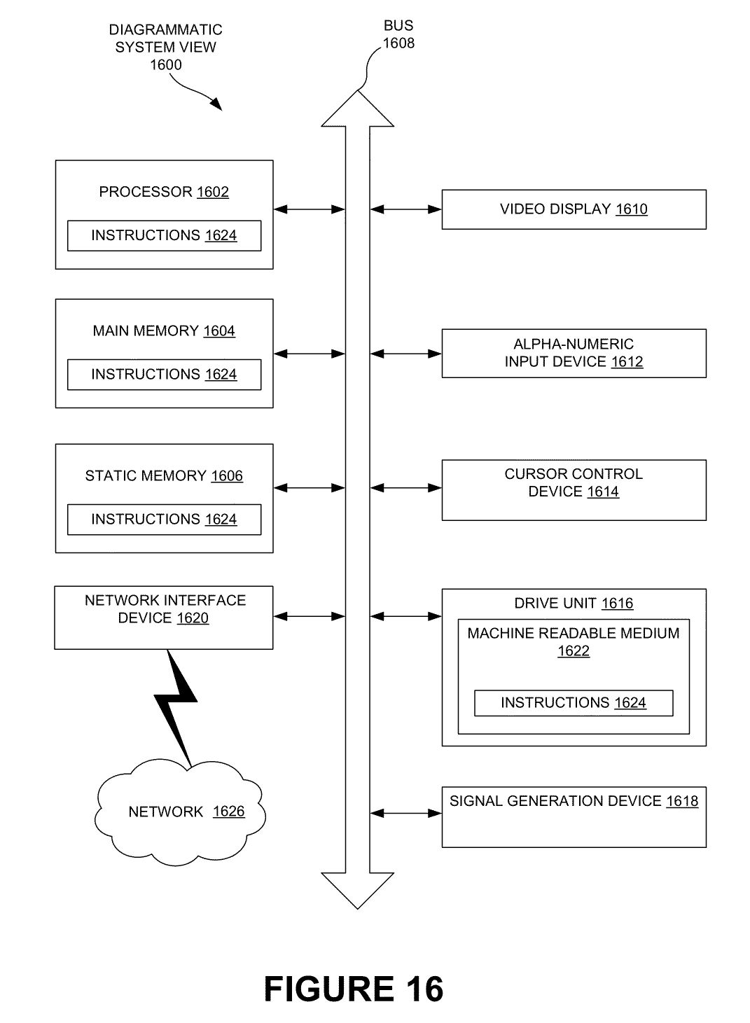

FIG. 16 is a diagrammatic system view, according to one embodiment. FIG. 16 is a diagrammatic system view 1600 of a device 104 in which any of the embodiments disclosed herein may be performed, according to one embodiment. Particularly, the system view 1600 of FIG. 16 illustrates a processor 1602, a main memory 1604, a static memory 1606, a bus 1608, a video display 1610, an alpha-numeric input device 1612, a cursor control device 1614, a drive unit 1616, a signal generation device 1618, a network interface device 1620, a machine readable medium 1622, instructions 1624, and a network 1626, according to one embodiment.

The diagrammatic system view 1600 may indicate a personal computer and/or a device 104 in which one or more operations disclosed herein are performed. The processor 1602 may be microprocessor, a state machine, an application specific integrated circuit, a field programmable gate array, etc. (e.g., Intel® Pentium® processor). The main memory 1604 may be a dynamic random access memory and/or a primary memory of a computer system.

The static memory 1606 may be a hard drive, a flash drive, and/or other memory information associated with the device 104. The bus 1608 may be an interconnection between various circuits and/or structures of the device 104. The video display 1610 may provide graphical representation of information on the device 104. The alpha-numeric input device 1612 may be a keypad, keyboard and/or any other input device of text (e.g., a special device to aid the physically handicapped). The cursor control device 1614 may be a pointing device such as a mouse.

The drive unit 1616 may be a hard drive, a storage system, and/or other longer term storage subsystem. The signal generation device 1618 may be a bios and/or a functional operating system of the device 104. The machine readable medium 1622 may provide instructions on which any of the methods disclosed herein may be performed. The instructions 1624 may provide source code and/or data code to the processor 1602 to enable any one/or more operations disclosed herein.

FIG. 17A is a user interface view of mapping a user profile 1700 of the geographic location 1704, according to one embodiment. In the example embodiment illustrated in FIG. 17A, the user profile 1700 may contain the information associated with the geographic location 1704. The user profile 1700 may contain the information associated with the registered user. The user profile 1700 may contain information such as address user of the specific geographic location, name of the occupant, profession of the occupant, details, phone number, educational qualification, etc.

The map 1702 may indicate the global neighborhood environment 2300 of the geographical location 1704, a unclaimed profile 1706 (e.g., the unclaimed profile 1802 of FIG. 18A, the unclaimed profile 1704 of FIG. 17), and a delisted profile 1708. The geographical location 1704 may be associated with the user profile 1700. The unclaimed profile 1706 may be the unclaimed profile 1706 associated with the neighboring property surrounding the geographic location 1704. The delisted profile 1708 illustrated in example embodiment of FIG. 17A, may be the unclaimed profile 1706 that may be delisted when the registered user claims the physical property. The tag 1710 illustrated in the example embodiment of FIG. 17A may be associated with hobbies, personal likes, etc. The block 1716 may be associated with events, requirements, etc. that may be displayed by the members of the global neighborhood environment 2300.

For example, a verified registered user (e.g., a verified registered user 1810 of FIG. 18A-B) may be associated with a user profile 1700. The user profile 1700 may be associated with a specific geographic location. A map concurrently displaying the user profile 1700 and the specific geographic location 1704 may be generated. Also, the unclaimed profiles 1706 associated with different geographic locations surrounding the specific geographic location associated with the user profile 1700 may be simultaneously generated in the map. In addition, a query of the user profile 1700 and/or the specific geographic location may be processed.

Similarly, a tag data (e.g., the tags 1710 of FIG. 17A) associated with the specific geographic locations, a particular geographic location, and the delisted geographic location may be processed. A frequent one of the tag data (e.g., the tags 1710 of FIG. 17A) may be displayed when the specific geographic location and/or the particular geographic location is made active, but not when a geographic location is delisted.

FIG. 17B is a user interface view of mapping of the unclaimed profile 1706, according to one embodiment. In the example embodiment illustrated in FIG. 17B, the map 1702 may indicate the geographic locations in the global neighborhood environment 2300 and/or may also indicate the geographic location of the unclaimed profile 1706. The unclaimed profile 1706 may display the information associated with the registered user of the global neighborhood environment 2300. The link claim this profile 1712 may enable the registered user to claim the unclaimed profile 1706 and/or may also allow the verified registered user (e.g., the verified registered user 1810 of FIG. 18A-B) to edit any information in the unclaimed profiles 1706. The block 1714 may display the information posted by any of the verified registered users (e.g., the verified registered user 1810 of FIG. 18A-B, the verified registered user 1810 of FIG. 18) of the global neighborhood environment 2300.

For example, a particular unclaimed profile (e.g., the particular unclaimed profile may be associated with a neighboring property to the specific property in the neighborhood) of the unclaimed profiles (e.g., the unclaimed profile 1802 of FIG. 18A, the unclaimed profile 1704 of FIG. 17A) may be converted to another user profile (e.g., the user profile may be tied to a specific property in a neighborhood) when a different registered user (e.g., the user 106 of FIG. 1) claims a particular geographic location to the specific geographic location associated with the particular unclaimed profile.

In addition, a certain unclaimed profile of the unclaimed profiles may be delisted when a private registered user claims a certain geographic location (e.g., the geographical location 1704 of FIG. 17A) adjacent to the specific geographic location and/or the particular geographic location. Also, the certain unclaimed profile in the map 1702 may be masked when the certain unclaimed profile is delisted through the request of the private registered user.

Furthermore, a tag data (e.g., the tags 1710 of FIG. 17A) associated with the specific geographic location, the particular geographic location, and the delisted geographic location may be processed. A frequent one of the tag data may be displayed when the specific geographic location and/or the particular geographic location are made active, but not when a geographic location is delisted.

Moreover, the verified registered user (e.g., the verified registered user 1810 of FIG. 18A-B, the verified registered user 1810 of FIG. 18) may be permitted to edit any information in the unclaimed profiles 1706 including the particular unclaimed profile 1706 and/or the certain unclaimed profile until the certain unclaimed profile may be claimed by the different registered user and/or the private registered user. In addition, a claimant of any unclaimed profile 1706 may be enabled to control what information is displayed on their user profile. Also, the claimant may be allowed to segregate certain information on their user profile 1700 such that only other registered users directly connected to the claimant are able to view data on their user profile 1700.

FIG. 18A is a user interface view of mapping of an unclaimed profile 1802 of the commercial user 1800, according to one embodiment. In the example embodiment illustrated in FIG. 18A, the commercial user 1800 may be associated with the customizable business profile 1804 located in the commercial geographical location. The unclaimed profile 1802 may contain the information associated with the commercial user 1800. The unclaimed profile 1802 may contain the information such as address, name, profession, tag, details (e.g., ratings), and educational qualification etc. of the commercial user 1800. The verified registered user 1810 may be user associated with the global neighborhood environment 2300 and may communicate a message to the neighborhood commercial user 1800. For example, a payment of the commercial user 1800 and the verified registered user 1810 may be processed.

FIG. 18B is a user interface view of mapping of customizable business profile 1804 of the commercial user 1800, according to one embodiment. In the example embodiment illustrated in FIG. 18B, the commercial user 1800 may be associated with the customizable business profile 1804. The customizable business profile 1804 may be profile of any business firm (e.g., restaurant, hotels, supermarket, etc.) that may contain information such as address, occupant name, profession of the customizable business. The customizable business profile 1804 may also enable the verified registered user 1810 to place online order for the products.

For example, the commercial user 1800 may be permitted to purchase a customizable business profile 1804 associated with a commercial geographic location. Also, the verified registered user 1810 may be enabled to communicate a message to the global neighborhood environment 2300 based on a selectable distance range away from the specific geographic location. In addition, a payment of the commercial user 1800 and/or the verified registered user 1810 may be processed.

A target advertisement 1806 may display the information associated with the offers and/or events of the customizable business. The display advertisement 1808 may display ads of the products of the customizable business that may be displayed to urge the verified registered user 1810 to buy the products of the customizable business. The verified registered user 1810 may be user associated with the global neighborhood environment 2300 that may communicate a message to the commercial user 1800 and/or may be interested in buying the products of the customizable business.

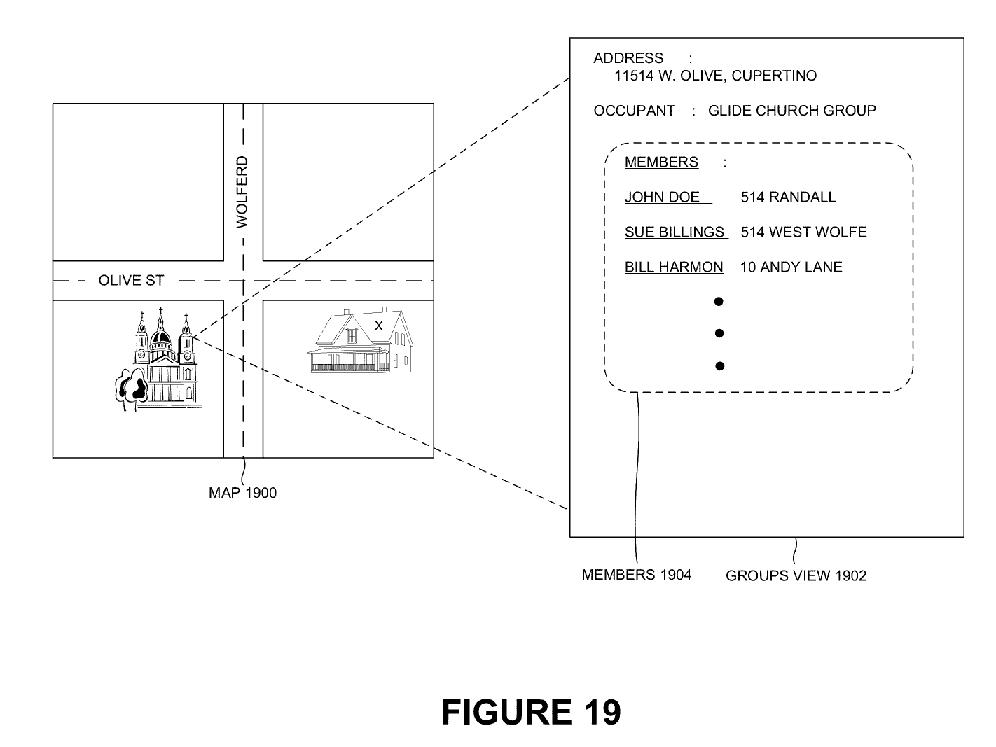

FIG. 19 is a user interface view of a group view 1902 associated with particular geographical location, according to one embodiment. Particularly FIG. 19 illustrates, a map 1900, a groups view 1902, according to one embodiment. In the example embodiment illustrated in FIG. 19, the map view 1900 may display map view of the geographical location of the specific group of the global neighborhood environment 2300. The groups view 1902 may contain the information (e.g., address, occupant, etc.) associated with the particular group of the specific geographical location (e.g., the geographical location displayed in the map 1900) of the global neighborhood environment 2300. The members 1904 may contain the information about the members associated with the group (e.g., the group associated with geographical location displayed in the map) of the global neighborhood environment 2300.

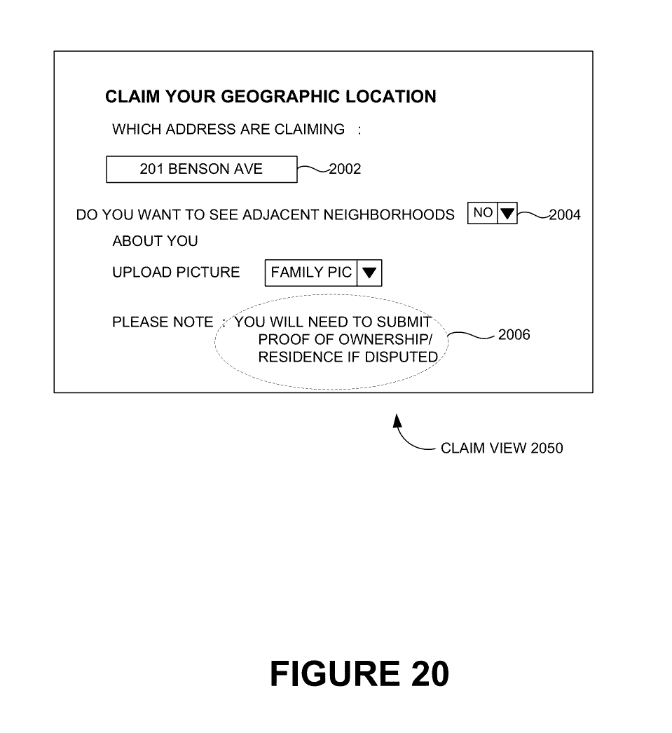

FIG. 20 is a user interface view of claim view 2050, according to one embodiment. The claim view 2050 may enable the user to claim the geographical location of the registered user. Also, the claim view 2050 may facilitate the user of the global neighborhood environment 2300 to claim the geographical location of property under dispute.

In the example embodiment illustrated in FIG. 20, the operation 2002 may allow the registered user of the global neighborhood environment 2300 to claim the address of the geographic location claimed by the registered user. The operation 2004 illustrated in example embodiment of FIG. 20, may enable the user to delist the claim of the geographical location. The operation 2006 may offer information associated with the document to be submitted by the registered users of the global neighborhood environment 2300 to claim the geographical location.

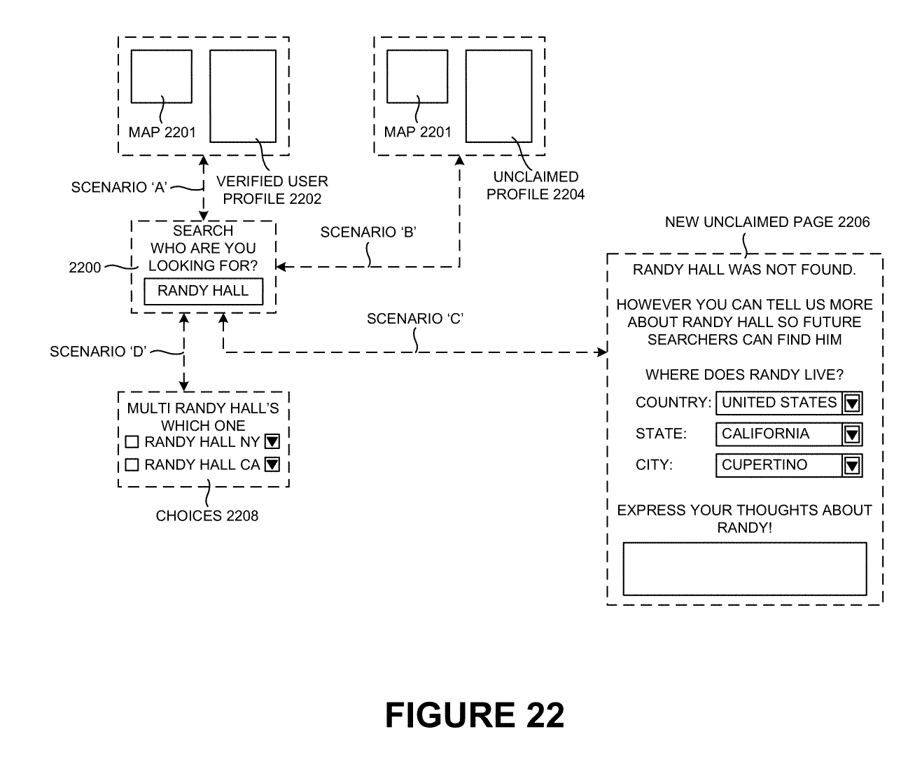

FIG. 21 is a user interface view of a building builder 2102, according to one embodiment. Particularly the FIG. 21 illustrates, a map 2100, a building builder 2102, according to one embodiment. The map 2100 may display the geographical location in which the verified registered user (e.g., the verified registered user 1810 of FIG. 18A-B) may create and/or modify empty unclaimed profiles (e.g., the unclaimed profile 1706 of FIG. 17A-41B, the unclaimed profile 1802 of FIG. 18A, the unclaimed profile 2204 of FIG. 22), building layouts, social network pages, and floor levels structures housing residents and businesses in the neighborhood. The building builder 2102 may enable the verified registered users (e.g., the verified registered user 1810 of FIG. 18A-B) of the global neighborhood environment 2300 to draw floor level structures, add neighbor's profiles and/or may also enable to select the floor number, unclaimed type, etc. as illustrated in example embodiment of FIG. 21.

The verified registered user 1810 may be verified registered user of the global neighborhood environment 2300 interested in creating and/or modifying unclaimed profiles (e.g., the unclaimed profile 1706 of FIG. 17A-41B, the unclaimed profile 1802 of FIG. 18A, the unclaimed profile 2204 of FIG. 22), building layouts, social network pages, and floor level structure housing residents and businesses in the neighborhood in the building builder 2102.

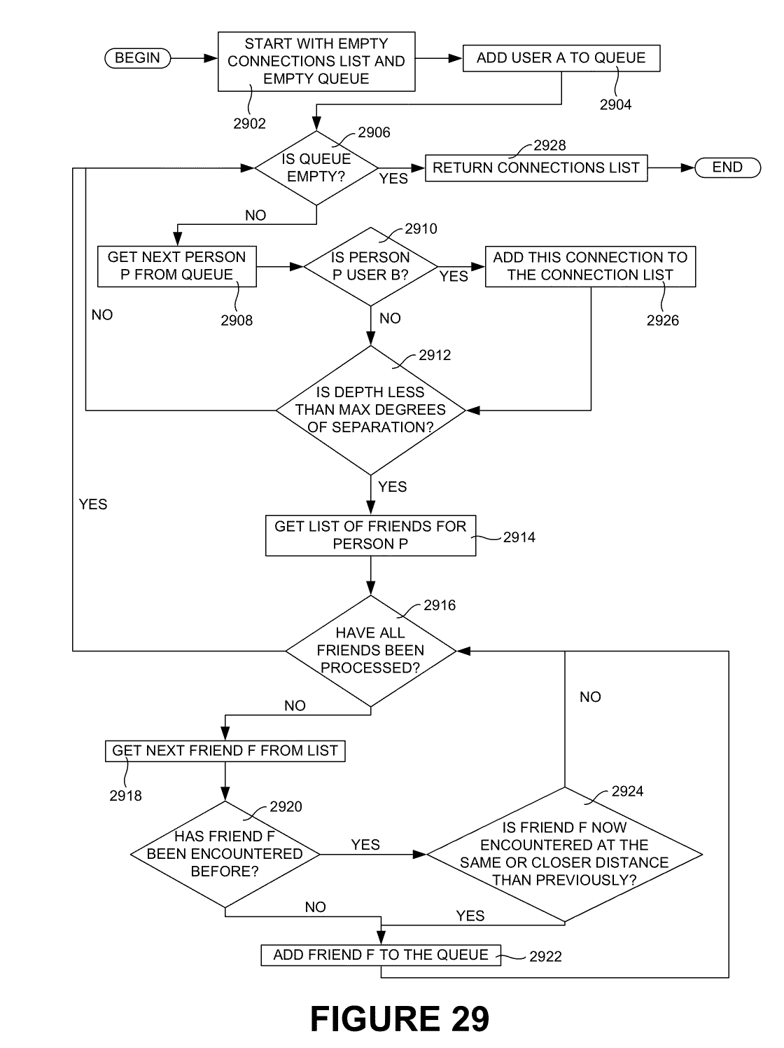

For example, a social community module (e.g., a social community module 2906 of FIG. 29) of the global neighborhood environment 2300 may generate a building creator (e.g., the building builder 2102 of FIG. 21) in which the registered users may create and/or modify empty unclaimed profiles (e.g., the unclaimed profile 1706 of FIG. 17A-41B, the unclaimed profile 1802 of FIG. 18A, the unclaimed profile 2204 of FIG. 22), building layouts, social network pages, and floor levels structures housing residents and/or businesses in the neighborhood.

FIG. 22 is a systematic view of communication of unclaimed data, according to one embodiment. Particularly FIG. 22 illustrates a map 2201, verified user profile 2202, choices 2208 and a new unclaimed page 2206, according to one embodiment. The map 2201 may locate the details of the address of the registered user of the global neighborhood environment 2300. The verified user profile 2202 may store the profiles of the verified user of the global neighborhood environment 2300. The unclaimed profile 2204 may be the profiles of the registered user who may claim them in the global neighborhood environment 2300.

In operation 2200 the search for the user profile is been carried whom the registered user may be searching. The new unclaimed page 2206 may solicit for the details of a user whom the registered user is searching for in the global neighborhood environment 2300. The choices 2208 may ask whether the requested search is any among the displayed names. The new unclaimed page 2206 may request for the details of location such as country, state and/or city. The operation 2200 may communicate with the choices 2208, and the new unclaimed page 2206.

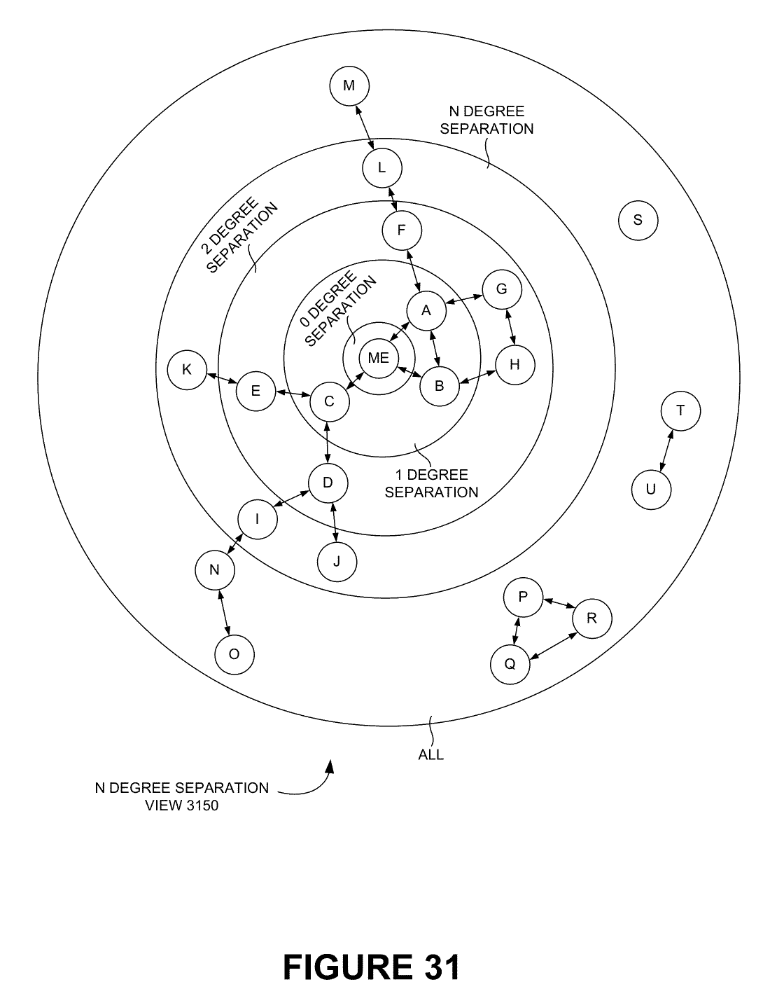

For example, a no-match module (e.g., a no-match module 3112 of FIG. 31) of the search module (e.g., the search module 2908 of FIG. 29)to request additional information from the verified registered user about a person, place, and business having no listing in the global neighborhood environment 2300 when no matches are found in a search query of the verified registered user (e.g., the verified registered user 1810 of FIG. 18A-B), and to create a new unclaimed page 2206 based on a response of the verified registered user 2202 about the at least one person, place, and business not previously indexed in the global neighborhood environment 2300.

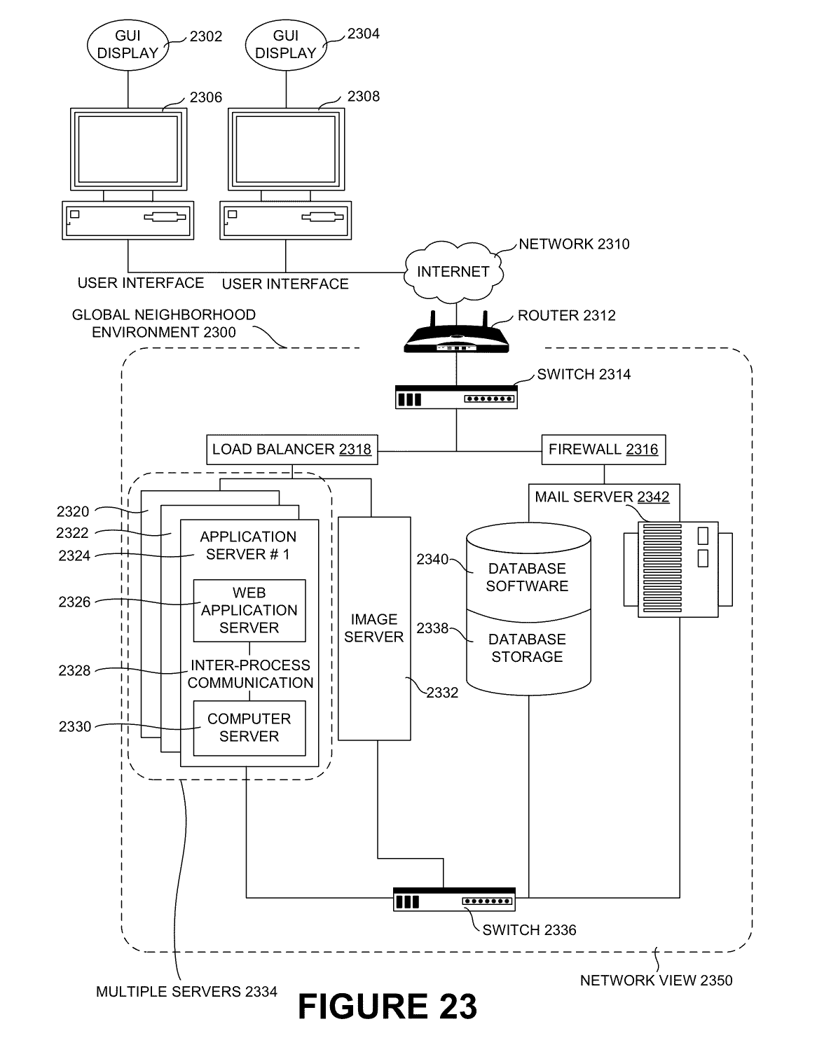

FIG. 23 is a systematic view of a network view 2350, according to one embodiment. Particularly it may include a GUI display 2302, a GUI display 2304, device 2306, a device 2308, a network 2310, a router 2312, a switch 2314, a firewall 2316, a load balancer 2318, an application server #3 2320, an application server #2 2322, an application server#1 2324, a web application server 2326, an inter-process communication 2328, a computer server 2330, an image server 2332, a multiple servers 2334, a switch 2336, a database storage 2338, database software 2340 and a mail server 2342, according to one embodiment.

The GUI display 2302 and GUI display 2304 may display particular case of user interface for interacting a device capable of representing data (e.g., computer, cellular telephones, television sets etc.) which employs graphical images and widgets in addition to text to represent the information and actions available to the user (e.g., the user 106 of FIG. 1). The device 2306 and device 2308 may be any device capable of presenting data (e.g., computer, cellular telephones, television sets etc.). The network 2310 may be any collection of networks (e.g., internet, private networks, university social system, private network of a company etc.) that may transfer any data to the user (e.g., the user 106 of FIG. 1) and the global neighborhood environment 2300.

The router 2312 may forward packets between networks and/or information packets between the global neighborhood environment 2300 and registered user over the network (e.g., internet). The switch 2314 may act as a gatekeeper to and from the network (e.g., internet) and the device. The firewall 2316 may provides protection (e.g., permit, deny or proxy data connections) from unauthorized access to the global neighborhood environment 2300. The load balancer 2318 may balance the traffic load across multiple mirrored servers in the global neighborhood environment 2300 and may be used to increase the capacity of a server farm beyond that of a single server and/or may allow the service to continue even in the face of server down time due to server failure and/or server maintenance.

The application server #2 2322 may be server computer on a computer network dedicated to running certain software applications of the global neighborhood environment 2300. The web application server 2326 may be server holding all the web pages associated with the global neighborhood environment 2300. The inter-process communication 2328 may be set of rules for organizing and un-organizing factors and results regarding the global neighborhood environment 2300. The computer server 2330 may serve as the application layer in the multiple servers of the global neighborhood environment 2300 and/or may include a central processing unit (CPU), a random access memory (RAM) temporary storage of information, and/or a read only memory (ROM) for permanent storage of information regarding the global neighborhood environment 2300.

The image server 2332 may store and provide digital images of the registered user of the global neighborhood environment 2300. The multiple servers 2334 may be multiple computers or devices on a network that may manages network resources connecting the registered user and the global neighborhood environment 2300. The database storage 2338 may store software, descriptive data, digital images, system data and any other data item that may be related to the user (e.g., the user 106 of FIG. 1) of the global neighborhood environment 2300. The database software 2340 may be provided a database management system that may support the global neighborhood environment 2300. The mail server 2342 may be provided for sending, receiving and storing mails. The device 2306 and 2308 may communicate with the GUI display(s) 2302 and 2304, the router 2312 through the network 2310 and the global neighborhood environment 2300.

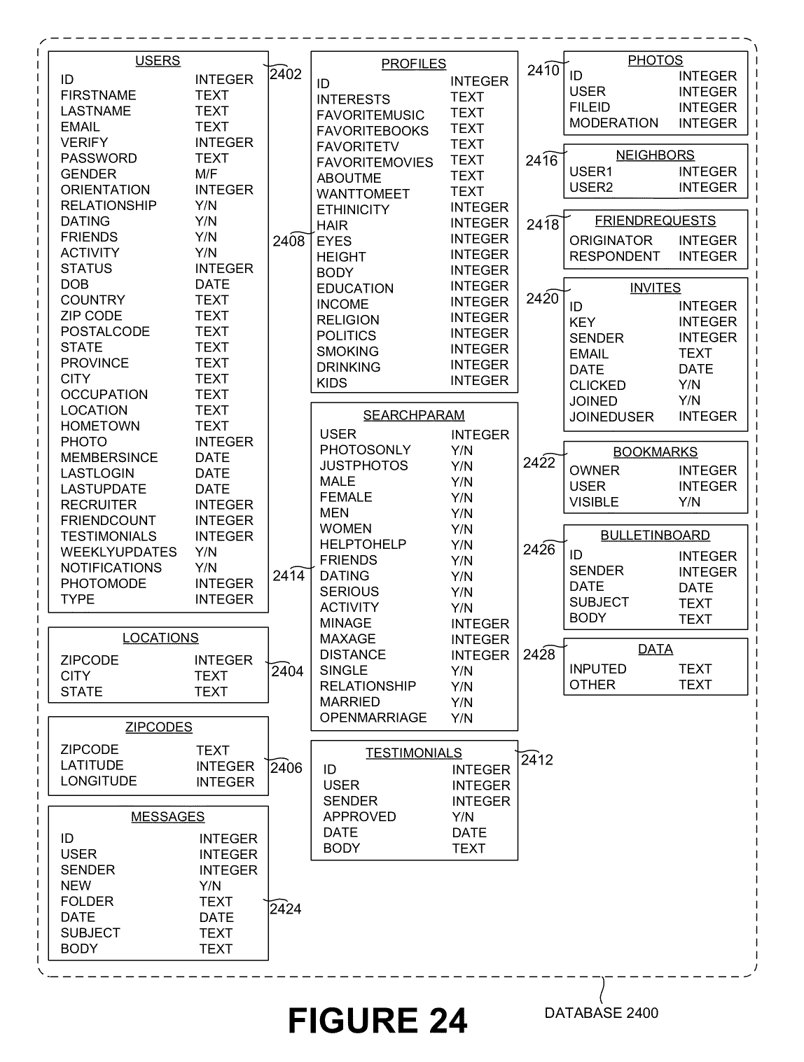

FIG. 24 is a block diagram of a database, according to one embodiment. Particularly the block diagram of the database 2400 of FIG. 24 illustrates a user data 2402, a location data, a zip codes data 2406, a profiles data 2408, a photos data 2410, a testimonials data 2412, a search parameters data 2414, a neighbor data 2416, a friends requests data1918, a invites data 2420, a bookmarks data 2422, a messages data 2424 and a bulletin board data 2426, according to one embodiment.

The database 2400 be may include descriptive data, preference data, relationship data, and/or other data items regarding the registered user of the global neighborhood environment 2300.

The user data 2402 may be a descriptive data referring to information that may describe a user (e.g., the user 106 of FIG. 1). It may include elements in a certain format for example Id may be formatted as integer, Firstname may be in text, Lastname may be in text, Email may be in text, Verify may be in integer, Password may be in text, Gender may be in m/f, Orientation may be in integer, Relationship may be in y/n, Dating may be in y/n, Friends may be in y/n, Activity may be in y/n, Status may be in integer, Dob may be in date, Country may be in text, Zip code may be in text, Postalcode may be in text, State may be in text, Province may be in text, City may be in text, Occupation may be in text, Location may be in text, Hometown may be in text, Photo may be in integer, Membersince may be in date, Lastlogin may be in date, Lastupdate may be in date, Recruiter may be in integer, Friendcount may be in integer, Testimonials may be in integer, Weeklypdates may be in y/n, Notifications may be in y/n, Photomode may be in integer and/or Type may be in integer.

The locations data 2404 may clarify the location details in formatted approach. For example Zip code may be formatted as integer, City may be in text and/or State may be in text. The zip codes data 2406 may provide information of a user location in formatted manner. For example Zip code may be formatted as text, Latitude may be in integer and/or Longitude may be in integer. The profile data 2408 may clutch personnel descriptive data that may be formatted.

For examples ID may be formatted as integer, Interests may be in text, Favoritemusic may be in text, Favaoritebooks may be in text, Favoritetv may be in text, Favoritemovies may be in text, Aboutme may be in text, Wanttommet may be in text, Ethnicity may be in integer, Hair may be in integer, Eyes may be in integer, Height may be in integer, Body may be in integer, Education may be in integer, Income may be in integer, Religion may be in integer, Politics may be in integer Smoking may be in integer, Drinking may be in integer and/or Kids may be in integer.

The photos data 2410 may represent a digital image and/or a photograph of the user formatted in certain approach. For example Id may be formatted as integer, User may be in integer, Fileid may be in integer and/or Moderation may be in integer. The testimonials data 2412 may allow users to write “testimonials” 2412, or comments, about each other and in these testimonials, users may describe their relationship to an individual and their comments about that individual. For example the user might write a testimonial that states “Rohan has been a friend of mine since graduation days. He is smart, intelligent, and a talented person.” The elements of testimonials data 2412 may be formatted as Id may be in integer, User may be in integer, Sender may be integer, Approved may be in y/n, Date may be in date and/or Body may be formatted in text.

The search parameters data 2414 may be preference data referring to the data that may describe preferences one user has with respect to another (For example, the user may indicate that he is looking for a female who is seeking a male for a serious relationship). The elements of the search parameters data 2414 may be formatted as User 2402 may be in integer, Photosonly may be in y/n, Justphotos may be in y/n, Male may be in y/n, Female may be in y/n, Men may be in y/n, Women may be in y/n, Helptohelp may be in y/n, Friends may be in y/n, Dating may be in y/n, Serious may be in y/n, Activity may be in y/n, Minage may be in integer, Maxage may be in integer, Distance may be in integer, Single may be in y/n, Relationship may be in y/n, Married may be in y/n and/or Openmarriage may be in y/n.

The neighbor's data 2416 may generally refer to relationships among registered users of the global neighborhood environment 2300 that have been verified and the user has requested another individual to join the system as neighbor 2416, and the request may be accepted. The elements of the neighbors data 2416 may be formatted as user1 may be in integer and/or user2 may be in integer. The friend requests data 2418 may tracks requests by users within the neighborhood to other individuals, which requests have not yet been accepted and may contain elements originator and/or respondent formatted in integer. The invites data 2420 may describe the status of a request by the user to invite an individual outside the neighborhood to join the neighborhood and clarify either the request has been accepted, ignored and/or pending.

The elements of the invites data 2420 may be formatted as Id may be in integer, Key may be in integer, Sender may be in integer, Email may be in text, Date may be in date format, Clicked may be in y/n, Joined may be in y/n and/or Joineduser may be in integer. The bookmarks data 2422 may be provide the data for a process allowed wherein a registered user of the global neighborhood environment 2300 may indicate an interest in the profile of another registered user. The bookmark data 2422 elements may be formatted as Owner may be in integer, User may be in integer and/or Visible may be in y/n. The message data 2424 may allow the users to send one another private messages.

The message data 2424 may be formatted as Id may be in integer, User may be in integer, Sender may be in integer, New may be in y/n, Folder may be in text, Date may be in date format, Subject may be in text and/or Body may be in text format. The bulletin board data 2426 may supports the function of a bulletin board that users may use to conduct online discussions, conversation and/or debate. The unclaimed data 2428 may share the user profiles in the neighborhood and its elements may be formatted as unclaimed inputed and/or others may be in text format.

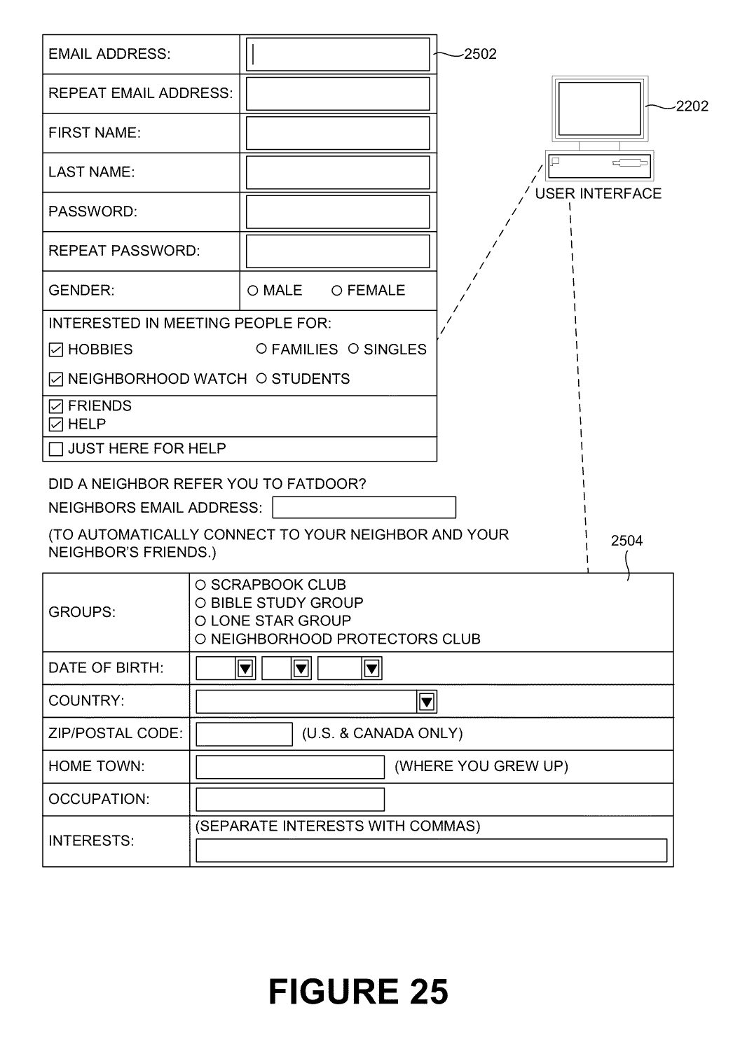

FIG. 25 is an exemplary graphical user interface view for data collection, according to one embodiment. Particularly FIG. 25 illustrates exemplary screens 2502, 2504 that may be provided to the user (e.g., the user 106 of FIG. 1) through a user interface 2302 may be through the network (e.g., Internet), to obtain user descriptive data. The screen 2502 may collect data allowing the user (e.g., the user 106 of FIG. 1) to login securely and be identified by the neighborhood. This screen 2502 may allow the user to identify the reason he/she is joining the neighborhood. For example, a user may be joining the neighborhood for “neighborhood watch”. The screen 2504 may show example of how further groups may be joined. For example, the user (e.g., the user 106 of FIG. 1) may be willing to join a group “Raj for city council”. It may also enclose the data concerning Dob, country, zip/postal code, hometown, occupation and/or interest.

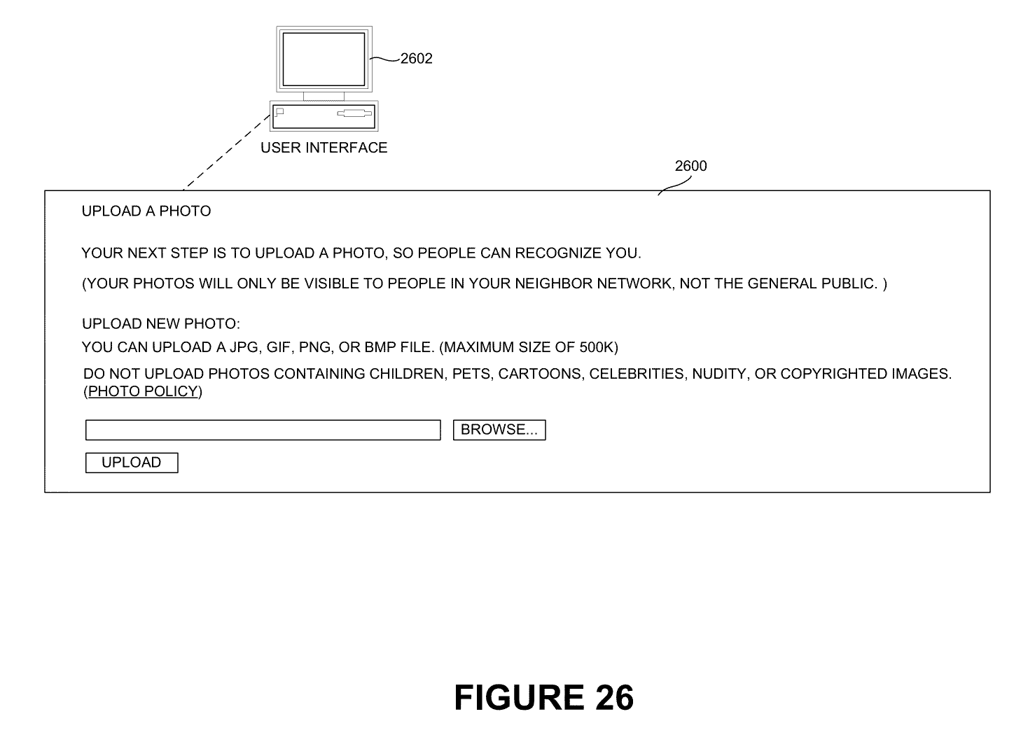

FIG. 26 is an exemplary graphical user interface view of image collection, according to one embodiment. A screen 2600 may be interface provided to the user (e.g., the user 106 of FIG. 1) over the network (e.g., internet) may be to obtain digital images from system user. The interface 2602 may allow the user (e.g., the user 106 of FIG. 1) to browse files on his/her computer, select them, and then upload them to the neighborhood. The user (e.g., the user 106 of FIG. 1) may upload the digital images and/or photo that may be visible to people in the neighbor network and not the general public. The user may be able to upload a JPG, GIF, PNG and/or BMP file in the screen 2600.

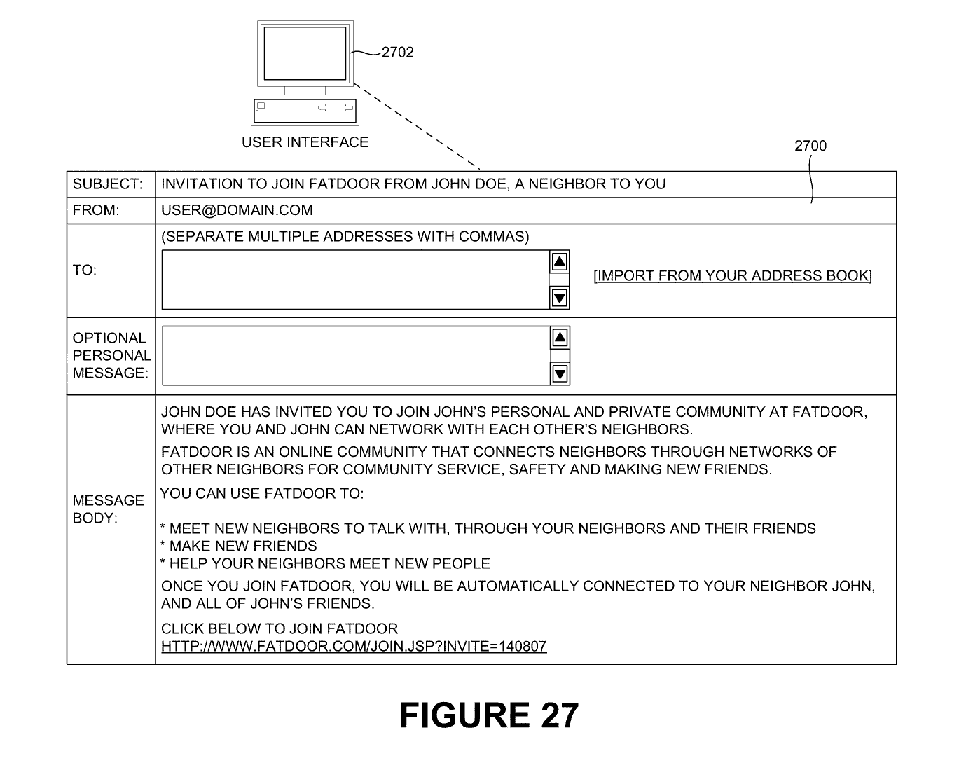

FIG. 27 is an exemplary graphical user interface view of an invitation, according to one embodiment. An exemplary screen 2700 may be provided to a user through a user interface 2702 may be over the network (e.g., internet) to allow users to invite neighbor or acquaintances to join the neighborhood. The user interface 2702 may allow the user (e.g., the user 106 of FIG. 1) to enter one or a plurality of e-mail addresses for friends they may like to invite to the neighborhood. The exemplary screen 2700 may include the “subject”, “From”, “To”, “Optional personnel message”, and/or “Message body” sections. In the “Subject” section a standard language text may be included for joining the neighborhood (e.g., Invitation to join Fatdoor from John Doe, a neighborhood.).

The “From” section may include the senders email id (e.g., user@ domain.com). The “To” section may be provided to add the email id of the person to whom the sender may want to join the neighborhood. The message that may be sent to the friends and/or acquaintances may include standard language describing the present neighborhood, the benefits of joining and the steps required to join the neighborhood. The user (e.g., the user 106 of FIG. 1) may choose to include a personal message, along with the standard invitation in the “Optional personal message” section. In the “Message body” section the invited friend or acquaintance may initiate the process to join the system by clicking directly on an HTML link included in the e-mail message (e.g., http://www.fatdoor.com/join.jsp? Invite=140807). In one embodiment, the user (e.g., the user 106 of FIG. 1) may import e-mail addresses from a standard computerized address book. The system may further notify the inviting user when her invitee accepts or declines the invitation to join the neighborhood.

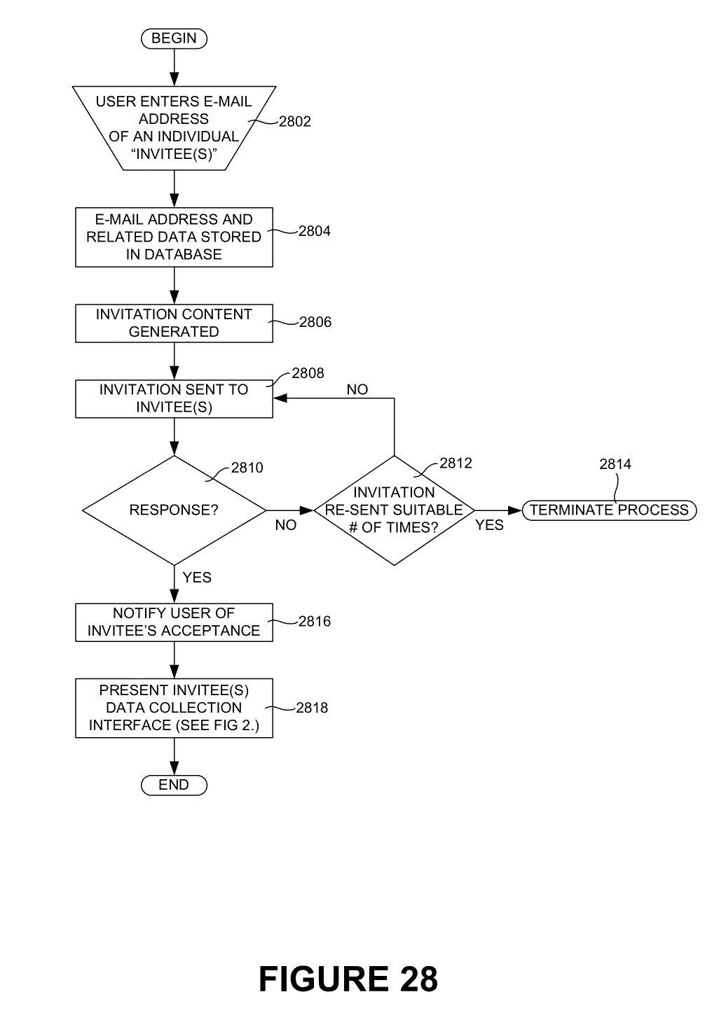

FIG. 28 is a flowchart of inviting the invitee(s) by the registered user, notifying the registered user upon the acceptance of the invitation by the invitee(s) and, processing and storing the input data associated with the user (e.g., the user 106 of FIG. 1) in the database, according to one embodiment. In operation 2802, the verified registered user (e.g., the verified registered user 1810 of FIG. 18A-B) willing to invite the individual enters the email addresses of an individual “invitee”. In operation 2804, the email address and the related data of the invitee may be stored in the database. In operation 2806, the invitation content for inviting the invitee may be generated from the data stored in the database. In operation 2808, the registered user sends invitation to the invitee(s).

In operation 2810, response from the user (e.g., the user 106 of FIG. 1) may be determined. The operation 2812, if the invitee doesn't respond to invitation sent by the registered user then registered user may resend the invitation for a predefined number of times. In operation 2814, if the registered user resends the invitation to the same invitee for predefined number of times and if the invitee still doesn't respond to the invitation the process may be terminated automatically.

In operation 2816, if the invitee accepts the invitation sent by the registered user then system may notify the registered user that the invitee has accepted the invitation. In operation 2818, the input from the present invitee(s) that may contain the descriptive data about the friend (e.g., registered user) may be processed and stored in the database.

For example, each registered user associated e-mail addresses of individuals who are not registered users may be stored and identified by each registered user as neighbors. An invitation to become a new user (e.g., the user 106 of FIG. 1) may be communicated out to neighbor of the particular user. An acceptance of the neighbor to whom the invitation was sent may be processed.

The neighbor may be added to a database and/or storing of the neighbor, a user ID and a set of user IDs of registered users who are directly connected to the neighbor, the set of user IDs stored of the neighbor including at least the user ID of the verified registered user (e.g., the verified registered user 1810 of FIG. 18A-B). Furthermore, the verified registered user may be notified that the invitation to the neighbor has been accepted when an acceptance is processed. Also, inputs from the neighbor having descriptive data about the friend may be processed and the inputs in the database may be stored.

FIG. 29 is a flowchart of adding the neighbor to the queue, according to one embodiment. In operation 2902, the system may start with the empty connection list and empty queue. In operation 2904, the user may be added to the queue. In operation 2906, it is determined whether the queue is empty. In operation 2908, if it is determined that the queue is not empty then the next person P may be taken from the queue. In operation 2910, it may be determined whether the person P from the queue is user B or not. In operation 2912, if the person P is not user B then it may be determined whether the depth of the geographical location is less than maximum degrees of separation.

If it is determined that depth is more than maximum allowable degrees of separation then it may repeat the operation 2908. In operation 2914, if may be determined that the depth of the geographical location (e.g., the geographical location 1704 of FIG. 17A) is less than maximum degrees of separation then the neighbors list for person P may be processed. In operation 2916, it may be determined whether all the neighbors in the neighborhood have been processed or not. If all the friends are processed it may be determined the queue is empty.

In operation 2918, if all the neighbors for person P are not processed then next neighbor N may be taken from the list. In operation 2920, it may be determined whether the neighbor N has encountered before or not. In operation 2922, if the neighbor has not been encountered before then the neighbor may be added to the queue. In operation 2924, if the neighbor N has been encountered before it may be further determined whether the geographical location (e.g., the geographical location 1704 of FIG. 17A) from where the neighbor has encountered previously is the same place or closer to that place.

If it is determined that the neighbor has encountered at the same or closer place then the friend may be added to the queue. If it may be determined that friend is not encountered at the same place or closer to that place then it may be again checked that all the friends have processed. In operation 2926, if it is determined that the person P is user B than the connection may be added to the connection list and after adding the connection to connection list it follows the operation 2912. In operation 2928, if it may be determined that queue is empty then the operation may return the connections list.

For example, a first user ID with the verified registered user (e.g., the verified registered user 1810 of FIG. 18A-B) and a second user ID may be applied to the different registered user. The verified registered user (e.g., the verified registered user 1810 of FIG. 18A-B) with the different registered user may be connected with each other through at least one of a geo-positioning data associated with the first user ID and the second user ID. In addition, a maximum degree of separation (Nmax) of at least two that is allowed for connecting any two registered users, (e.g., the two registered users who may be directly connected may be deemed to be separated by one degree of separation and two registered users who may be connected through no less than one other registered user may be deemed to be separated by two degrees of separation and two registered users who may be connected through not less than N other registered users may be deemed to be separated by N+1 degrees of separation).

Furthermore, the user ID of the different registered user may be searched (e.g., the method limits the searching of the different registered user in the sets of user IDs that may be stored as registered users who are less than Nmax degrees of separation away from the verified registered user (e.g., the verified registered user 1810 of FIG. 18A-B), such that the verified registered user (e.g., the verified registered user 1810 of FIG. 18A-B) and the different registered user who may be separated by more than Nmax degrees of separation are not found and connected.) in a set of user IDs that may be stored of registered users who are less than Nmax degrees of separation away from the verified registered user (e.g., the verified registered user 1810 of FIG. 18A-B), and not in the sets of user IDs that may be stored for registered users who are greater than or equal to Nmax degrees of separation away from the verified registered user (e.g., the verified registered user 1810 of FIG. 18A-B), until the user ID of the different registered user may be found in one of the searched sets. Also, the verified registered user (e.g., the verified registered user 1810 of FIG. 18A-B) may be connected to the different registered user if the user ID of the different registered user may be found in one of the searched sets.

Moreover, the sets of user IDs that may be stored of registered users may be searched initially who are directly connected to the verified registered user (e.g., the verified registered user 1810 of FIG. 18A-B). A profile of the different registered user may be communicated to the verified registered user (e.g., the verified registered user 1810 of FIG. 18A-B) to display through a marker associating the verified registered user (e.g., the verified registered user 1810 of FIG. 18A-B) with the different registered user. A connection path between the verified registered user (e.g., the verified registered user 1810 of FIG. 18A-B) and the different registered user, the connection path indicating at least one other registered user may be stored through whom the connection path between the verified registered user (e.g., the verified registered user 1810 of FIG. 18A-B) and the different registered user is made.

In addition, the connection path between the verified registered user (e.g., the verified registered user 1810 of FIG. 18A-B) and the different registered user may be communicated to the verified registered user to display. A hyperlink in the connection path of each of the at least one registered users may be embedded through whom the connection path between the verified registered user (e.g., the verified registered user 1810 of FIG. 18A-B) and the different registered user is made.

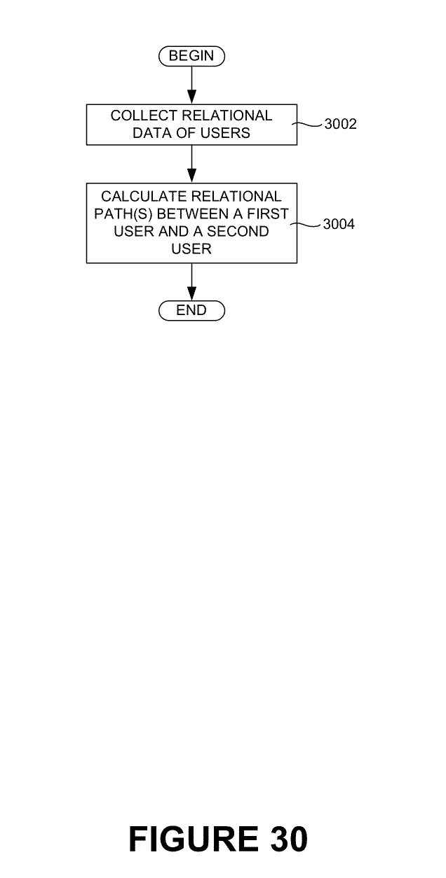

FIG. 30 is a flowchart of communicating brief profiles of the registered users, processing a hyperlink selection from the verified registered user (e.g., the verified registered user 1810 of FIG. 18A-B) and calculating and ensuring the Nmax degree of separation of the registered users away from verified registered users (e.g., the verified registered user 1810 of FIG. 18A-B), according to one embodiment. In operation 3002, the data of the registered users may be collected from the database. In operation 3004, the relational path between the first user and the second user may be calculated (e.g., the Nmax degree of separation between verified registered user (e.g., the verified registered user 1810 of FIG. 18A-B) and the registered user).

For example, the brief profiles of registered users, including a brief profile of the different registered user, to the verified registered user (e.g., the verified registered user 1810 of FIG. 18A-B) for display, each of the brief profiles including a hyperlink to a corresponding full profile may be communicated.

Furthermore, the hyperlink selection from the verified registered user (e.g., the verified registered user 1810 of FIG. 18A-B) may be processed (e.g., upon processing the hyperlink selection of the full profile of the different registered user, the full profile of the different registered user may be communicated to the verified registered user (e.g., the verified registered user 1810 of FIG. 18A-B) for display). In addition, the brief profiles of those registered users may be ensured who are more than Nmax degrees of separation away from the verified registered user (e.g., the verified registered user 1810 of FIG. 18A-B) are not communicated to the verified registered user (e.g., the verified registered user 1810 of FIG. 18A-B) for display.

FIG. 31 is an N degree separation view 3150, according to one embodiment. ME may be a verified registered user (e.g., the verified registered user 1810 of FIG. 18A-B) of the global neighborhood environment 2300 centered in the neighborhood network. A, B, C, D, E, F, G, H, I, J, K, L, M, N, O, P, Q, R, S, T, and/or U may be the other registered user of the neighborhood network. The member of the neighborhood network may be separated from the centered verified registered user (e.g., the verified registered user 1810 of FIG. 18A-B) ME of the neighborhood network by certain degree of separation. The registered user A, B and C may be directly connected and are deemed to be separated by one degree of separation from verified registered user (e.g., the verified registered user 1810 of FIG. 18A-B) ME. The registered user D, E, F, G, and H may be connected through no less than one other registered user may be deemed to be separated by two degree of separation from verified registered user (e.g., the verified registered user 1810 of FIG. 18A-B) ME. The registered user I, J, K, and L may be connected through no less than N−1 other registered user may be deemed to be separated by N degree of separation from verified registered user (e.g., the verified registered user 1810 of FIG. 18A-B) ME. The registered user M, N, O, P, Q, R S, T and U may be all registered user.

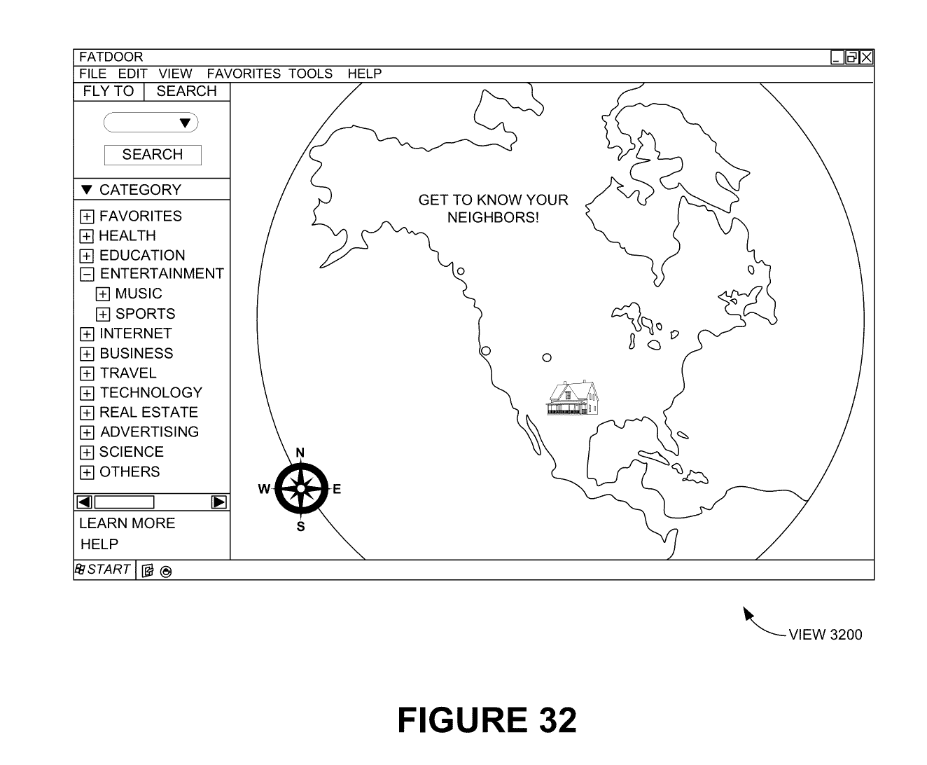

FIG. 32 is a user interface view 3200 showing a map, according to one embodiment. Particularly FIG. 32 illustrates a satellite photo of a physical world. The registered user of the global neighborhood environment 2300 may use this for exploring the geographical location (e.g., the geographical location 1704 of FIG. 17A) of the neighbors. The registered user (e.g., the verified registered user 1810 of FIG. 18A-B) may navigate, zoom, explore and quickly find particular desired geographical locations of the desired neighbors. This may help the registered user to read the map and/or plot the route of the neighbors on the world map.

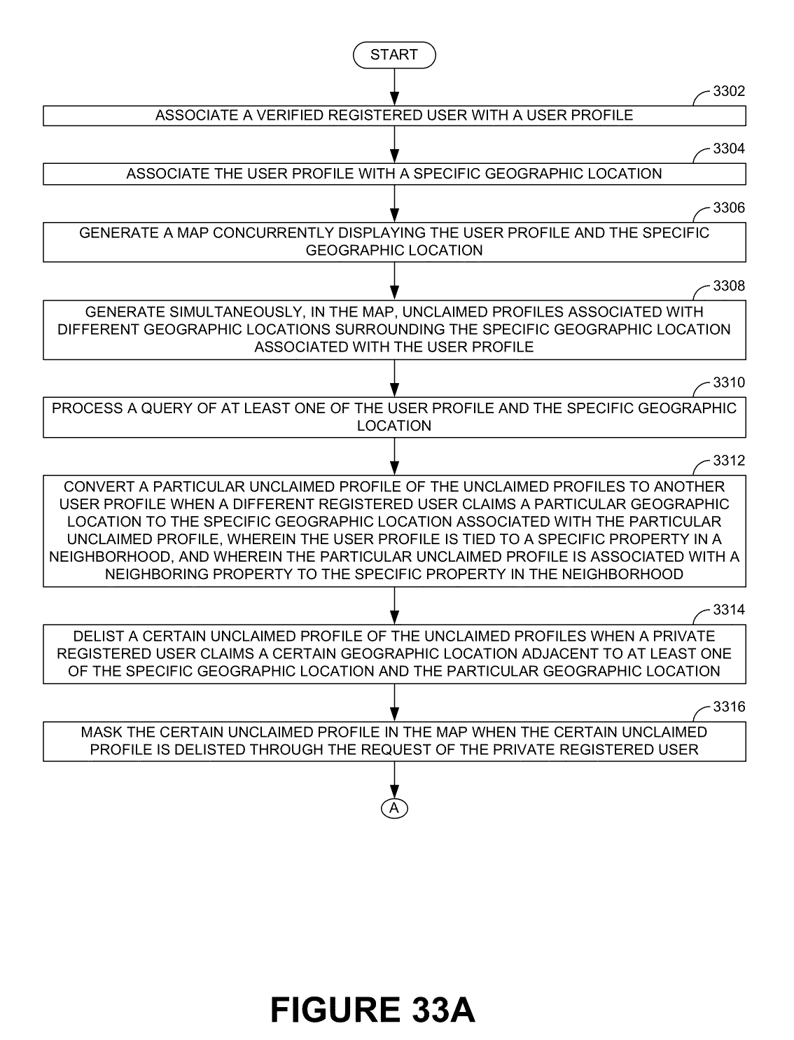

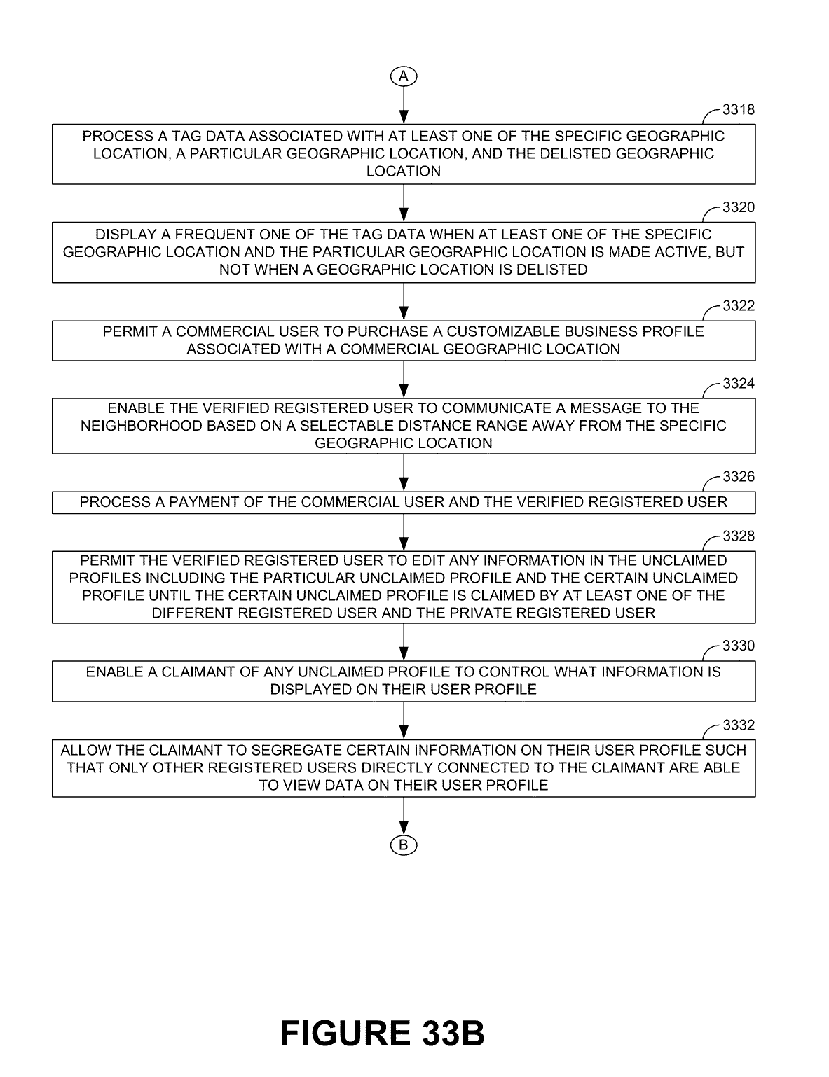

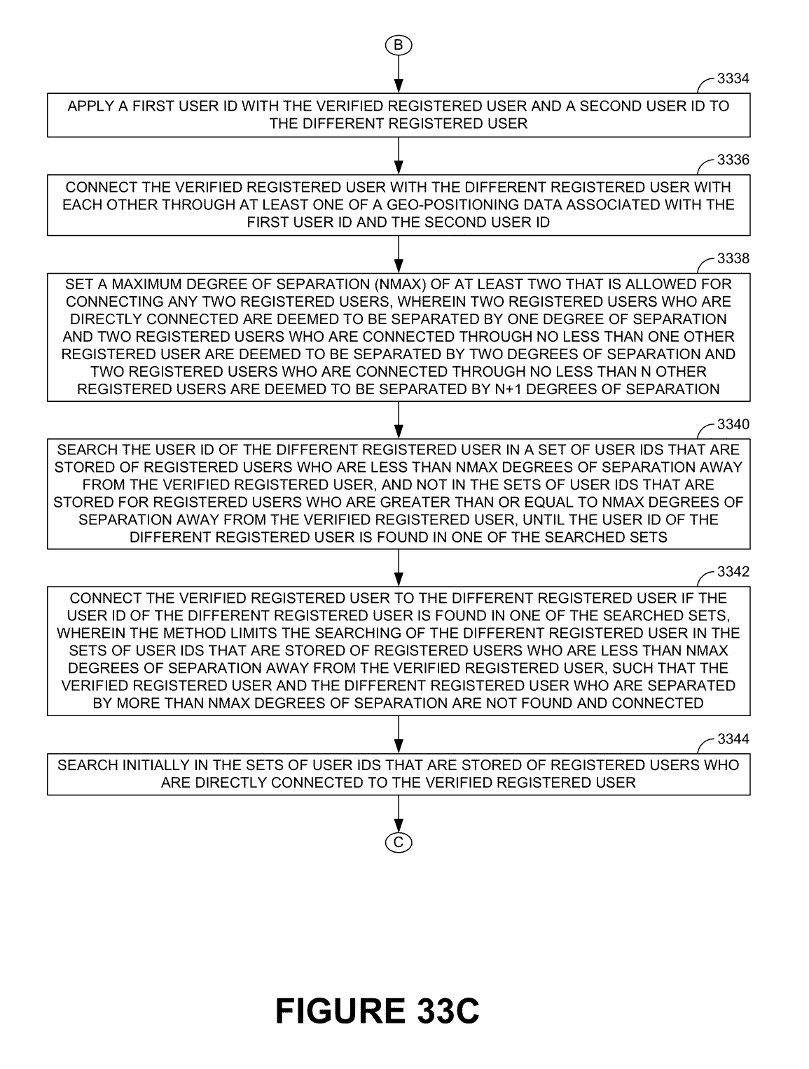

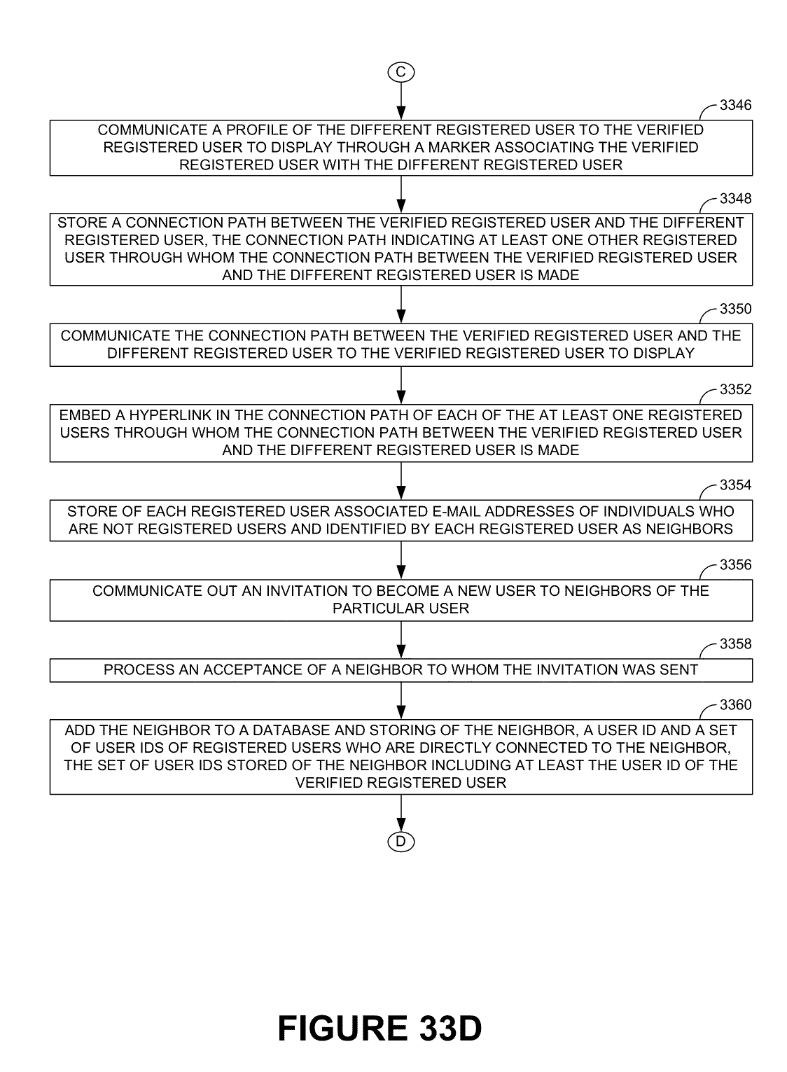

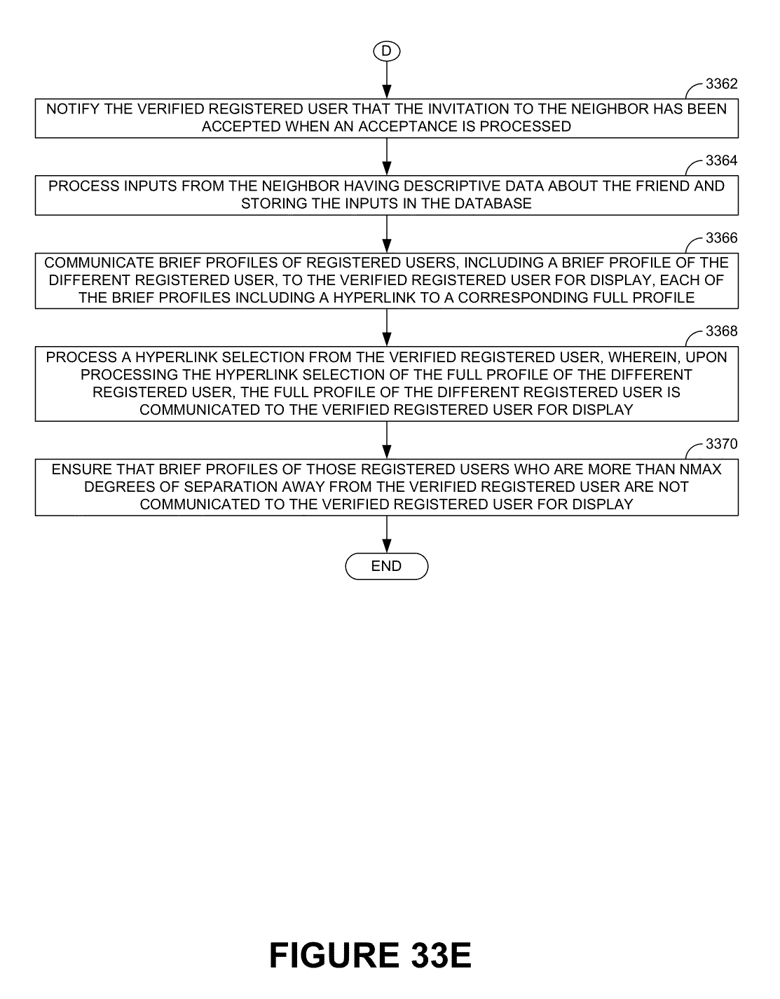

FIG. 33A is a process flow of searching map based community and neighborhood contribution, according to one embodiment. In operation 3302, a verified registered user (e.g., a verified registered user 1810 of FIG. 18A-13B, a verified registered user 1810 of FIG. 21) may be associated with a user profile (e.g., a user profile 29200 of FIG. 17A). In operation 3304, the user profile may be associated with a specific geographic location (e.g., a geographic location 1704 of FIG. 17A).

In operation 3306, a map (e.g., a map 1702 of FIG. 17A-41B, a map 1900 of FIG. 19, a map 2100 of FIG. 21, a map 2201 of FIG. 22) may be generated concurrently displaying the user profile and the specific geographic location (e.g., the geographic location 1704 of FIG. 17A). In operation, 3308, in the map, unclaimed profiles (e.g., a unclaimed profile 1706 of FIG. 17A-B, a unclaimed profile 1802 of FIG. 18A, a unclaimed profile 2204 of FIG. 22) associated with different geographic locations may be simultaneously generated surrounding the specific geographic location (e.g., the geographic location 1704 of FIG. 17A) associated with the user profile.

In operation 3310, a query of at least one of the user profile and the specific geographic location (e.g., the geographic location 1704 of FIG. 17A) may be processed. In operation 3312, a particular unclaimed profile of the unclaimed profiles (e.g., the unclaimed profile 1706 of FIG. 17A-B, the unclaimed profile 1802 of FIG. 18A, the unclaimed profile 2204 of FIG. 22) may be converted to another user profile when a different registered user claims a particular geographic location to the specific geographic location (e.g., the geographic location 1704 of FIG. 17A) associated with the particular unclaimed profile (e.g., the unclaimed profile 1706 of FIG. 17A-B, the unclaimed profile 1802 of FIG. 18A, the unclaimed profile 2204 of FIG. 22), wherein the user profile may be tied to a specific property in a neighborhood (e.g., a neighborhood 2902A-2902N of FIG. 29), and wherein the particular unclaimed profile (e.g., the unclaimed profile 1706 of FIG. 17A-41B, the unclaimed profile 1802 of FIG. 18A, the unclaimed profile 2204 of FIG. 22) may be associated with a neighboring property to the specific property in the neighborhood (e.g., the neighborhood 2920A-2920N of FIG. 29).

In operation 3314, a certain unclaimed profile (e.g., the unclaimed profile 1706 of FIG. 17A-41B, the unclaimed profile 1802 of FIG. 18A, the unclaimed profile 2204 of FIG. 22) of the unclaimed profiles (e.g., the unclaimed profile 1706 of FIG. 17A-B, the unclaimed profile 1802 of FIG. 18A, the unclaimed profile 2204 of FIG. 22) may be delisted when a private registered user claims a certain geographic location (e.g., the geographic location 1704 of FIG. 17A) adjacent to at least one of the specific geographic location and the particular geographic location (e.g., the geographic location 1704 of FIG. 17A).

In operation 3316, the certain unclaimed profile (e.g., the unclaimed profile 1706 of FIG. 17A-B, the unclaimed profile 1802 of FIG. 18A, the unclaimed profile 2204 of FIG. 22) in the map (e.g., the map 1702 of FIG. 17A-B, the map 1900 of FIG. 19, the map 2100 of FIG. 21, the map 2201 of FIG. 22) when the certain unclaimed profile may be delisted and/or be masked through the request of the private registered user.

FIG. 33B is a continuation of process flow of FIG. 33A showing additional processes, according to one embodiment. In operation 3318, a tag data associated with at least one of the specific geographic location, the particular geographic location (e.g., the geographic location 1704 of FIG. 17A), and the delisted geographic location may be processed. In operation 3320, a frequent one of the tag data may be displayed when at least one of the specific geographic location and the particular geographic location (e.g., the geographic location 1704 of FIG. 17A) may be made active, but not when the geographic location (e.g., the geographic location 1704 of FIG. 17A) may be delisted.

In operation 3322, a commercial user (e.g., a commercial user 1800 of FIG. 18A-B) may be permitted to purchase a customizable business profile (e.g., a customizable business profile 1804 of FIG. 18B) associated with a commercial geographic location. In operation 3324, the verified registered user (e.g., the verified registered user 1810 of FIG. 18A-B) to communicate a message to the neighborhood (e.g., the neighborhood 2902A-2902N of FIG. 29) may be enabled based on a selectable distance range away from the specific geographic location.

In operation 3326, a payment of the commercial user (e.g., the commercial user 1800 of FIG. 18A-B) and the verified registered user (e.g., the verified registered user 1810 of FIG. 18A-B) may be processed. In operation 3328, the verified registered user (e.g., the verified registered user 1810 of FIG. 18A-B) may be permitted to edit any information in the unclaimed profiles (e.g., the unclaimed profile 1706 of FIG. 17A-B, the unclaimed profile 1802 of FIG. 18A, the unclaimed profile 2204 of FIG. 22) including the particular unclaimed profile and the certain unclaimed profile until the certain unclaimed profile may be claimed by at least one of the different registered user and the private registered user.

In operation 3330, a claimant of any unclaimed profile (e.g., the unclaimed profile 1706 of FIG. 17A-B, the unclaimed profile 1802 of FIG. 18A, the unclaimed profile 2204 of FIG. 22) may be enabled to control what information is displayed on their user profile. In operation 3332, the claimant to segregate certain information on their user profile may be allowed such that only other registered users directly connected to the claimant are able to view data on their user profile.

FIG. 33C is a continuation of process flow of FIG. 33B showing additional processes, according to one embodiment. In operation 3334, a first user ID with the verified registered user (e.g., the verified registered user 1810 of FIG. 18A-B) and a second user ID to the different registered user may be applied. In operation 3336, the verified registered user (e.g., the verified registered user 1810 of FIG. 18A-B) with the different registered user with each other may be connected through at least one of associated with the first user ID and the second user ID.

In operation 3338, a maximum degree of separation (Nmax) of at least two may be set that is allowed for connecting any two registered users, wherein two registered users who are directly connected may be deemed to be separated by one degree of separation and two registered users who are connected through no less than one other registered user may be deemed to be separated by two degrees of separation and two registered users who may be connected through no less than N other registered users are deemed to be separated by N+1 degrees of separation. In operation 3340, the user ID of the different registered user may be searched in a set of user IDs that are stored of registered users who are less than Nmax degrees of separation away from the verified registered user (e.g., the verified registered user 1810 of FIG. 18A-B), and not in the sets of user IDs that are stored for registered users who may be greater than or equal to Nmax degrees of separation away from the verified registered user (e.g., the verified registered user 1810 of FIG. 18A-B), until the user ID of the different registered user may be found in one of the searched sets.

In operation 3342, the verified registered user (e.g., the verified registered user 1810 of FIG. 18A-B) may be connected to the different registered user if the user ID of the different registered user may be found in one of the searched sets, wherein the method limits the searching of the different registered user in the sets of user IDs that may be stored of registered users who may be less than Nmax degrees of separation away from the verified registered user (e.g., the verified registered user 1810 of FIG. 18A-B), such that the verified registered user (e.g., the verified registered user 1810 of FIG. 18A-B) and the different registered user who may be separated by more than Nmax degrees of separation are not found and connected. In operation 3344, initially in the sets of user IDs that are stored of registered users who may be directly connected to the verified registered user (e.g., the verified registered user 1810 of FIG. 18A-B) may be initially searched.

FIG. 33D is a continuation of process flow of FIG. 33C showing additional processes, according to one embodiment. In operation 3346, a profile of the different registered user to the verified registered user (e.g., the verified registered user 1810 of FIG. 18A-B) to display may be communicated through a marker associating the verified registered user (e.g., the verified registered user 1810 of FIG. 18A-B) with the different registered user.

In operation 3348, a connection path between the verified registered user (e.g., the verified registered user 1810 of FIG. 18A-B) and the different registered user, the connection path indicating at least one other registered user may be stored through whom the connection path between the verified registered user (e.g., the verified registered user 1810 of FIG. 18A-B) and the different registered user may be made.

In operation 3350, the connection path between the verified registered user (e.g., the verified registered user 1810 of FIG. 18A-B) and the different registered user to the verified registered user (e.g., the verified registered user 1810 of FIG. 18A-B) may be communicated to display.

In operation 3352, a hyperlink in the connection path of each of the at least one registered users may be embedded through whom the connection path between the verified registered user (e.g., the verified registered user 1810 of FIG. 18A-B) and the different registered user may be made. In operation 3354, each registered user associated e-mail addresses of individuals who are not registered users may be stored and identified by each registered user as neighbors (e.g., a neighbor 2920 of FIG. 29).

In operation 3356, an invitation may be communicated to become a new user (e.g., a user 106 of FIG. 1) to neighbors of the particular user. In operation 3358, an acceptance of the neighbor to whom the invitation was sent may be processed. In operation 3360, the neighbor to a database and storing of the neighbor, a user ID and the set of user IDs of registered users may be added who are directly connected to the neighbor, the set of user IDs stored of the neighbor including at least the user ID of the verified registered user (e.g., the verified registered user 1810 of FIG. 18A-B).

FIG. 33E is a continuation of process flow of FIG. 33D showing additional processes, according to one embodiment. In operation 3362, the verified registered user (e.g., the verified registered user 1810 of FIG. 18A-B) that the invitation to the neighbor has been accepted may be notified when the acceptance is processed.

In operation 3364, inputs from the neighbor having descriptive data about the friend and storing the inputs in the database may be processed. In operation 3366, brief profiles of registered users, including a brief profile of the different registered user may be communicated, to the verified registered user (e.g., the verified registered user 1810 of FIG. 18A-B) for display, each of the brief profiles including the hyperlink to a corresponding full profile.

In operation 3368, the hyperlink selection from the verified registered user (e.g., the verified registered user 1810 of FIG. 18A-B) may be processed, wherein, upon processing the hyperlink selection of the full profile of the different registered user, the full profile of the different registered user is communicated to the verified registered user (e.g., the verified registered user 1810 of FIG. 18A-B) for display.

In operation 3370, brief profiles of those registered users who may be more than Nmax degrees of separation away from the verified registered user (e.g., the verified registered user 1810 of FIG. 18A-B) may not communicated to the verified registered user (e.g., the verified registered user 1810 of FIG. 18A-B) may be ensured for display.

In one embodiment, a method of a neighborhood broadcast server 100 includes validating that a station broadcast data 102 generated through a device 104 is associated with a verified user (e.g., a user 106) of the neighborhood broadcast server 100 using a processor 120 and a memory 124. The method verifies that a set of geospatial coordinates 103 associated with the station broadcast data 102 generated through the device 104 are trusted based on a claimed geospatial location (e.g., any of the claimed geospatial locations 700 as described in FIG. 7 of the verified user (e.g., the user 106 of FIG. 1 as described as the verified user 706 in FIG. 7) of the neighborhood broadcast server 100). In addition, the method determines that a time stamp 510 associated with a creation date 508 and a creation time 507 of the station broadcast data 102 generated through the device 104 is trusted based on the claimed geospatial location (e.g., any of the claimed geospatial locations 700 as described in FIG. 7 of the verified user (e.g., the user 106 of FIG. 1 as described as the verified user 706 in FIG. 7) of the neighborhood broadcast server 100).

Furthermore, the station broadcast data 102 generated through the device 104 is automatically published on a set of user profiles (e.g., preseeded user profiles 302 and/or claimed user profiles 304 as described in FIG. 3) having associated verified addresses in a threshold radial distance 119 from the set of geospatial coordinates 103 associated with the station broadcast data 102 generated through the device 104 of the verified user (e.g., the user 106 of FIG. 1 as described as the verified user 706 in FIG. 7) of the neighborhood broadcast server 100 using a radial algorithm 240. A listing criteria 712 associated with the station broadcast data 102 including a description, a photograph, a video, a category, a functional status of a station broadcast offered through the station broadcast data 102 may be processed.

An availability chart 714 may be populated when the station broadcast associated with the listing criteria 712 is posted. The availability chart 714 may include a target broadcasting verified user 706 within the area radius, a start timing, a broadcast duration, and/or a timing criteria. The method may determine that the station broadcast data 102 is generated by the verified user (e.g., the user 106 of FIG. 1 as described as the verified user 706 in FIG. 7) of the neighborhood broadcast system (e.g., of the geospatially constrained social network 142) when validating that the station broadcast data 102 is associated with the device 104.

The method may determine that an application (e.g., a downloadable application such as the Fatdoor mobile application and/or the Nextdoor mobile application) on the device 104 is communicating the station broadcast data 102 to the neighborhood broadcasting system when the station broadcast data 102 is processed. The verified user (e.g., the user 106 of FIG. 1 as described as the verified user 706 in FIG. 7) may be associated with a verified user (e.g., the user 106 of FIG. 1 as described as the verified user 706 in FIG. 7) profile in the neighborhood broadcasting system through the application on the device 104. The station broadcast data 102 generated through the device 104 may be presented as a station broadcast alert pushpin of the station broadcast in a geospatial map surrounding pre-populated residential and/or business listings in a surrounding vicinity (such that the station broadcast alert pushpin of the station broadcast may be automatically presented on the geospatial map in addition to being presented on the set of user profiles (e.g., preseeded user profiles 302 and/or claimed user profiles 304 as described in FIG. 3 having associated verified addresses in the threshold radial distance 119 from the set of geospatial coordinates 103 associated with the station broadcast data 102 generated through the device 104 of the verified user (e.g., the user 106 of FIG. 1 as described as the verified user 706 in FIG. 7) of the neighborhood broadcast server 100)).

The station broadcast data 102 generated through the device 104 may be radially distributed through an on-page posting, an electronic communication, and/or a push notification (delivered to desktop and/or mobile devices 504). The station broadcast data 102 may be associated with users and/or their user profiles (e.g., preseeded user profiles 302 and/or claimed user profiles 304 as described in FIG. 3 around an epicenter 144 defined at the set of geospatial coordinates 103 associated with the station broadcast data 102. The station broadcast data 102 may be generated through the device 104 to all subscribed user profiles (e.g., preseeded user profiles 302 and/or claimed user profiles 304 as described in FIG. 3 in a circular geo-fenced area defined by the threshold distance from the set of geospatial coordinates 103 associated with the station broadcast data 102. Furthermore, the station broadcast data 102 may be generated through the device 104 through the radial algorithm 240 of a neighborhood broadcasting system that measures a distance away of each address associated with each user profile from the current geospatial location at the epicenter.

The verified user (e.g., the user 106 of FIG. 1 as described as the verified user 706 in FIG. 7) may be permitted to drag and/or drop the station broadcast alert pushpin on any location on the geospatial map, and/or automatically determining a latitude and/or a longitude associated with a placed location. A theater 309A, a school 309B, a cinema 309C, a public exhibition space 309D, and/or a restaurant 309E in a surrounding geospatial area to the set of geospatial coordinates 103 associated with the station broadcast data 102 generated through the device 104 may be automatically notified. The geospatial coordinates 103 may be extracted from a metadata associated with the station broadcast data 102 generated through the device 104 when verifying that the set of geospatial coordinates 103 associated with the station broadcast data 102 generated through the device 104 are trusted based on the claimed geospatial location (e.g., any of the claimed geospatial locations 700 as described in FIG. 7 of the verified user (e.g., the user 106 of FIG. 1 as described as the verified user 706 in FIG. 7) of the neighborhood broadcast server 100). A relative match between a persistent clock associated with the neighborhood broadcast server 100 and/or a digital clock of the device 104 may determine that the time stamp 510 associated with the creation date 508 and/or time of the station broadcast data 102 generated through the device 104 is accurate and therefore trusted.

A publishing of the station broadcast data 102 generated through the device 104 on a set of user profiles (e.g., preseeded user profiles 302 and/or claimed user profiles 304 as described in FIG. 3 having associated verified addresses in the threshold radial distance 119 from the set of geo spatial coordinates 103 associated with the station broadcast data 102 generated through the device 104 of the verified user (e.g., the user 106 of FIG. 1 as described as the verified user 706 in FIG. 7) of the neighborhood broadcast server 100) may be automatically deleted based on a station broadcast alert expiration time. A set of residential addresses each associated with a resident name in a neighborhood surrounding the device 104 may be geocoded. The method may prepopulate the set of residential addresses (each associated with the resident name) as the set of user profiles (e.g., preseeded user profiles 302 and/or claimed user profiles 304 as described in FIG. 3 in the threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the neighborhood broadcast server 100) in a neighborhood curation system (e.g., part of the geospatially constrained social network 142) communicatively coupled with the neighborhood broadcast server 100. The method may permit the verified user (e.g., the user 106 of FIG. 1 as described as the verified user 706 in FIG. 7) to modify content in each of the set of user profiles (e.g., preseeded user profiles 302 and/or claimed user profiles 304 as described in FIG. 3. The modified content may be tracked through the neighborhood curation system (e.g., part of the geospatially constrained social network 142).

A reversible history journal associated with each of the set of user profiles (e.g., preseeded user profiles 302 and/or claimed user profiles 304 as described in FIG. 3 such that a modification of the verified user (e.g., the user 106 of FIG. 1 as described as the verified user 706 in FIG. 7) can be undone on a modified user profile page may be generated. An editing credibility of the verified user (e.g., the user 106 of FIG. 1 as described as the verified user 706 in FIG. 7) based on an edit history of the verified user (e.g., the user 106 of FIG. 1 as described as the verified user 706 in FIG. 7) and/or a community contribution validation of the verified user (e.g., the user 106 of FIG. 1 as described as the verified user 706 in FIG. 7) by other users of the neighborhood curation system (e.g., part of the geospatially constrained social network 142) may be determined. The station broadcast data 102 generated through the device 104 to a set of user profiles (e.g., preseeded user profiles 302 and/or claimed user profiles 304 as described in FIG. 3 having associated verified addresses in a threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the neighborhood broadcast server 100) using the radial algorithm 240 may be automatically published. A claim request of the verified user (e.g., the user 106 of FIG. 1 as described as the verified user 706 in FIG. 7) generating the station broadcast data 102 generated through the device 104 to be associated with an address of the neighborhood curation system (e.g., part of the geospatially constrained social network 142) may be processed.

It may be determined if the claimable neighborhood in the neighborhood curation system (e.g., part of the geospatially constrained social network 142) is associated with a private neighborhood community in the claimable neighborhood of the neighborhood curation system (e.g., part of the geospatially constrained social network 142). The verified user (e.g., the user 106 of FIG. 1 as described as the verified user 706 in FIG. 7) may be associated with the private neighborhood community in the claimable neighborhood of the neighborhood curation system (e.g., part of the geospatially constrained social network 142) if the private neighborhood community has been activated by the verified user (e.g., the user 106 of FIG. 1 as described as the verified user 706 in FIG. 7) and/or a different verified user (e.g., the user 106 of FIG. 1 as described as the verified user 706 in FIG. 7). The verified user (e.g., the user 106 of FIG. 1 as described as the verified user 706 in FIG. 7) may be permitted to draw a set of boundary lines in a form of a geospatial polygon such that the claimable neighborhood in a geospatial region surrounding the claim request creates the private neighborhood community in the neighborhood curation system (e.g., part of the geospatially constrained social network 142) if the private neighborhood community may be inactive.

The method may verify the claim request of the verified user (e.g., the user 106 of FIG. 1 as described as the verified user 706 in FIG. 7) generating the station broadcast data 102 generated through the device 104 to be associated with a neighborhood address of the neighborhood curation system (e.g., part of the geospatially constrained social network 142) when the address may be determined to be associated with a work address and/or a residential address of the verified user (e.g., the user 106 of FIG. 1 as described as the verified user 706 in FIG. 7). The station broadcast data 102 generated through the device 104 on the private neighborhood community associated with the verified user (e.g., the user 106 of FIG. 1 as described as the verified user 706 in FIG. 7) generating the station broadcast data 102 generated through the device 104 may be simultaneously published through the device 104 in the threshold radial distance 119 from the address associated with the claim request of the verified user (e.g., the user 106 of FIG. 1 as described as the verified user 706 in FIG. 7) of the neighborhood curation system (e.g., part of the geospatially constrained social network 142) (when automatically publishing the station broadcast data 102 generated through the device 104 on a set of user profiles (e.g., preseeded user profiles 302 and/or claimed user profiles 304 as described in FIG. 3 having associated verified addresses) in a threshold radial distance 119 from the claimed geospatial location (e.g., any of the claimed geospatial locations 700 as described in FIG. 7 of the verified user (e.g., the user 106 of FIG. 1 as described as the verified user 706 in FIG. 7) of the neighborhood broadcast server 100) based on a set of preferences of the verified user (e.g., the user 106 of FIG. 1 as described as the verified user 706 in FIG. 7) using the radial algorithm 240.

The station broadcast data 102 generated through the device 104 may be live broadcasted to the different verified user (e.g., the user 106 of FIG. 1 as described as the verified user 706 in FIG. 7) and/or other verified user (e.g., the user 106 of FIG. 1 as described as the verified user 706 in FIG. 7) in the private neighborhood community and/or currently within the threshold radial distance 119 from the current geospatial location through the neighborhood broadcast server 100 through a multicast algorithm such that a live broadcast multicasts to a plurality of data processing systems associated with each of the different user and/or the other verified user (e.g., the user 106 of FIG. 1 as described as the verified user 706 in FIG. 7) simultaneously when the device 104 of the verified user (e.g., the user 106 of FIG. 1 as described as the verified user 706 in FIG. 7) generating the live-broadcast enables broadcasting of the station broadcast data 102 generated through the device 104 to any one of a geospatial vicinity around the device 104 of the verified user (e.g., the user 106 of FIG. 1 as described as the verified user 706 in FIG. 7) generating the broadcast and/or in any private neighborhood community in which the verified user (e.g., the user 106 of FIG. 1 as described as the verified user 706 in FIG. 7) has a non-transitory connection.

The different verified user (e.g., the user 106 of FIG. 1 as described as the verified user 706 in FIG. 7) and/or other verified user (e.g., the user 106 of FIG. 1 as described as the verified user 706 in FIG. 7) in the private neighborhood community may be permitted to bi-directionally communicate with the verified user (e.g., the user 106 of FIG. 1 as described as the verified user 706 in FIG. 7) generating the broadcast through the neighborhood broadcast server 100. Any private neighborhood community in which the verified user (e.g., the user 106 of FIG. 1 as described as the verified user 706 in FIG. 7) has a non-transitory connection may be a residential address of the verified user (e.g., the user 106 of FIG. 1 as described as the verified user 706 in FIG. 7) and/or a work address of the verified user (e.g., the user 106 of FIG. 1 as described as the verified user 706 in FIG. 7) that has been confirmed by the neighborhood broadcast server 100 as being associated with the verified user (e.g., the user 106 of FIG. 1 as described as the verified user 706 in FIG. 7). The threshold distance may be between 0.2 and/or 0.4 miles from the set of geospatial coordinates 103 associated with the station broadcast data 102 generated through the device 104 to optimize a relevancy of the live-broadcast.

The neighborhood broadcast server 100 may include a crowdsourced moderation algorithm in which multiple neighbors to a geospatial area determine what content contributed to the neighborhood broadcast server 100 persists and/or which may be deleted. The neighborhood broadcast server 100 may permit users to mute messages of specific verified user (e.g., the user 106 of FIG. 1 as described as the verified user 706 in FIG. 7) to prevent misuse of the neighborhood broadcast server 100. All subscribed user profiles (e.g., preseeded user profiles 302 and/or claimed user profiles 304 as described in FIG. 3 in a circular geo-fenced area may be defined by the threshold distance from the set of geospatial coordinates 103 associated with the station broadcast data 102 generated through the computing device through the radial algorithm 240 of a neighborhood broadcasting system that measures a distance away of each address associated with each user profile from the current geospatial location at the epicenter.

In another embodiment, a method of a neighborhood broadcast server 100 includes determining that a time stamp 510 associated with a creation date 508 and/or a creation time 507 of a station broadcast data 102 generated through a computing device is trusted based on a claimed geospatial location (e.g., any of the claimed geospatial locations 700 as described in FIG. 7 of a user of the neighborhood broadcast server 100 using a processor 120 and a memory 124. The method includes automatically publishing the station broadcast data 102 generated through the computing device on a set of user profiles (e.g., preseeded user profiles 302 and/or claimed user profiles 304 as described in FIG. 3 having associated verified addresses in a threshold radial distance 119 from a set of geospatial coordinates 103 associated with the station broadcast data 102 generated through the computing device of the user of the neighborhood broadcast server 100 using a radial algorithm 240.

In addition, the method includes radially distributing the station broadcast data 102 as a notification data through an on-page posting, an electronic communication, and/or a push notification delivered to either (1) a set of recipients through an internet protocol (IP) based network associated with users and/or their user profiles (e.g., preseeded user profiles 302 and/or claimed user profiles 304 as described in FIG. 3 around an epicenter defined at the set of geospatial coordinates 103 associated with the station broadcast data 102 generated through the computing device or (2) a set of service providers accessible by the neighborhood broadcast server through a cellular network using the radial algorithm 240 in addition to the set of recipients through the IP based network associated with users and/or their user profiles (e.g., preseeded user profiles 302 and/or claimed user profiles 304 as described in FIG. 3.

In yet another embodiment, a system includes a neighborhood broadcast server 100 to automatically publish a station broadcast data 102 on a set of user profiles (e.g., preseeded user profiles 302 and/or claimed user profiles 304 as described in FIG. 3 having associated verified addresses in a threshold radial distance 119 from the set of geospatial coordinates 103 associated with the station broadcast data 102 of a verified user (e.g., the user 106 of FIG. 1 as described as the verified user 706 in FIG. 7) of the neighborhood broadcast server 100) using a radial algorithm 240. The system also includes a device 104 communicatively coupled with the neighborhood broadcast server 100 through a network 101 to generate the station broadcast data 102 using a camera, a microphone, and/or a sensory capability of the device 104 to generate a captured data that is appended with a present geospatial location and/or a time stamp 510 associated with a creation date 508 and/or a creation time 507 of the captured data in generating the station broadcast data 102.

Embodiments described herein in FIGS. 1-11 govern a new kind of social network for neighborhoods, according to one embodiment (e.g., may be private and/or wiki-editable search engine based). It should be noted that in some embodiments, the address of a user may be masked from the public search (but still may be used for privacy considerations), according to one embodiment. Some embodiments have no preseeded data, whereas others might. Embodiments described herein may present rich, location specific information on individual residents and businesses.

A user can “Claim” one or more Business Pages and/or a Residential Pages, according to one embodiment. In order to secure their Claim, the user may verify their location associated with the Business Page and/or Residential page within 30 days, or the page becomes released to the community, according to one embodiment. A user can only have a maximum of 3 unverified Claims out at any given time, according to one embodiment. When a user clicks on “Claim this Page” on Business Profile page and/or a Residential Profile page, they can indicate the manner in which they intend to verify their claim, according to one embodiment. Benefits of Claiming a Business Page and/or Residential page may enable the user to mark their page ‘Self-Editable only’ from the default ‘Fully Editable’ status, and see “Private” listings in a claimed neighborhood around the verified location, according to one embodiment. Each edit by a user on a Residential Profile page and/or a Business Profile page may be made visible on the profile page, along with a date stamp, according to one embodiment.

Browse function: Based on the user's current location, the browse function may display a local map populated with pushpins for location-specific information, and a news feed, made up of business page edits, public people page edits, any recent broadcasts, etc., according to one embodiment. The news feed may show up on each Business Page and each Residential Page, based on activity in the surrounding area, according to one embodiment. Secure a Neighborhood function: May allow the user to identify and “secure” a neighborhood, restricting certain types of access to verified residents, according to one embodiment. Add a Pushpin function: May allow any registered or verified user to add any type of Pushpin (as described in FIG. 8), to one embodiment.

In addition to the map, the search results page may display a news feed, made up of business page edits, public people page edits, any recent broadcasts, and autogenerated alerts who has moved into the neighborhood, who has moved out of the neighborhood, any recent reviews in the neighborhood, any pushpins placed in the immediate area, etc., according to one embodiment. The news feed may prioritize entries relating to the search results, and will take into account privacy policies and preferences, according to one embodiment.

Example Newsfeeds may include:

Joe Smith moved into the neighborhood in September 2013. Welcome Joe! Like Share; 43 neighbors (hyperlink) moved in to the Cupertino library neighborhood in July 2013. Like Share; 12 neighbors (hyperlink) verified in to the Cupertino library neighborhood in July 2013. Like Share; Rai Abhyanker invited Paul Smith, a guest to the Cupertino neighborhood. Raj indicates Paul is a friend from college looking to move into the neighborhood. Welcome Paul!; Raj Abhyanker posted a Nissan Leaf for rent $35 a day, in mountain view Rent now. Like Share

This content may feed each Profile Page and helps to increase Search Engine value for content on the site, according to one embodiment. Alerts may be created and curated (prioritized, filtered) automatically and/or through crowdsourcing, to keep each page vibrant and actively updating on a regular basis (ideally once a day or more), according to one embodiment.

A Multi-Family Residence page will display a list of residents in the entire building, according to one embodiment. Clicking on any resident will display a Single Family Residence page corresponding to the individual living unit where that person resides, according to one embodiment.

For example, suppose that John Smith and Jane Smith live in apartment 12 of a large building. Their names are included in the list of residents. When a user clicks on either John Smith or Jane Smith, we will display a “Single Family Residence” page showing both John and Jane, just as if apartment 12 was a separate structure, according to one embodiment.

The broadcast feature (e.g., associated with the station broadcast data 102 and generated by the radial algorithm 240 of the radial distribution module 140) may be a “Radio” like function that uses the device 104's current geospatial location to send out information to neighbors around the present geospatial location of the user, according to one embodiment. Broadcasts may be posted to neighbor pages in the geospatial vicinity (e.g., in the same neighborhood) on public and private pages in the geospatial social network, according to one embodiment. These broadcasts may enable any user, whether they live in a neighborhood or not to communicate their thoughts to those that live or work (or have claimed) a profile in the neighborhood around where the broadcaster is physically at, regardless of where the broadcaster lives, according to one embodiment. Broadcasts can be audio, video, pictures, and or text, according to one embodiment. For accountability, the broadcaster may be a verified user and their identity made public to all users who receive the broadcast in one embodiment.

This means that the broadcast feature may be restricted to be used only by devices (E.g., mobile phones) that have a GPS chip (or other geolocation device) that an identify a present location of where the broadcast is originating from, according to one embodiment. The broadcast may be sent to all users who have claimed a profile in the geo spatial vicinity where the broadcast originates, according to one embodiment. This can either be broadcast live to whoever is “tuned” in to a broadcast of video, audio, picture, and text in their neighborhood, or can be posted on each users profile if they do not hear the broadcast to the neighborhood in a live mode in one embodiment.

When a broadcast is made neighbors, around where the broadcast is made, they may receive a message that says something like:

Raj Abhyanker, a user in Menlo Park just broadcast “Japanese cultural program” video from the Cupertino Union church just now. Watch, Listen, View

This broadcast may be shared with neighbors around Menlo park, and or in Cupertino. This way, Raj's neighbors and those in Cupertino can know what is happening in their neighborhoods, according to one embodiment. In one embodiment, the broadcast only goes to one area (Cupertino or Menlo park in the example above).

Broadcasts could be constrained to devices that have geospatial accuracy of present location and a current only (mobile devices for example). Otherwise, broadcasts won't mean much, according to one embodiment (would otherwise be just like thoughts/video upload without this). Broadcasts shouldn't be confused with ‘upload videos’, according to one embodiment. Different concepts. Why? Broadcasts have an accuracy of time and location that cannot be altered by a user, according to one embodiment. Hence, mobile is the most likely medium for this not desktop computer, according to one embodiment. We should not let the user set their own location for broadcasts (like other pushpin types), according to one embodiment. Also time is fixed, according to one embodiment. Fixing and not making these two variables editable give users confidence that the broadcast was associated with a particular time and place, and creates a very unique feature, according to one embodiment. For example, it would be not useful if the broadcast is untrusted as to location of origination, according to one embodiment. E.g., I broadcast when I am somewhere only about the location I am at, according to one embodiment.

Broadcasts are different that other pushpins because location of where a broadcast, and time of broadcast is *current location* and *current time*, according to one embodiment. They are initiated wherever a broadcaster is presently at, and added to the news feed in the broadcasters neighborhood and in the area wherever a broadcaster is presently at, according to one embodiment.

Broadcast rules may include:

1. If I post a Broadcast in my secured neighborhood, only my neighbors can see it, according to one embodiment.

2. If I post a Broadcast in different secured neighborhood then my own, my neighbors can see it (e.g., unless I turn this off in my privacy setting) and neighbors in the secured neighborhood can see it (e.g., default not turn-offable, but I can delete my broadcast), according to one embodiment.

3. If I post a Broadcast in different unsecured neighborhood then my own, my neighbors can see it (unless I turn this off in my privacy setting) and the broadcast is publicly visible on user pages of public user profiles in the unsecured neighborhood until profiles are claimed and/or the neighborhood is secured, according to one embodiment.

4. If an outsider in a secure neighborhood posts a broadcast in my secure neighborhood, it's not public, according to one embodiment.

5. If an outsider in a unsecure neighborhood posts a broadcast in my secure neighborhood, the system does not post on profiles in his unsecure neighborhood (to prevent stalking, burglary), but does post in my secure neighborhood, according to one embodiment.

Privacy settings. For each verified residential or business location, the user may set Privacy to Default, Public, Private, or Inactive, according to one embodiment. The Default setting (which is the default) means that the profile will be public, until the neighborhood is secured; in a secured neighborhood, the profile will be Private, according to one embodiment. By changing this setting, the user may force the profile to be Public or Private, regardless of whether the neighborhood is secured, according to one embodiment. For each verified residential location, the user may set edit access to Group Editable or Self Editable, according to one embodiment.

Residential Privacy example. The residential profiles can be: Public: anyone can search, browse, or view the user profile, according to one embodiment. This is the default setting for unsecured neighborhoods (initially, all the content on the site), according to one embodiment. Private: only people in my neighborhood can search, browse, or view the user's profile, according to one embodiment. This is the default for secured neighborhoods, according to one embodiment. Inactive: nobody can search, browse, or view the profile, even within a secured neighborhood, according to one embodiment. A user may have at least one active (public or private), verified profile in order to have edit capabilities, according to one embodiment; if the user makes all profiles inactive, that user is treated (for edit purposes) as an unverified user, according to one embodiment.

Verified users can edit the privacy setting for their profile and override the default, according to one embodiment. Group Editable: anyone with access to a profile based on the privacy roles above can edit the profile, according to one embodiment This is the default setting, according to one embodiment Self Editable, only the verified owner of a profile can edit that profile, according to one embodiment.

Exceptions Guest User. A verified user in another neighborhood is given “Guest” access to a neighborhood for a maximum of 60 days by a verified user in the neighborhood in which the guest access is given, according to one embodiment. In effect, the guest becomes a member of the neighborhood for a limited period, according to one embodiment. Friend. When a user has self-elected being friends with someone in a different neighborhood, they can view each other's profiles only (not their neighbors), according to one embodiment. One way for a user to verify a location is to submit a scanned utility bill, according to one embodiment.

When a moderator selects the Verify Utility Bills function, the screen will display a list of items for processing, according to one embodiment. Accept the utility bill as a means of verification, according to one embodiment. This will verify the user's location, and will also generate an e-mail to the user, according to one embodiment. Or Decline the utility bill as a means of verification, according to one embodiment. There will be a drop-down list to allow the moderator to select a reason, according to one embodiment; this reason will be included in an e-mail message to the user. Reasons may include: Name does not match, address does not match, name/address can't be read, not a valid utility bill, according to one embodiment.

An example embodiment will now be described. A user (e.g., an organization, a non-profit institution, a home owner, a resident, a tenant, a manager) may broadcast a live musical performance on a geospatially constrained social network (e.g., Fatdoor.com, Nextdoor.com). A recipient may receive that broadcast in the station broadcast data 102 that the user is broadcasting (e.g., post using the radial algorithm 240) using a desktop computer at their work address and/or through their mobile device 504. The recipient may be able to view the broadcast of the user and respond to the user with the recipient's own live broadcast. The recipient may be looking for a particular type of broadcast, for example, a jazz performance, or a news talk show in the local area. Conversely, the user broadcasting the station broadcast may wish to transmit their broadcast only to the local area. The user may broadcast a news talk show that pertains to local residents. By posting the broadcast through the radial algorithm 240, the user may ensure that only local residents may receive the user's broadcast. In some cases, a recipient may already be listening or watching a broadcast and may receive the station broadcast data 102 through their device 104 (e.g., even when their device 104 is physically at a different location than a location in which they live). The recipient may become aware of a better broadcasting option as a result of their participation through the geospatially constrained social network 142 having the neighborhood broadcast server 100. Therefore, the recipient may discover a new local talent or area of interest or watching interest that is in a location geographically proximate to an address where the recipient has a non-transitory association (e.g., an existing home address, an existing work address).

Because the recipient may be presented with the station broadcast through the embodiments of described in FIGS. 1-11 using the radial algorithm 240 of the radial distribution module 140 of the neighborhood broadcast server 100, the recipient may have a chance to experience new broadcasts and information. Therefore, recipients may save time, money, and effort in finding a radio or television broadcast in the local area. Users transmitting broadcasts, too, may save time, effort, and money by avoiding having to purchase expensive radio equipment or pay costly government fees for use of the telecommunications broadcast band in order to send broadcasts to a local audience. Users who wish to target the local area may save time and effort by transmitting their broadcast through the radial algorithm 240 and thereby reaching only their targeted audience.

For example, a recipient Bob Jones may be interested in listening to local musical talent near his home in Lorelei neighborhood, Menlo Park. Bob Jones may become a user on Nextdoor.com (or Fatdoor.com) and view the musical broadcasts that other users are broadcasting directly surrounding Bob Jones' home. Bob Jones may then receive broadcasts from other users who post using the radial algorithm 240 using a desktop computer at their work address and/or through their mobile device 504. Thereby Bob Jones may become familiar with musical acts and events going on near his home and become more connected to his neighborhood and the local music scene. Bob may also broaden his musical interests through his exposure to new music performers in his neighborhood that he may have discovered through the geospatially constrained social network.

In another example, a user Sally Smith may be interested in hosting and transmitting a local news talk show from her apartment. Sally Smith may want to reach local residents in her neighborhood because the topic of her discussions concerns a local ordinance that is on the upcoming ballot. By sending her broadcast through the geospatially constrained social network using the radial algorithm, Sally Smith may broadcast her news talk show to local residents who are also users of the social network. Because Sally Smith only broadcasts to the local area, nearby businesses may be drawn to this efficient way of reaching customers because they may be interested in advertising to the targeted, local audience of Sally. A business that might otherwise not be able to afford a larger-scale advertising campaign may be able to advertise on this more-focused scale and thus reap commercial rewards. The new patrons of these local businesses may likewise benefit from this advertising.

Because Sally Smith avoids sending her message to an audience that is not interested and because Sally does not need to purchase her own radio transmission equipment or obtain permission from a regulatory agency to broadcast across the radiofrequency broadcast band, she may save time, effort, and money in transmitting her broadcast. Consequently, Sally may benefit from being able to personally express herself and help the local neighborhood become more politically engaged. Sally may profit from the social and commercial connections forged through her broadcasts to local, like-minded broadcast recipients.

Bob and Jane may live in the Lorelei neighborhood of Menlo Park, and for this reason receive the station broadcast data. If Bob creates a station broadcast, Bob may choose to restrict dissemination of his station broadcast just to the Lorelei neighborhood because it is an ‘active’ neighborhood around where Bob lives. Particularly, a minimum number of Bob's neighbors in the Lorelei neighborhood, such as 10 neighbors in the Lorelei neighborhood, may have signed up and verified their profiles through an online neighborhood social network (e.g., Fatdoor.com). If Bob is the first user that creates a private network for his neighborhood (e.g., a ‘founding member’), he may need to draw geospatial boundaries and/or claim geospatial boundaries around his neighborhood and invite a threshold number of neighbors (e.g., 10 neighbors) to activate it. An amount of time for Bob to invite and activate his neighborhood may be limited (e.g., 21 days). However, Bob may request an extension of time from the geospatially constrained social network 142 if Bob needs more time to invite users, and the geospatially constrained social network 142 may grant this extra time. In other words, if Bob is a founding member, he may have the ability to define the neighborhood boundary and choose the neighborhood name.

The geo-spatially constrained social network 142 may internally make corrections to either the boundaries or name that Bob set based on feedback from other neighbors and/or based on internal policies. These internal policies may include a preference for a use of official names for a community (e.g., based on local thoroughfares, a nearby park, or landmark for inspiration), a neighborhood name that is short and sweet (e.g., eliminating unnecessary words like city, state, neighbors, neighborhood, HOA, friends, etc.), with correct capitalization (e.g., to ensure that a first letter of each word is capitalized), and/or use of spaces between each word in a neighborhood name. In one embodiment, Bob may designate neighborhood ‘leads’ who can adjust boundaries of their neighborhood through an adjust boundaries tool. Bob may be part of an elite group of neighborhood ‘leads’ who keep the geospatially constrained social network 142 operating smoothly by organizing information and posting neighborhood-wide information. The neighborhood leads like Bob may have special privileges such as removing inappropriate messages, adjusting neighborhood boundaries, verifying unverified members, editing the about section on a neighborhood feed, and/or promoting other members to become neighborhood leads.

Bob and his neighbors may have each verified their addresses through a postcard verification system in which they received a postcard at their home with an access code that permits each of them to access their private Lorelei neighborhood community information including station broadcast history in the online neighborhood social network (e.g., the Fatmail postcard system through which an access code may have been received at a respective Lorelei home that uniquely identifies and verifies a home in the Lorelei neighborhood). Bob may have invited a threshold number (e.g., 10) of his Lorelei neighbors prior to the Lorelei neighborhood becoming active. Bob may choose to disseminate his station broadcast data to a neighborhood adjacent to Lorelei, such as Menlo Park downtown (e.g., using the radial algorithm 240 of the radial distribution module 140). Optionally, Bob may choose to restrict his station broadcast data just to Lorelei neighbors (e.g., using the radial algorithm 240 of the radial distribution module 140). In other words, users of the neighborhood social network in an entirely different neighborhood, such as the Financial District neighborhood of San Francisco (about 20 miles away) may not be able to access the station broadcast data that Bob generates.

For example, the station broadcast data may be disseminated to adjacent neighborhoods that have been claimed by different users in a manner such that the station broadcast data is optionally disseminated to the surrounding claimed neighborhoods based on Bob's preference.

It will be understood with those skill in the art that in some embodiments, the radial distribution module 140 may restrict dissemination of station broadcast data by verified users to claimed neighborhoods in a private neighborhood social network (e.g. the geospatially constrained social network 142 may be a private social network, the neighborhood curation system described herein may also be part of the private neighborhood social network) in which the broadcaster resides (e.g., has a home) using the radial algorithm 140. The geo-spatially constrained social network 142 may include online communities designed to easily create private websites to facilitate communication among neighbors and build stronger neighborhoods (e.g., to help neighbors build stronger and safer neighborhoods).

Further, it follows that the threshold radial distance 119 may take on a variety of shapes other than purely circular and is defined to encompass a variety of shapes based on associated geographic, historical, political and/or cultural connotations of associated boundaries of neighborhoods and/or as defined by a city, municipality, government, and/or data provider (e.g., Maponics®, Urban Mapping®), in one embodiment. For example, the threshold radial distance 119 may be based on a particular context, such as a school boundary, a neighborhood boundary, a college campus boundary, a subdivision boundary, a parcel boundary, and/or a zip code boundary.

In an alternative embodiment, the threshold radial distance 119 generated by the geospatially constrained social network 142 may be restricted to a shared apartment building (e.g., and/or an office building). In addition, it will be understood with those skilled in the art that the neighborhood broadcast server 100 may be operated as a function of the geo-spatially constrained social network 142 (e.g., a neighborhood social network).

In addition, it will be understood that in some embodiments, the station broadcast data 102 is generated by the cinema 309C (e.g., and/or others of the display venues 109) in the form of professional advice provided as a feed (e.g., a Real Simple Syndication (RSS) feed) to the geo-spatially constrained social network 142 for distribution to relevant ones of the claimed neighborhoods in the geo-spatially constrained social network 142. It will be understood that the station broadcast data 102 may appear in a ‘feed’ provided to users of the geo-spatially constrained social network 142 (e.g., a private social network for neighbors) on their profile pages based on access control privileges set by the radial broadcast module 140 using the radial algorithm 240. For example, access to the station broadcast data 102 may be limited to just a claimed neighborhood (e.g., as defined by neighborhood boundaries) and/or optionally adjacent neighborhoods.

In one embodiment, the geo-spatially constrained social network 142 may provide police departments and other municipal agencies with a separate login in which they can invite neighbors themselves, provide for a virtual neighborhood watch and emergency preparedness groups, and conduct high value crime and safety related discussions from local police and fire officials without requiring any technical integration. This may provide police departments and municipalities with a single channel to easily broadcast information across neighborhoods that they manage, and receive and track neighborhood level membership and activity to identify leaders of a neighborhood.

For example, communications defined from one broadcasting user to an adjacent neighborhood may involve sharing information about a local artistic event that might interest several neighborhoods, explaining about a lost pet that might have wandered into an adjoining neighborhood, to rally support from neighbors from multiple neighborhoods to address civic issues, to spread the word about events like local theater production or neighborhood garage sales, and/or to ask for advice or recommendations from the widest range of people in a community). In one embodiment, the geospatially constrained social network 142 may prevent self-promotional messages and broadcasts that are inappropriate (e.g., a user sending such messages may be suspended from the geospatially constrained social network using the crowd sourced moderation algorithm 204. In one embodiment, the user 106 may personalize nearby neighborhoods so that the user can choose exactly which nearby neighborhoods (if any) they wish to communicate with. The user 106 may be able to flag a neighborhood feeds from adjacent neighborhoods. In addition, leaders from a particular neighborhood may be able to communicate privately with leaders of an adjoining neighborhood to plan and organize on behalf of an entire constituency. Similarly, users 106 may be able to filter feeds to only display messages from the neighborhood that they reside in. The user 106 may be able to restrict posts (e.g., pushpin placements) only in the neighborhood they are presently in. In one embodiment, nearby neighbors may (or may not) be able to access profiles of adjacent neighborhoods.

It will also be understood that in some embodiments, that users may be ‘verified through alternate means, for example through a utility bill verification (e.g., to verify that a user's address on a utility bill matches the residential address they seek to claim), a credit card verification (e.g., or debit card verification), a phone number verification (e.g., reverse phone number lookup), a privately-published access code (e.g., distributed to a neighborhood association president, and/or distributed at a neighborhood gathering), and a neighbor vouching method (e.g., in which an existing verified neighbor ‘vouches’ for a new neighbor as being someone that they personally know to be living in a neighborhood.

In one embodiment, the geospatially constrained social network 142 ensures a secure and trusted environment for a neighborhood website by requiring all members to verify their address. In this embodiment, verification may provide assurance the assurance that new members are indeed residing at the address they provided when registering for an account in the geo-spatially constrained social network 142. Once a neighborhood has launched out of pilot status, only members who have verified their address may be able access to their neighborhood website content.

It will be understood that among the various ways of verifying an address, a user of the geo-spatially constrained social network 142 may uses the following methods to verify the address of every member:

A. Postcard. The geo-spatially constrained social network 142 can send a postcard to the address listed on an account of the user 106 with a unique code printed on it (e.g., using the Fatmail postcard campaign). The code will may allow the user 106 to log in and verify their account.

B. Credit or debit card. The geo-spatially constrained social network 142 may be able to verify a home address through a credit or debit card billing address.

In one embodiment, billing address may be confirmed without storing personally identifiable information and/or charging a credit card.

C. Home phone. If a user 106 has a landline phone, the user may receive an automated phone call from the geo-spatially constrained social network 142 that may provide with a unique code to verify an account of the user 106.

D. Neighborhood leader. A neighborhood leader of the geo-spatially constrained social network can use a verify neighbors feature of the geo-spatially constrained social network 142 to vouch for and verify neighbors.

E. Mobile phone. A user 106 may receive a call to a mobile phone associated with the user 106 to verify their account.

F. Neighbor invitations. A neighbor who is a verified member of the geo-spatially constrained social network 142 can vouch for, and may invite another neighbor to join the geo-spatially constrained social network 142. Accepting such an invitation may allow the user 106 to join the geo-spatially constrained social network 142 as a verified member, according to one embodiment.

H. Social Security Number (SSN). The geo-spatially constrained social network 142 can verify a home address when the user 106 provides the last 4 digits of a SSN (e.g., not stored by the geospatially constrained social network 142 for privacy reasons).

It will be also understood that in a preferred embodiment neighborhood boundaries defined by the radial distribution module 140 using the radial algorithm 140 may be constrained to work in neighborhoods having a threshold number of homes (e.g., 100 homes in a neighborhood) and more (e.g., up to thousands of homes) as this may be needed to reach the critical mass of active posters that is needed to help the geo-spatially constrained social network 142 succeed. In one embodiment, ‘groups’ may be creatable in smaller neighborhoods having fewer than the threshold number of homes for communications in micro-communities within a claimed neighborhood.

It will also be appreciated that in some embodiments, a mobile device 104 may be a desktop computer, a laptop computer, and/or a non-transitory broadcasting module. In addition, it will be understood that the prepopulated data (e.g., preseeded data) described herein may not be created through data licensed from others, but rather may be user generated content of organically created profiles in the geo-spatial social network created by different users who have each verified their profiles.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system. Accordingly, the specification and drawings are to be regarded in an illustrative rather than a restrictive sense.

What is claimed is:

1. A method of a neighborhood broadcast server comprising:
validating that a station broadcast data is associated with a mobile device, wherein the station broadcast data is at least one of a radio station and a television station;
verifying that a set of geospatial coordinates associated with the station broadcast data are trusted based on a current geospatial location of the mobile device;
determining that a time stamp associated with a creation date and a creation time of the station broadcast data is trusted based the current geospatial location of the mobile device; and
automatically publishing the station broadcast data on a set of user profiles having associated verified addresses in a threshold radial distance from the current geospatial location of the mobile device using a radial algorithm.

2. The method of claim 1 further comprising:
determining that the station broadcast data is generated by a verified user of the neighborhood broadcast system when validating that the station broadcast data is associated with the mobile device;
determining that an application on the mobile device is communicating the station broadcast data to the neighborhood broadcast server when the station broadcast data is processed; and
associating the verified user with a verified user profile in the neighborhood broadcast server through the application on the mobile device,
wherein the station broadcast data is radially distributed through at least one of an on-page posting, an electronic communication, and a push notification delivered to desktop and mobile devices associated with users and their user profiles around an epicenter defined at the current geospatial location of the mobile device to all subscribed user profiles in a circular geo-fenced area defined by a threshold distance from the current geospatial location of the mobile device through the radial algorithm of the neighborhood broadcast server that measures a distance away of each address associated with each user profile from the current geospatial location at the epicenter.

3. The method of claim 2 further comprising:
extracting the set of geospatial coordinates from a metadata associated with the station broadcast data when verifying that the set of geospatial coordinates associated with the station broadcast data are trusted based on the current geospatial location of the mobile device.

4. The method of claim 3 further comprising:
determining a relative match between a persistent clock associated with the neighborhood broadcast server and a digital clock of the mobile device to determine that the time stamp associated with the creation date and time of the station broadcast data is accurate and therefore trusted.

5. The method of claim 4 further comprising:
geocoding a set of residential addresses each associated with a resident name in a neighborhood surrounding the mobile device; and
prepopulating the set of residential addresses each associated with the resident name as the set of user profiles in the threshold radial distance from the current geospatial location of the mobile device in a neighborhood curation system communicatively coupled with the neighborhood broadcast server.

6. The method of claim 5 further comprising:
permitting the verified user to modify content in each of the set of user profiles;
tracking the modified content through the neighborhood curation system;
generating a reversible history journal associated with each of the set of user profiles such that a modification of the verified user can be undone on a modified user profile page;
determining an editing credibility of the verified user based on an edit history of the verified user and a community contribution validation of the verified user by other users of the neighborhood curation system; and
automatically publishing the station broadcast data to the set of user profiles having associated verified addresses in the threshold radial distance from the current geospatial location of the mobile device.

7. The method of claim 6 further comprising:
processing a claim request of the verified user generating the station broadcast data through the mobile device to be associated with an address of the neighborhood curation system;
determining if a claimable neighborhood in the neighborhood curation system is associated with a private neighborhood community in the claimable neighborhood of the neighborhood curation system;
associating the verified user with the private neighborhood community in the claimable neighborhood of the neighborhood curation system if the private neighborhood community has been activated by at least one of the verified user and a different verified user;
permitting the verified user to draw a set of boundary lines in a form of a geospatial polygon such that the claimable neighborhood in a geospatial region surrounding the claim request creates the private neighborhood community in the neighborhood curation system if the private neighborhood community is inactive;
verifying the claim request of the verified user generating the station broadcast data through the mobile device to be associated with a neighborhood address of the neighborhood curation system when the address is determined to be associated with at least one of a work address and a residential address of the verified user; and
simultaneously publishing the station broadcast data on the private neighborhood community associated with the verified user generating the station broadcast data through the mobile device in the threshold radial distance from the address associated with the claim request of the verified user of the neighborhood curation system when automatically publishing the station broadcast data on the set of user profiles having associated verified addresses in the threshold radial distance from the current geospatial location of the mobile device based on a set of preferences of the verified user using the radial algorithm.

8. The method of claim 7 further comprising:
providing a summary data to the verified user generating the station broadcast data through the mobile device of how many user profile pages were updated with an alert of the station broadcast data when publishing the station broadcast data in at least one of the private neighborhood community and the set of user profiles having associated verified addresses in the threshold radial distance from the current geospatial location of the mobile device based on the set of preferences of the verified user.

9. The method of claim 8 further comprising:
live broadcasting the station broadcast data to the different verified user and other verified users in at least one of the private neighborhood community and currently within the threshold radial distance from the current geospatial location through a multicast algorithm of the neighborhood broadcast server such that the live broadcast multicasts to a plurality of mobile devices associated with each of the different user and the other verified users simultaneously when the mobile device of the verified user generating the station broadcast data enables broadcasting of the station broadcast data to a geospatial vicinity around the mobile device of the verified user generating the station broadcast data and in any private neighborhood community in which the verified user has a non-transitory connection using the radial algorithm; and
permitting the different verified user and other verified users in at least one of the private neighborhood community to bi-directionally communicate with the verified user generating the station broadcast data through the neighborhood broadcast server using the radial algorithm,
wherein any private neighborhood community in which the verified user has a non-transitory connection is at least one of the residential address of the verified user and the work address of the verified user that has been confirmed by the neighborhood broadcast server as being associated with the verified user,
wherein the threshold radial distance is between 0.2 and 0.4 miles from the set of geospatial coordinates associated with the station broadcast data to optimize a relevancy of the station broadcast data,
wherein the neighborhood broadcast server includes a crowdsourced moderation algorithm in which multiple neighbors to a geospatial area determine what content contributed to the neighborhood broadcast server persists and which is deleted, and
wherein the neighborhood broadcast server permits users to mute messages of specific verified users to prevent misuse of the neighborhood broadcast server.

10. A method of a neighborhood broadcast server comprising:
determining that a time stamp associated with a creation date and a creation time of a station broadcast data is trusted based on a current geospatial location of a computing device;
automatically publishing the station broadcast data on a set of user profiles having associated verified addresses in a threshold radial distance from the current geospatial location of the computing device using a radial algorithm; and
radially distributing the station broadcast data as a notification data through at least one of an on-page posting, an electronic communication, and a push notification delivered to a set of recipients through an internet protocol (IP) based network associated with users and their user profiles around an epicenter defined at a set of geospatial coordinates associated with the station broadcast data generated through the computing device.

11. The method of claim 10 further comprising:
validating that the station broadcast data is associated with the computing device; and
verifying that the set of geospatial coordinates associated with the station broadcast data are trusted based on the current geospatial location of the computing device.

12. The method of claim 11 further comprising:
determining that the station broadcast data is generated by a user of the neighborhood broadcast system when validating that the station broadcast data is associated with the computing device;
determining that an application on the computing device is communicating the station broadcast data to the neighborhood broadcast server when the station broadcast data is processed; and
associating the user with a user profile in the neighborhood broadcast server through the application on the computing device.

13. The method of claim 12 further comprising:
extracting the geospatial coordinates from a metadata associated with the station broadcast data when verifying that the set of geospatial coordinates associated with the station broadcast data are trusted based on the current geospatial location of the computing device.

14. A system of a neighborhood broadcast server comprising:
a neighborhood broadcast server to automatically publish a station broadcast data on a set of user profiles having associated verified addresses in a threshold radial distance from a set of geospatial coordinates associated with the station broadcast data of a verified user of the neighborhood broadcast server using a radial algorithm,
an internet protocol network, and
a device communicatively coupled with the neighborhood broadcast server through a network to generate the station broadcast data using at least one of a camera, a microphone, and a sensory capability of the device to generate a captured data that is appended with a present geospatial location and a time stamp associated with a creation date and a creation time of the captured data in generating the station broadcast data.

15. The system of claim 14 wherein the neighborhood broadcast server further comprises:
a validation module to validate that the station broadcast data is associated with the device and to verify the set of geospatial coordinates associated with the station broadcast data are trusted based on a current geospatial location of the device,
a time stamp module to determine that the time stamp associated with the creation date and the creation time of the station broadcast data is trusted based the current geospatial location of the device,
a publishing module to automatically publish the station broadcast data on the set of user profiles having associated verified addresses in the threshold radial distance from the current geospatial location of the device using the radial algorithm,
a verification module to determine that the station broadcast data is generated by the verified user of the neighborhood broadcast system when validating that the station broadcast data is associated with the device,
a communication determining module to determine that an application on the device is communicating the station broadcast data to the neighborhood broadcast server when the station broadcast data is processed,
an application module to associate the verified user with a verified user profile in the neighborhood broadcast server through the application on the device, and
a radial distribution module to radially distribute the station broadcast data through at least one of an on-page posting, an electronic communication, and a push notification delivered to desktop and devices associated with users and their user profiles around an epicenter defined at the current geospatial location of the device to all subscribed user profiles in a circular geo-fenced area defined by a threshold distance from the current geospatial location of the device through the radial algorithm of the neighborhood broadcast server that measures a distance away of each address associated with each user profile from the current geospatial location at the epicenter.

16. The system of claim 15 further comprising:
an extraction module to extract the geospatial coordinates from a metadata associated with the station broadcast data when verifying that the set of geospatial coordinates associated with the station broadcast data are trusted based on the current geospatial location of the device.

17. The system of claim 16 further comprising:
a matching module to determine a relative match between a persistent clock associated with the neighborhood broadcast server and a digital clock of the device to determine that the time stamp associated with the creation date and time of the station broadcast data is accurate and therefore trusted.

18. The system of claim 17 further comprising:
a plotting module to geocode a set of residential addresses each associated with a resident name in a neighborhood surrounding the device, and
a data-seeding module to prepopulate the set of residential addresses each associated with the resident name as the set of user profiles in the threshold radial distance from the current geospatial location of the device in a neighborhood curation system communicatively coupled with the neighborhood broadcast server.

19. The system of claim 18 further comprising:
a modification module to permit the verified user to modify content in each of the set of user profiles,
a discovery module to track the modified content through the neighborhood curation system,
an undo module to generate a reversible history journal associated with each of the set of user profiles such that a modification of the verified user can be undone on a modified user profile page, and
a reputation module to determine an editing credibility of the verified user based on an edit history of the verified user and a community contribution validation of the verified user by other users of the neighborhood curation system.

20. The system of claim 19 further comprising:
A claiming module to process a claim request of the verified user generating the station broadcast data through the device to be associated with the address of the neighborhood curation system,
a private-neighborhood module to determine if a claimable neighborhood in the neighborhood curation system is associated with a private neighborhood community in the claimable neighborhood of the neighborhood curation system,
an association module to associate the verified user with the private neighborhood community in the claimable neighborhood of the neighborhood curation system if the private neighborhood community has been activated by at least one of the verified user and a different verified user,
a boundary module to permit the verified user to draw a set of boundary lines in a form of a geospatial polygon such that the claimable neighborhood in a geospatial region surrounding the claim request creates the private neighborhood community in the neighborhood curation system if the private neighborhood community is inactive,
an address type module to verify the claim request of the verified user generating the station broadcast data through the device to be associated with a neighborhood address of the neighborhood curation system when the address is determined to be associated with at least one of a work address and a residential address of the verified user,
a concurrency module to simultaneously publish the station broadcast data on the private neighborhood community associated with the verified user generating the station broadcast data through the device in the threshold radial distance from the address associated with the claim request of the verified user of the neighborhood curation system when automatically publishing the station broadcast data on the set of user profiles having associated verified addresses in the threshold radial distance from the current geospatial location of the device based on a set of preferences of the verified user using the radial algorithm,
a summary module to provide a summary data to the verified user generating the station broadcast data through the device of how many user profile pages were updated with an alert of the station broadcast data when publishing the station broadcast data in at least one of the private neighborhood community and the set of user profiles having associated verified addresses in the threshold radial distance from the current geospatial location of the device based on the set of preferences of the verified user,
a live broadcast module to live broadcast the station broadcast data to the different verified user and other verified users in at least one of the private neighborhood community and currently within the threshold radial distance from the current geospatial location through a multicast algorithm of the neighborhood broadcast server such that the live broadcast multicasts to a plurality of devices associated with each of the different user and the other verified users simultaneously when the device of the verified user generating the station broadcast data enables broadcasting of the station broadcast data to a geospatial vicinity around the device of the verified user generating the station broadcast data and in any private neighborhood community in which the verified user has a non-transitory connection using the radial algorithm,
a bi-directional communication module to permit the different verified user and other verified users in at least one of the private neighborhood community to bi-directionally communicate with the verified user generating the station broadcast data through the neighborhood broadcast server using the radial algorithm,
wherein any private neighborhood community in which the verified user has a non-transitory connection is at least one of the residential address of the verified user and the work address of the verified user that has been confirmed by the neighborhood broadcast server as being associated with the verified user,
a threshold module to optimize a relevancy of the station broadcast data wherein the threshold radial distance is between 0.2 and 0.4 miles from the set of geospatial coordinates associated with the station broadcast data,
a television module to generate a set of neighborhood television stations distributed through the internet protocol network such that recipients in in a region bounded by the threshold radial distance are permitted to access and tune in each of the set of neighborhood television stations based on at least one of a claimed neighborhood profile and the current geospatial location of a recipient,
a radio module to generate a set of neighborhood radio stations distributed through the internet protocol network such that recipients in the region bounded by the threshold radial distance are permitted to access and tune in to each of the set of neighborhood radio stations based on at least one of the claimed neighborhood profile and the current geospatial location of the recipient,
a crowdsourced-moderation algorithm in which multiple neighbors to a geospatial area determine what content contributed to the neighborhood broadcast server persists and which is deleted,
a muting module to permit users to mute messages of specific verified users to prevent misuse of the neighborhood broadcast server,
wherein the neighborhood broadcast server permits the station broadcast data to be disseminated to adjacent neighborhoods that have been claimed by different users in a manner such that the station broadcast data is optionally disseminated to the surrounding claimed neighborhoods based on the set of preference of the verified user,
wherein the claimed neighborhood of the verified user is activated based on a minimum number of other verified users in the threshold radial distance that have been verified through a primary residential address associated with each of the other verified users through at least one of a post card verification, a utility bill verification, a privately-published access code, and a neighbor vouching method,
wherein access to the station broadcast data is restricted to the claimed neighborhood of the verified user, and
wherein access to the station broadcast data is denied to users having verified addresses outside the claimed neighborhood of the verified user.
